(19) United States
(12) Patent Application Publication
(10) Pub. No.: US 2025/0321646 A1
(43) Pub. Date: Oct. 16, 2025

(54) AIR GESTURE USER INTERFACES

(71) Applicant: Apple Inc., Cupertino, CA (US)

(72) Inventors: Edward CHAO, Palo Alto, CA (US); Giovanni M. AGNOLI, San Mateo, CA (US); Christopher P. FOSS, San Francisco, CA (US); Adam J. LEONARD, San Francisco, CA (US); Cezar Mihai RADU, Dublin, CA (US)

(21) Appl. No.: 19/078,043

(22) Filed: Mar. 12, 2025

Related U.S. Application Data
(60) Provisional application No. 63/634,149, filed on Apr. 15, 2024.
(60) Provisional application No. 63/657,702, filed on Jun. 7, 2024.
(60) Provisional application No. 63/757,671, filed on Feb. 12, 2025.

(51) Int. Cl. G06F 3/01; G06F 3/16; G06F 9/451

(52) U.S. Cl. CPC G06F 3/017; G06F 3/016; G06F 3/165; G06F 9/451

(57) ABSTRACT

The present disclosure generally relates to air gesture user interfaces.

### CROSS-REFERENCE TO RELATED APPLICATIONS

This application claims the benefit of U.S. Provisional Application No. 63/757,671, filed on Feb. 12, 2025, entitled “AIR GESTURE USER INTERFACES”, U.S. Provisional Application No. 63/657,702, filed on Jun. 7, 2024, entitled “AIR GESTURE USER INTERFACES”, and U.S. Provisional Application No. 63/634,149, filed on Apr. 15, 2024, entitled “AIR GESTURE USER INTERFACES”. The contents of each of these applications are hereby each incorporated by reference in their entireties for all purposes.

### FIELD

The present disclosure relates generally to computer user interfaces, and more specifically to techniques for managing air gesture inputs.

### BACKGROUND

Computer systems often receive user inputs and perform corresponding operations. Example user inputs include touch inputs on a touch-sensitive surface, keyboard inputs, and cursor inputs using a pointing device.

### BRIEF SUMMARY

Some techniques for managing air gesture inputs using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for managing air gesture inputs, particularly with respect to an input focus. Such methods and interfaces optionally complement or replace other methods for managing air gesture inputs. Such methods and interfaces reduce the cognitive burden on a user and produce a more efficient human-machine interface. For battery-operated computing devices, such methods and interfaces conserve power and increase the time between battery charges.

In some embodiments, a method is described. The method comprises: at a computer system that is in communication with a display generation component: detecting an occurrence of an event to transition the computer system from a lower power state to a higher power state that is different from the lower power state; in response to detecting the occurrence of the event to transition the computer system from the lower power state to the higher power state: in accordance with a determination that a first set of criteria is satisfied, displaying, via the display generation component, a first element with a visual indication that the first element has input focus; and in accordance with a determination that the first set of criteria is not satisfied, forgoing display, via the display generation component, of the first element with the visual indication that the first element has input focus; detecting a first air gesture; and in response to detecting the first air gesture and in accordance with a determination that the first air gesture is a first type of gesture detected while displaying the visual indication that the first element has input focus, performing an operation corresponding to the first element.

In some embodiments, a non-transitory computer-readable storage medium is described. The non-transitory computer-readable storage medium stores one or more programs configured to be executed by one or more processors of a computer system that is in communication with a display generation component, the one or more programs including instructions for: detecting an occurrence of an event to transition the computer system from a lower power state to a higher power state that is different from the lower power state; in response to detecting the occurrence of the event to transition the computer system from the lower power state to the higher power state: in accordance with a determination that a first set of criteria is satisfied, displaying, via the display generation component, a first element with a visual indication that the first element has input focus; and in accordance with a determination that the first set of criteria is not satisfied, forgoing display, via the display generation component, of the first element with the visual indication that the first element has input focus; detecting a first air gesture; and in response to detecting the first air gesture and in accordance with a determination that the first air gesture is a first type of gesture detected while displaying the visual indication that the first element has input focus, performing an operation corresponding to the first element.

In some embodiments, a transitory computer-readable storage medium is described. The transitory computer-readable storage medium stores one or more programs configured to be executed by one or more processors of a computer system that is in communication with a display generation component, the one or more programs including instructions for: detecting an occurrence of an event to transition the computer system from a lower power state to a higher power state that is different from the lower power state; in response to detecting the occurrence of the event to transition the computer system from the lower power state to the higher power state: in accordance with a determination that a first set of criteria is satisfied, displaying, via the display generation component, a first element with a visual indication that the first element has input focus; and in accordance with a determination that the first set of criteria is not satisfied, forgoing display, via the display generation component, of the first element with the visual indication that the first element has input focus; detecting a first air gesture; and in response to detecting the first air gesture and in accordance with a determination that the first air gesture is a first type of gesture detected while displaying the visual indication that the first element has input focus, performing an operation corresponding to the first element.

In some embodiments, a computer system is described. The computer system is configured to communicate with a display generation component and comprises: one or more processors; and memory storing one or more programs configured to be executed by the one or more processors, the one or more programs including instructions for: detecting an occurrence of an event to transition the computer system from a lower power state to a higher power state that is different from the lower power state; in response to detecting the occurrence of the event to transition the computer system from the lower power state to the higher power state: in accordance with a determination that a first set of criteria is satisfied, displaying, via the display generation component, a first element with a visual indication that the first element has input focus; and in accordance with a determination that the first set of criteria is not satisfied, forgoing display, via the display generation component, of the first element with the visual indication that the first element has input focus; detecting a first air gesture; and in response to detecting the first air gesture and in accordance with a determination that the first air gesture is a first type of gesture detected while displaying the visual indication that the first element has input focus, performing an operation corresponding to the first element.

In some embodiments, a computer system is described. The computer system is configured to communicate with a display generation component and comprises: means for detecting an occurrence of an event to transition the computer system from a lower power state to a higher power state that is different from the lower power state; means, responsive to detecting the occurrence of the event to transition the computer system from the lower power state to the higher power state, for: in accordance with a determination that a first set of criteria is satisfied, displaying, via the display generation component, a first element with a visual indication that the first element has input focus; and in accordance with a determination that the first set of criteria is not satisfied, forgoing display, via the display generation component, of the first element with the visual indication that the first element has input focus; means for detecting a first air gesture; and means, responsive to detecting the first air gesture and in accordance with a determination that the first air gesture is a first type of gesture detected while displaying the visual indication that the first element has input focus, for performing an operation corresponding to the first element.

In some embodiments, a computer program product is described. The compute program product comprises one or more programs configured to be executed by one or more processors of a computer system that is in communication with a display generation component, the one or more programs including instructions for: detecting an occurrence of an event to transition the computer system from a lower power state to a higher power state that is different from the lower power state; in response to detecting the occurrence of the event to transition the computer system from the lower power state to the higher power state: in accordance with a determination that a first set of criteria is satisfied, displaying, via the display generation component, a first element with a visual indication that the first element has input focus; and in accordance with a determination that the first set of criteria is not satisfied, forgoing display, via the display generation component, of the first element with the visual indication that the first element has input focus; detecting a first air gesture; and in response to detecting the first air gesture and in accordance with a determination that the first air gesture is a first type of gesture detected while displaying the visual indication that the first element has input focus, performing an operation corresponding to the first element.

In some embodiments, a method is described. The method is performed at a computer system that is in communication with one or more display generation components and one or more input devices. The method comprises: displaying, via the one or more display generation components, a respective user interface; while displaying the respective user interface, detecting, via the one or more input devices, a hand input; and in response to detecting the hand input: in accordance with a determination that the hand input is a respective wrist gesture, performing a cancel operation associated with the respective user interface; and in accordance with a determination that the hand input is a first type of finger gesture that is different from the respective wrist gesture, performing an operation associated with the respective user interface that is different from the cancel operation.

In some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: displaying, via the one or more display generation components, a respective user interface; while displaying the respective user interface, detecting, via the one or more input devices, a hand input; and in response to detecting the hand input: in accordance with a determination that the hand input is a respective wrist gesture, performing a cancel operation associated with the respective user interface; and in accordance with a determination that the hand input is a first type of finger gesture that is different from the respective wrist gesture, performing an operation associated with the respective user interface that is different from the cancel operation.

In some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: displaying, via the one or more display generation components, a respective user interface; while displaying the respective user interface, detecting, via the one or more input devices, a hand input; and in response to detecting the hand input: in accordance with a determination that the hand input is a respective wrist gesture, performing a cancel operation associated with the respective user interface; and in accordance with a determination that the hand input is a first type of finger gesture that is different from the respective wrist gesture, performing an operation associated with the respective user interface that is different from the cancel operation.

In some embodiments, a computer system is described. The computer system is configured to communicate with one or more display generation components and one or more input devices, and comprises: one or more processors; and memory storing one or more programs configured to be executed by the one or more processors, the one or more programs including instructions for: displaying, via the one or more display generation components, a respective user interface; while displaying the respective user interface, detecting, via the one or more input devices, a hand input; and in response to detecting the hand input: in accordance with a determination that the hand input is a respective wrist gesture, performing a cancel operation associated with the respective user interface; and in accordance with a determination that the hand input is a first type of finger gesture that is different from the respective wrist gesture, performing an operation associated with the respective user interface that is different from the cancel operation.

In some embodiments, a computer system is described. The computer system is configured to communicate with one or more display generation components and one or more input devices, and comprises: means for displaying, via the one or more display generation components, a respective user interface; means, while displaying the respective user interface, for detecting, via the one or more input devices, a hand input; and means, responsive to detecting the hand input, for: in accordance with a determination that the hand input is a respective wrist gesture, performing a cancel operation associated with the respective user interface; and in accordance with a determination that the hand input is a first type of finger gesture that is different from the respective wrist gesture, performing an operation associated with the respective user interface that is different from the cancel operation.

In some embodiments, a computer program product is described. The computer program product comprises one or more programs configured to be executed by one or more processors of a computer system that is in communication with one or more display generation components and one or more input devices, the one or more programs including instructions for: displaying, via the one or more display generation components, a respective user interface; while displaying the respective user interface, detecting, via the one or more input devices, a hand input; and in response to detecting the hand input: in accordance with a determination that the hand input is a respective wrist gesture, performing a cancel operation associated with the respective user interface; and in accordance with a determination that the hand input is a first type of finger gesture that is different from the respective wrist gesture, performing an operation associated with the respective user interface that is different from the cancel operation.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing air gesture inputs, thereby increasing the effectiveness, efficiency, and user satisfaction with such devices. Such methods and interfaces may complement or replace other methods for managing air gesture inputs.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6AC illustrate exemplary user interfaces for managing air gestures, in accordance with some embodiments.

FIG. 7 is a flow diagram illustrating methods of managing air gestures, in accordance with some embodiments.

FIGS. 8A-8W illustrate exemplary user interfaces for managing air gestures, in accordance with some embodiments.

FIG. 9 is a flow diagram illustrating methods of managing air gestures, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing air gesture inputs. For example, it is advantageous to conditionally perform one or more operations based on an input focus and a received air gesture. Such techniques can reduce the cognitive burden on a user who uses air gestures, thereby enhancing productivity. Further, such techniques can reduce processor and battery power otherwise wasted on redundant user inputs.

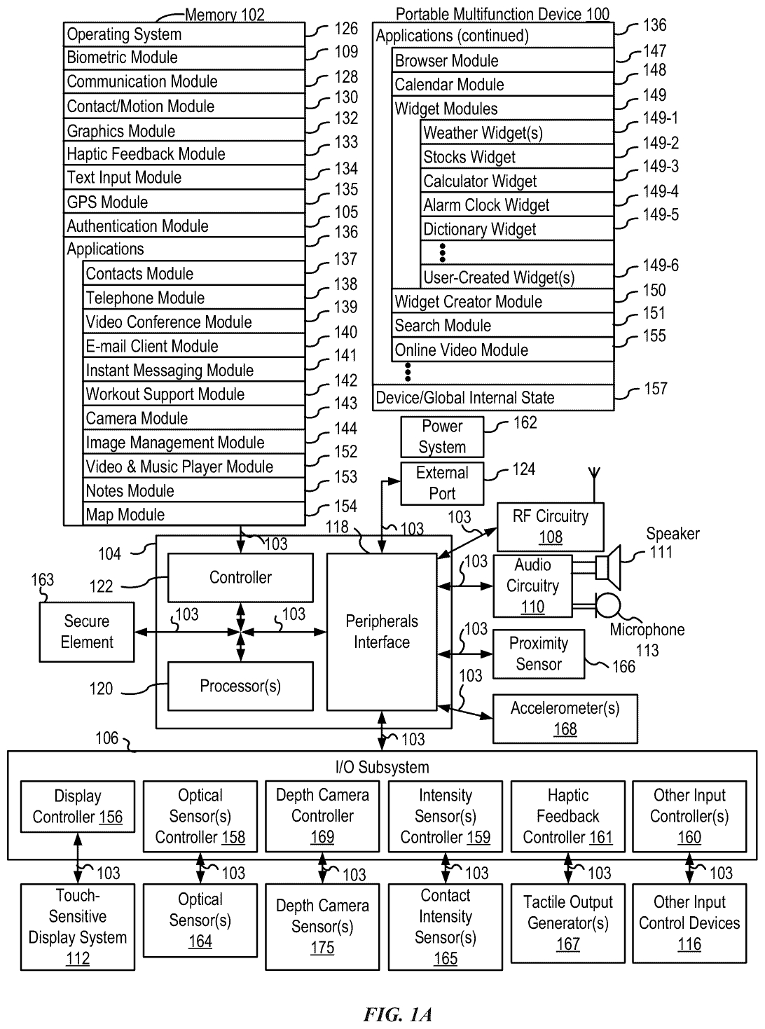

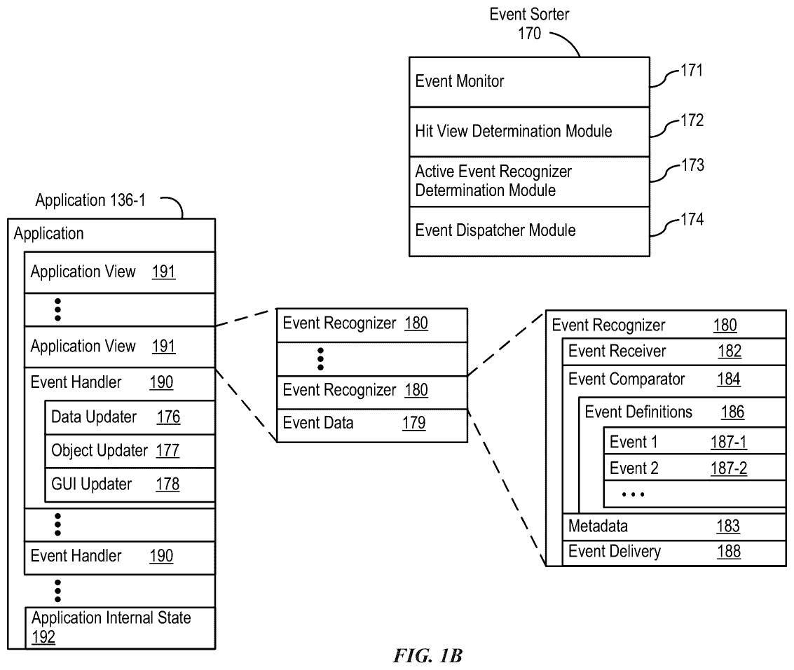

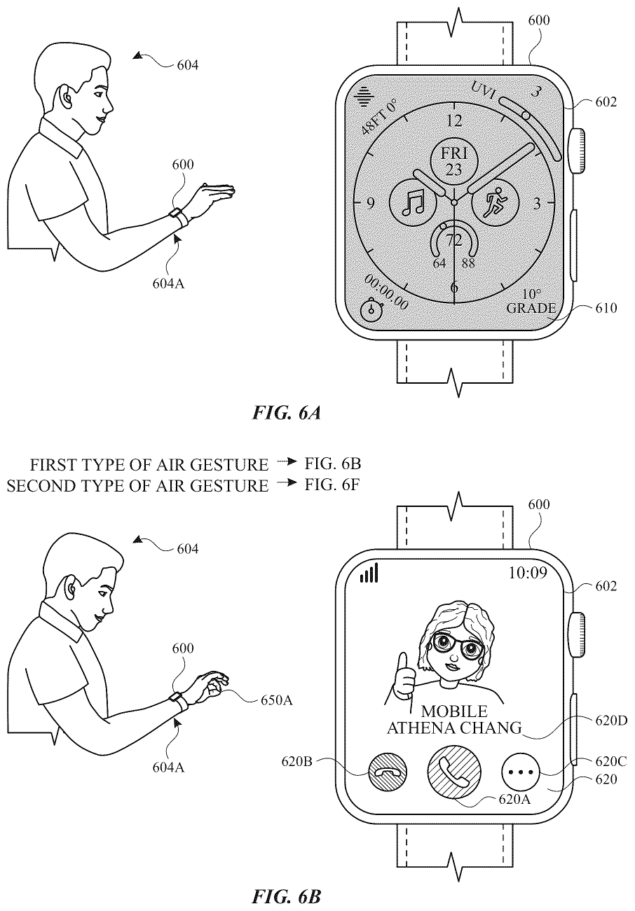

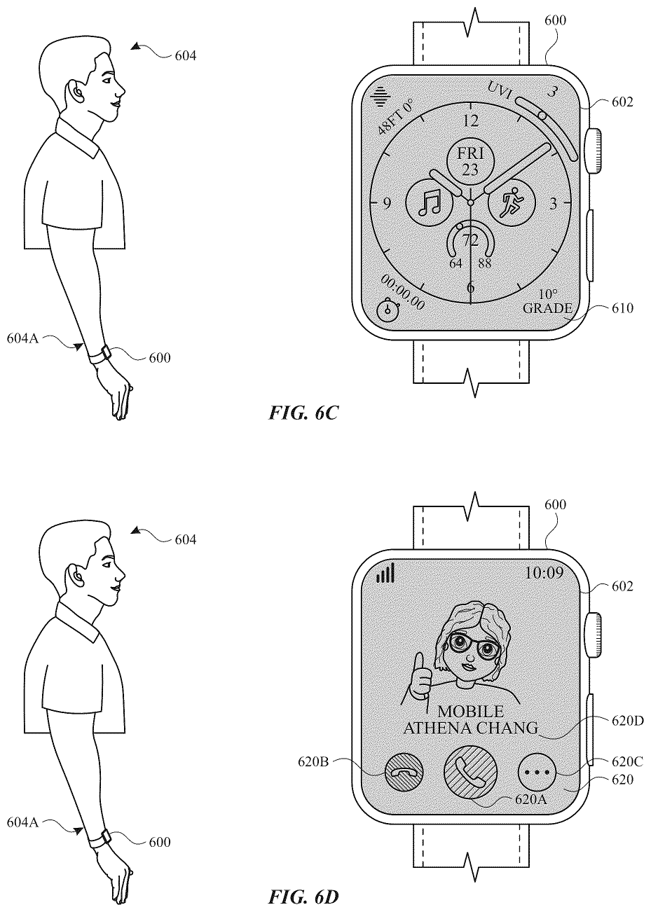

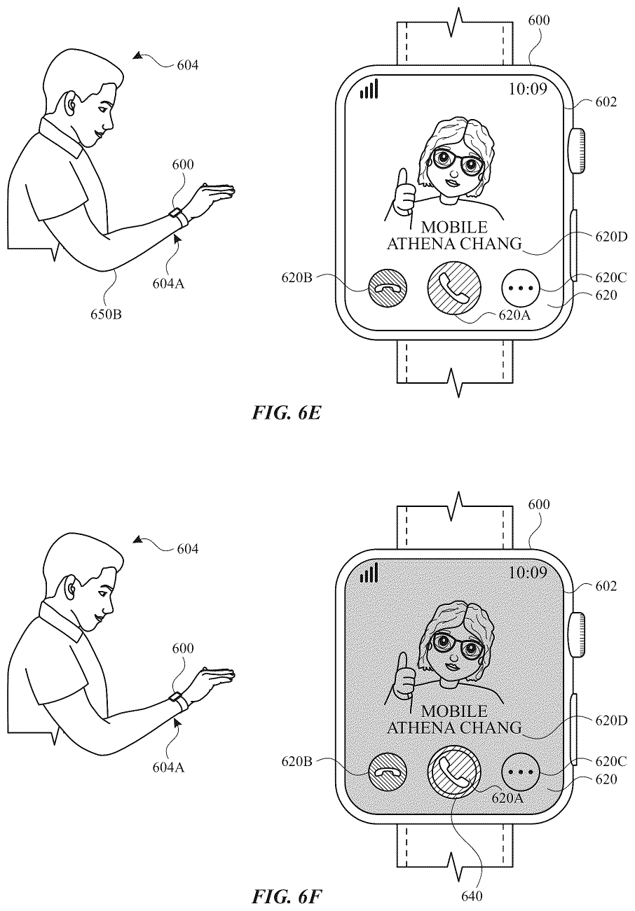

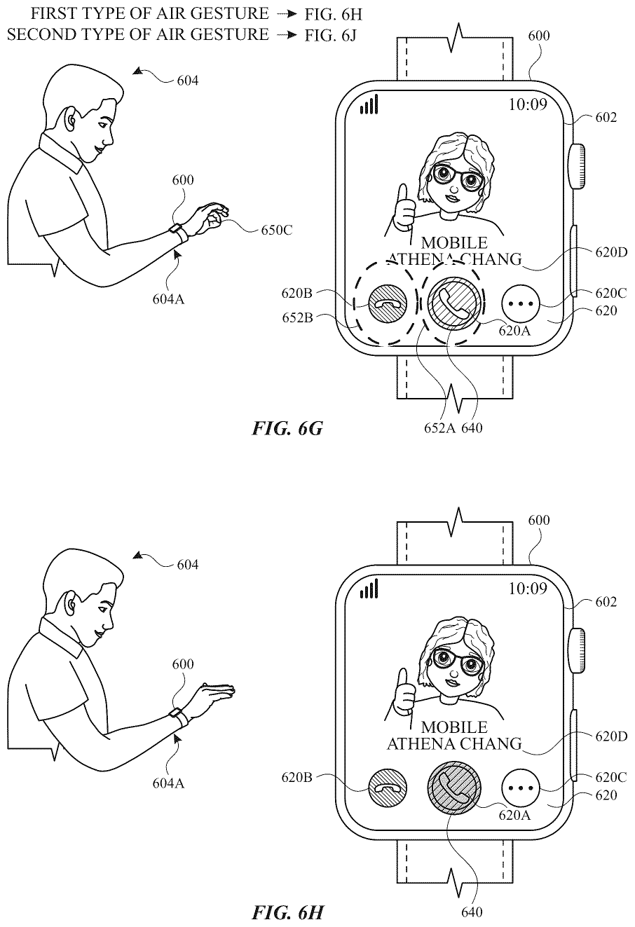

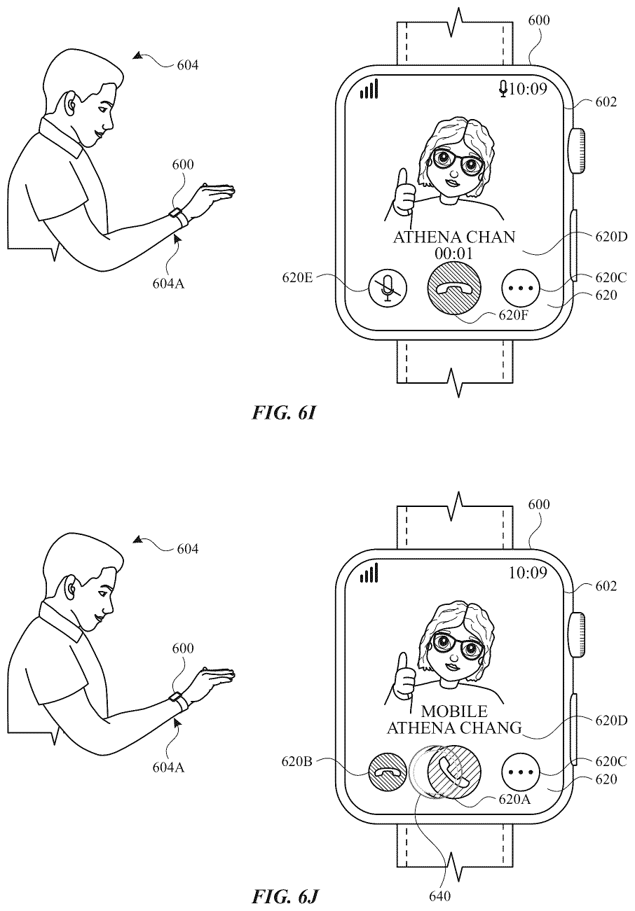

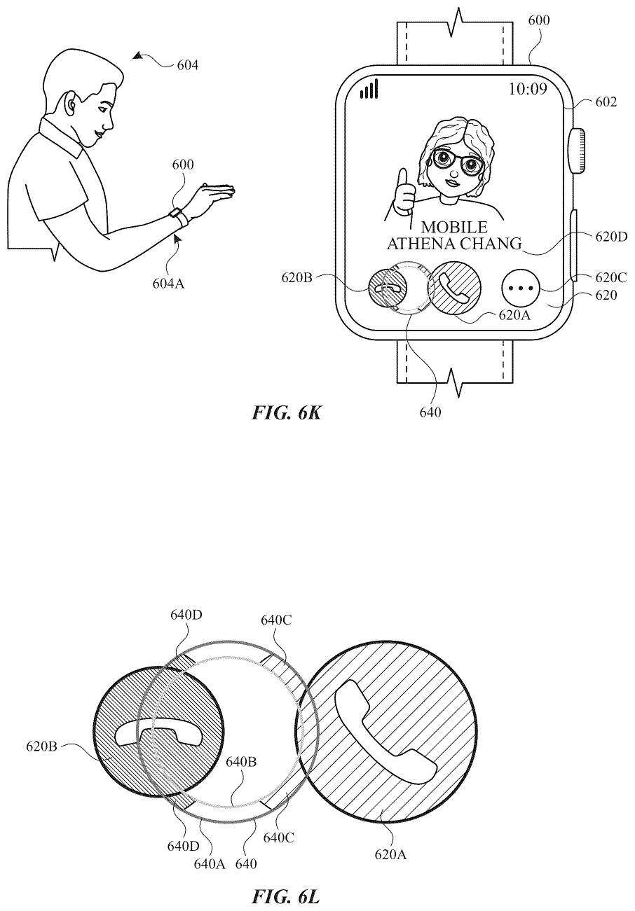

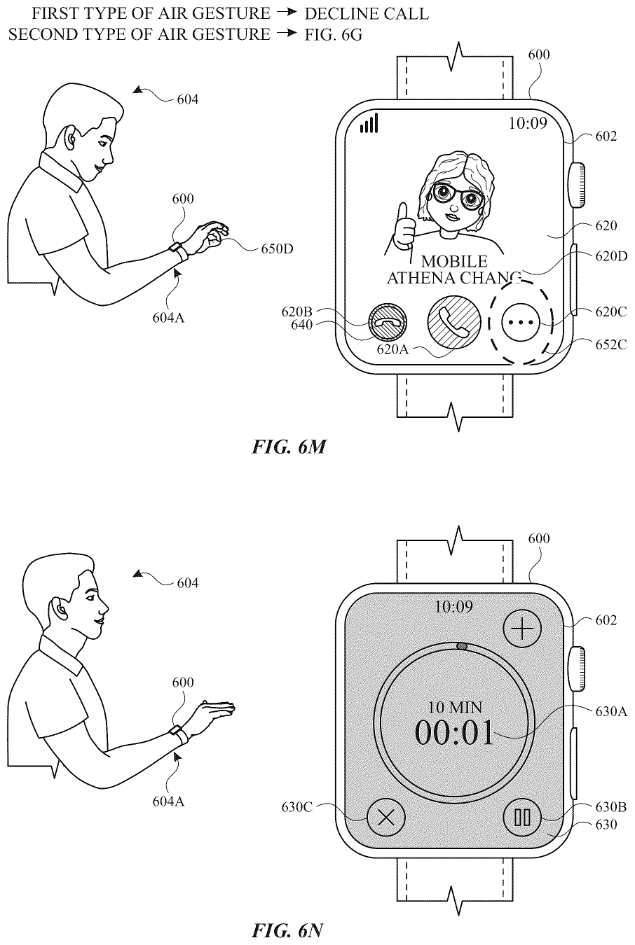

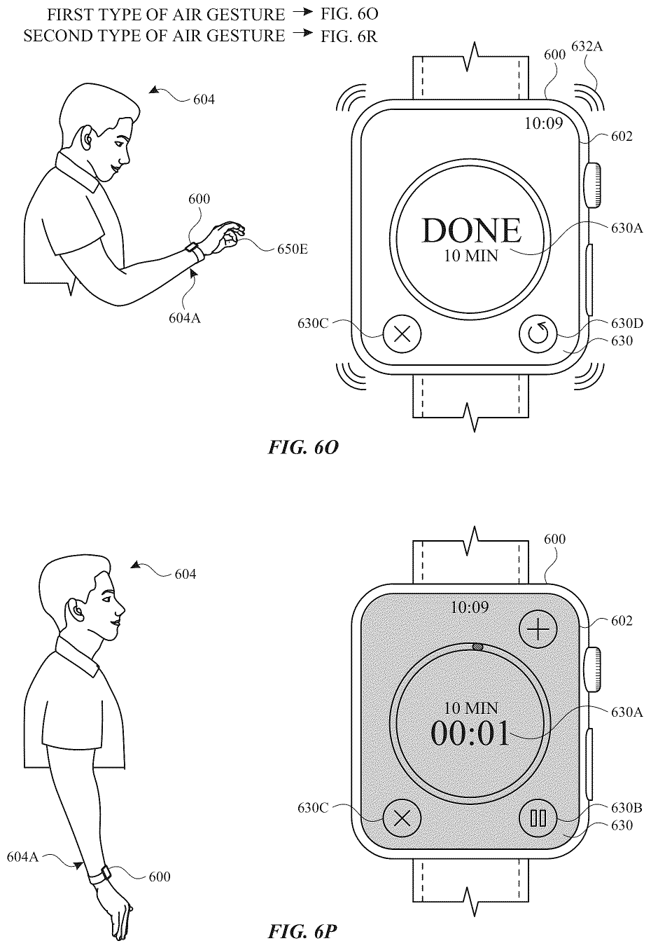

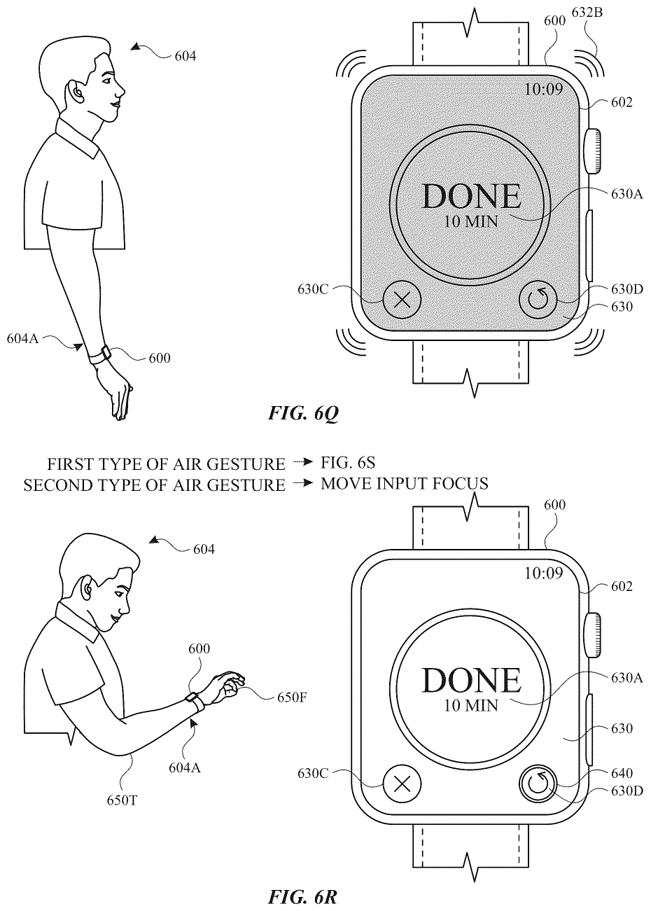

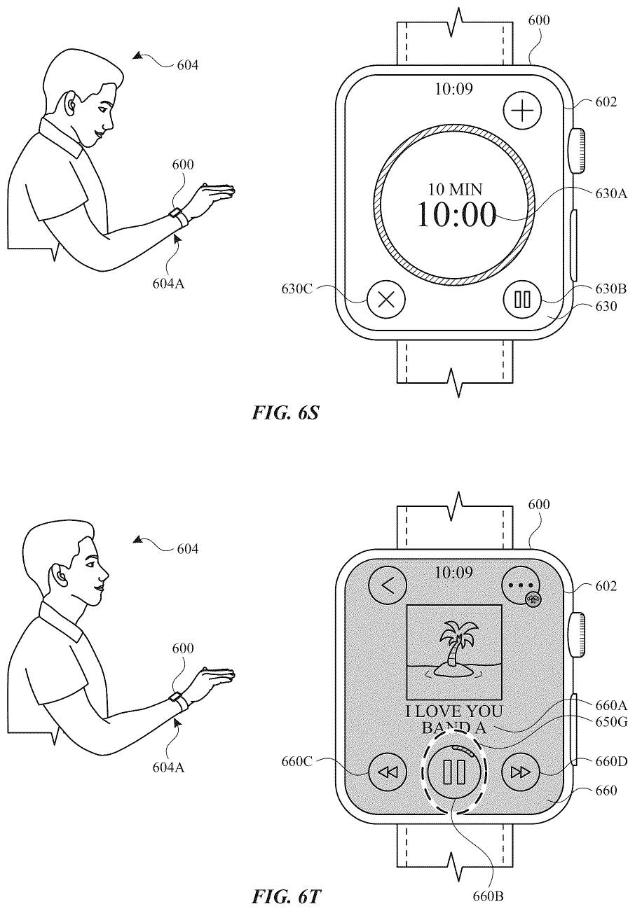

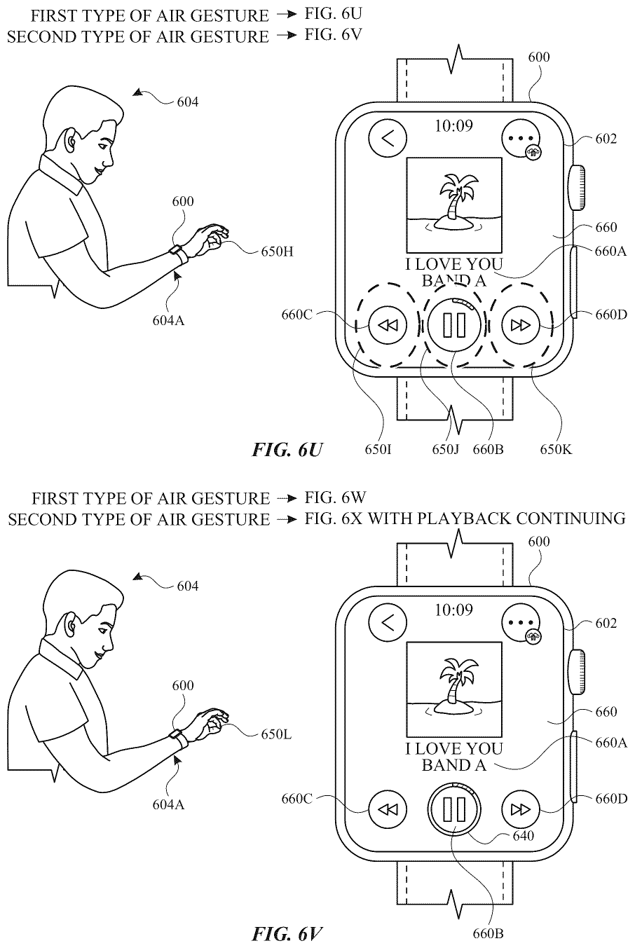

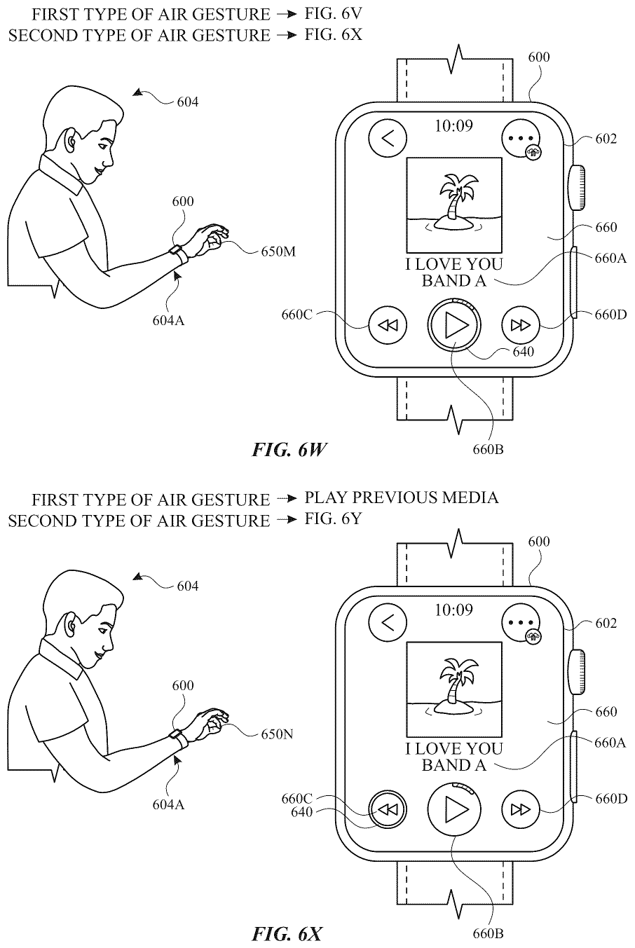

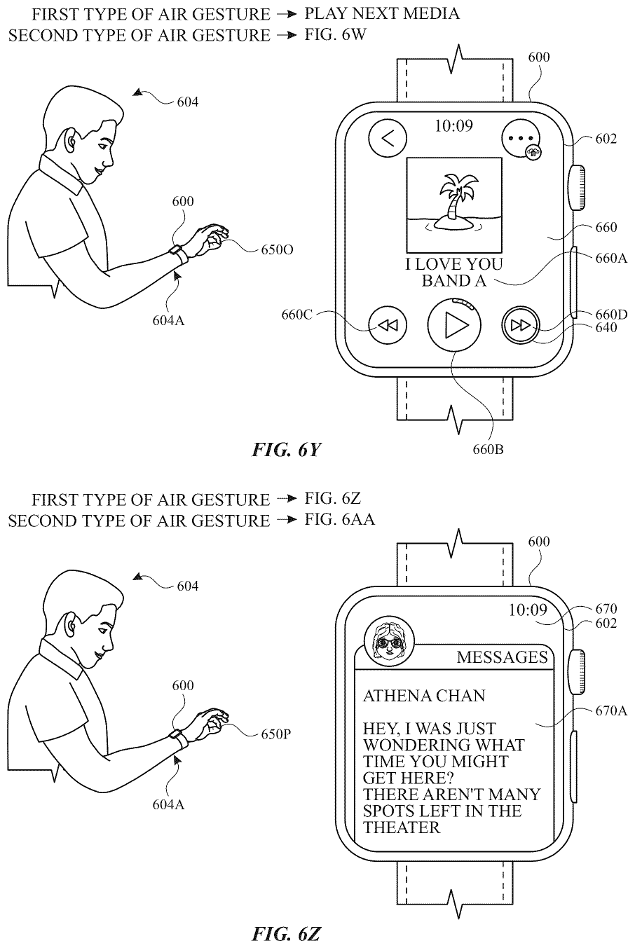

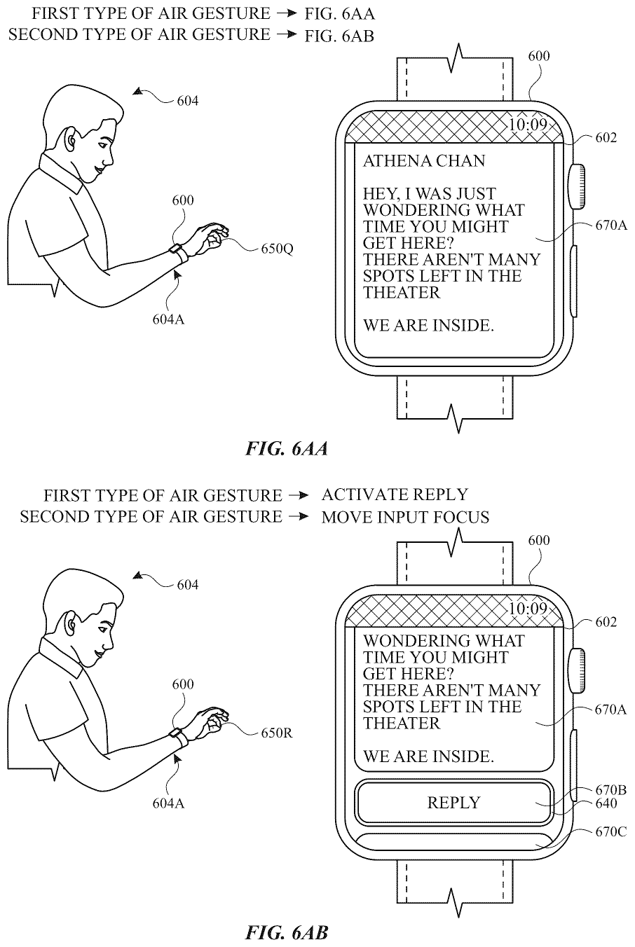

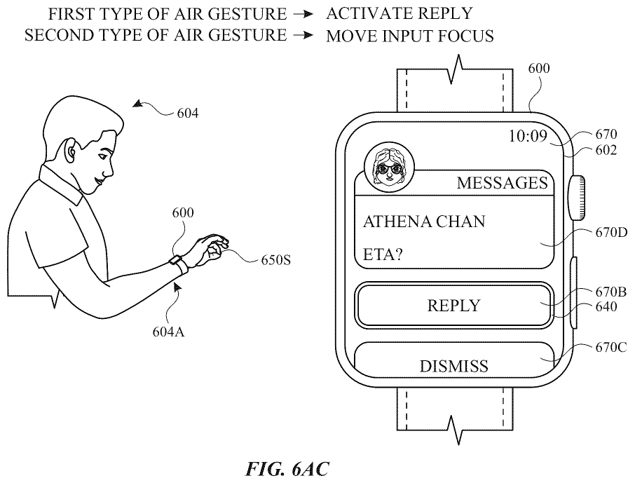

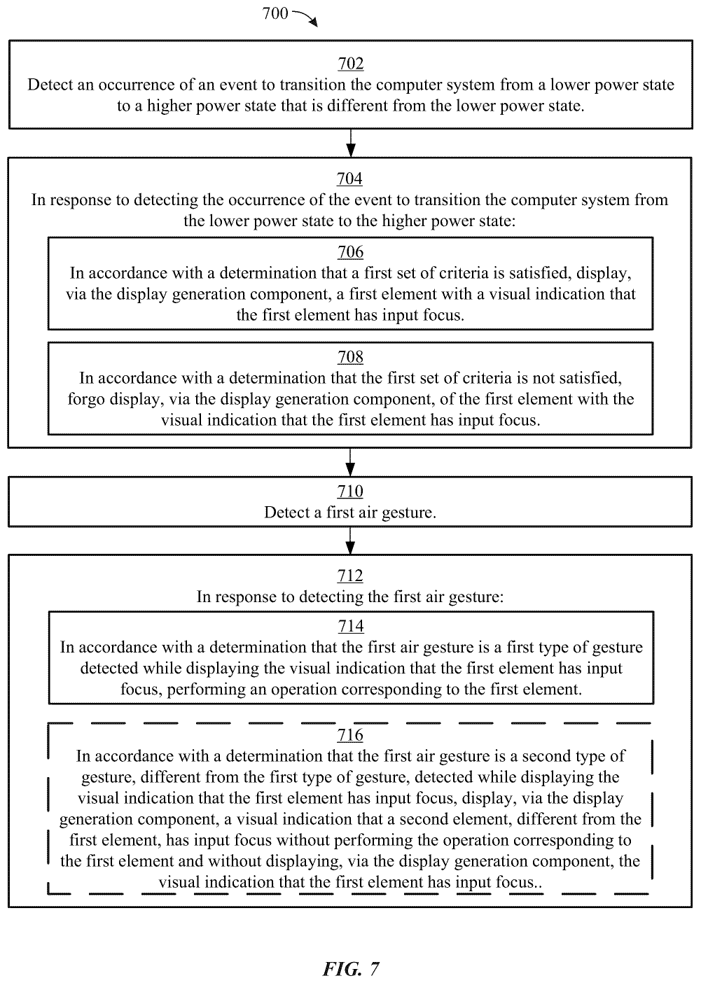

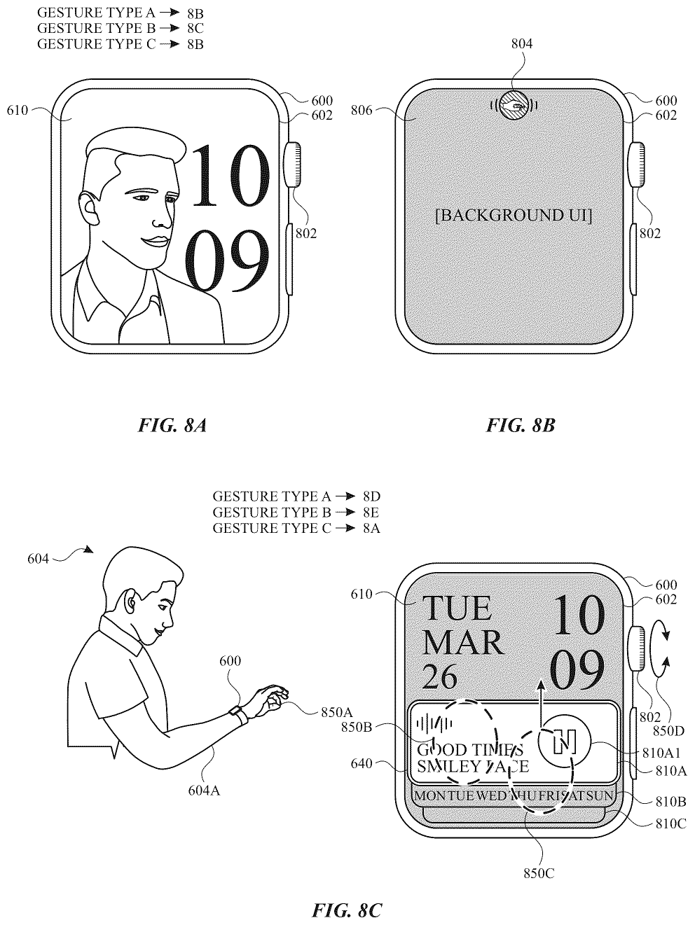

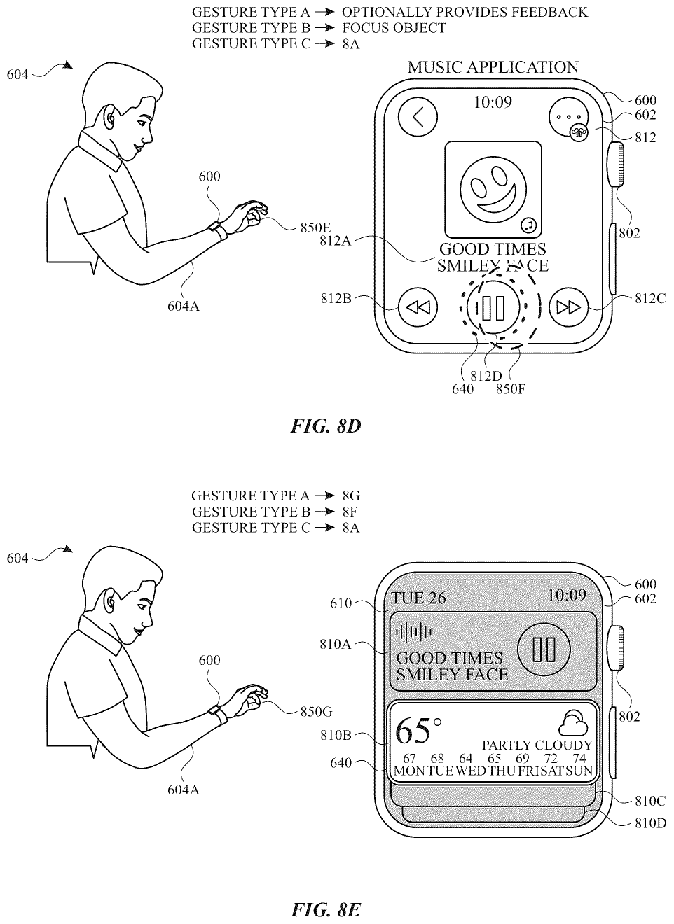

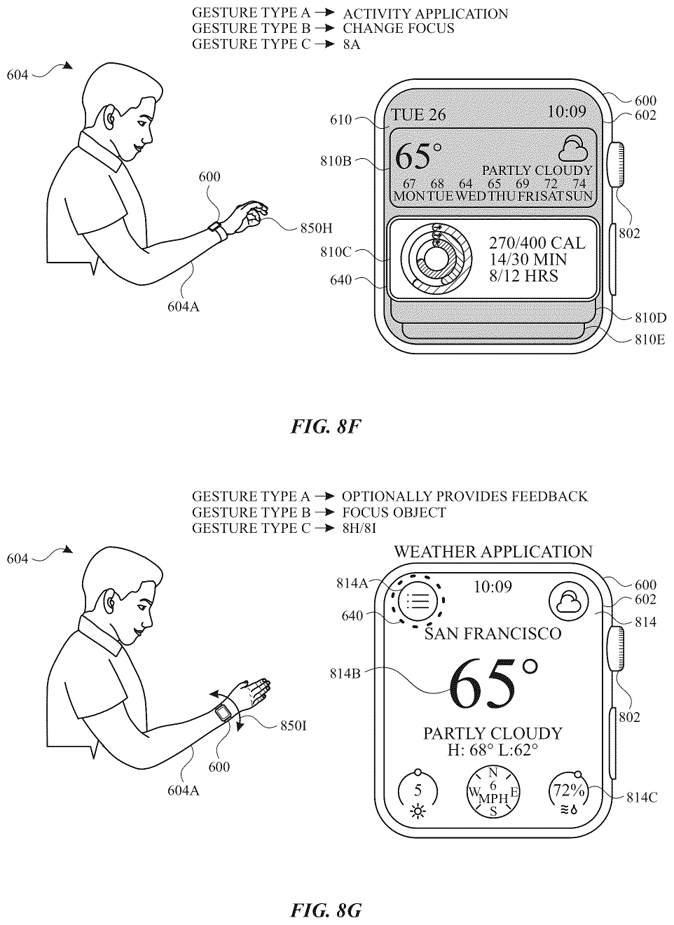

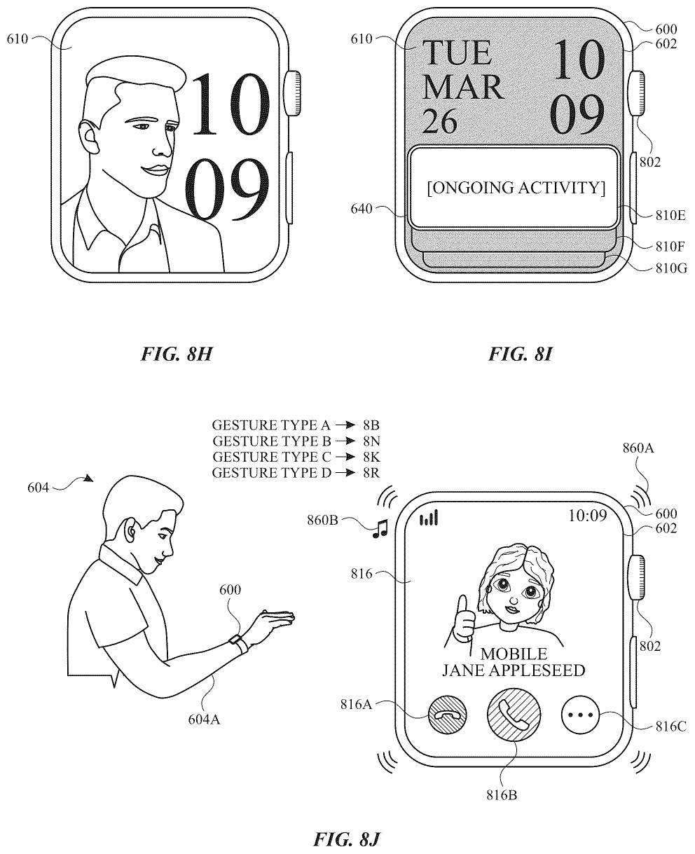

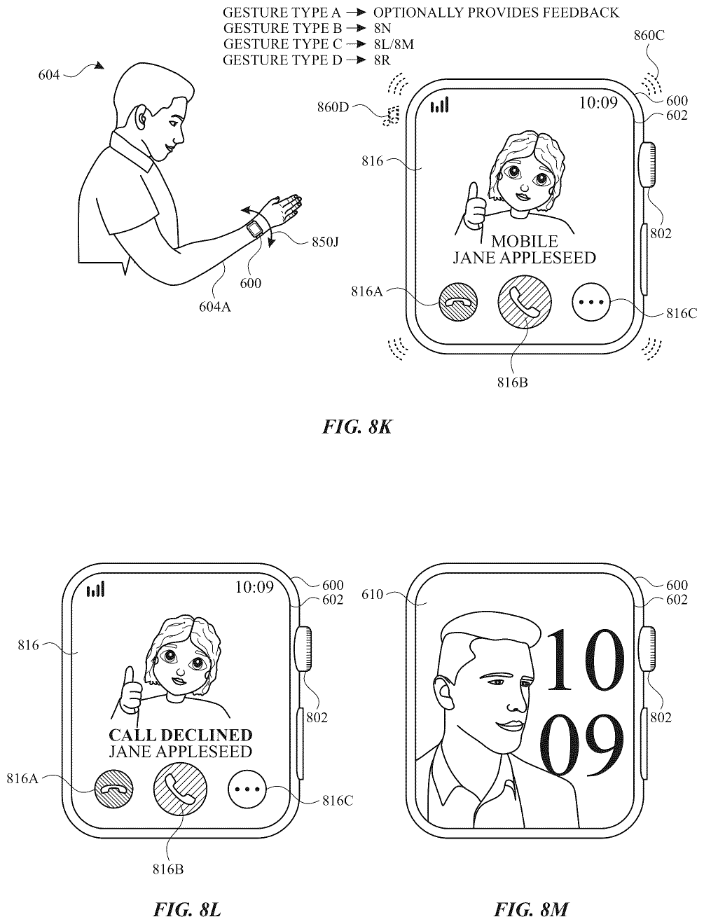

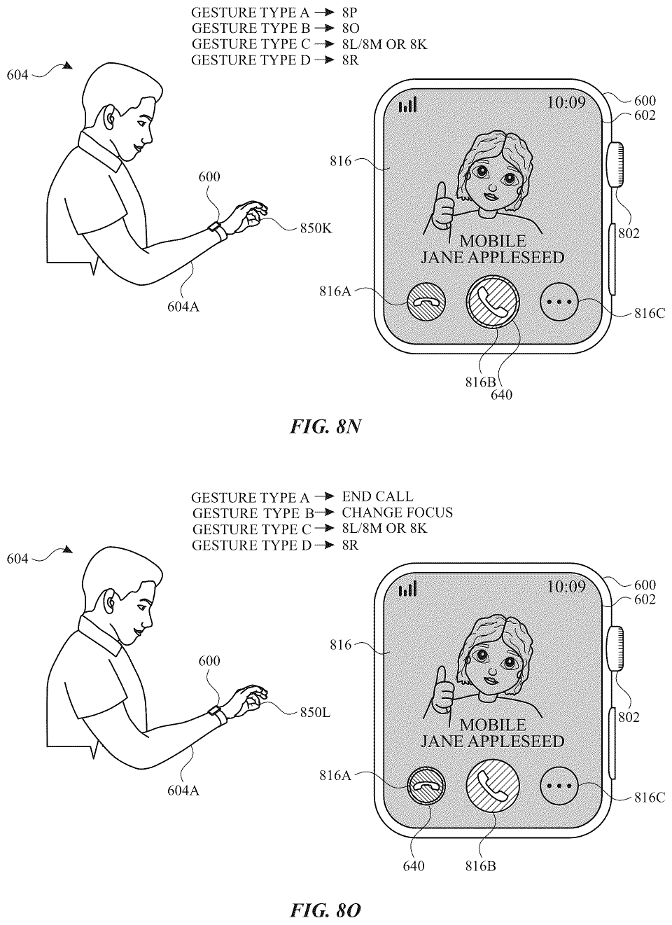

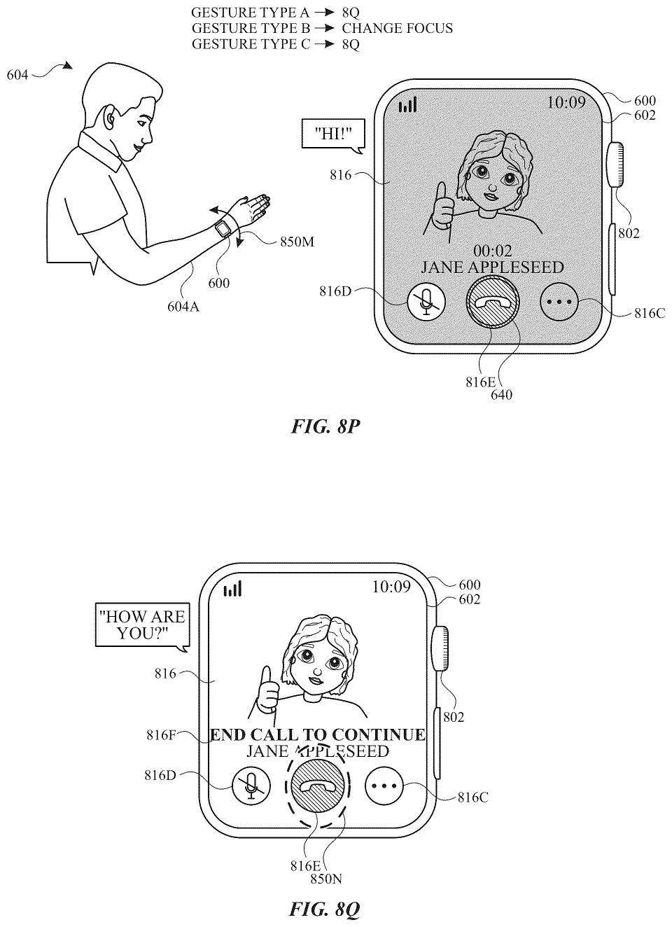

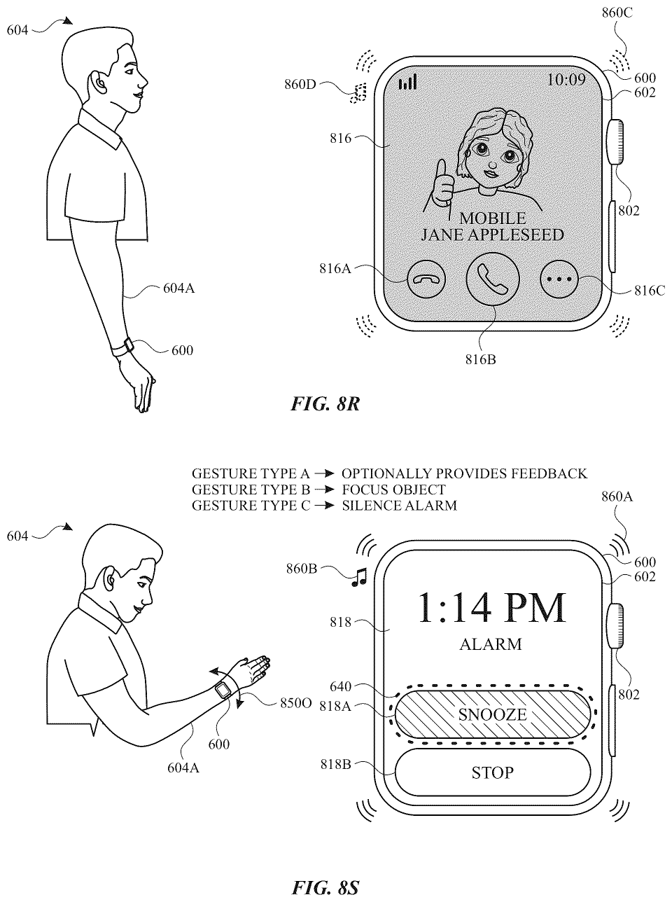

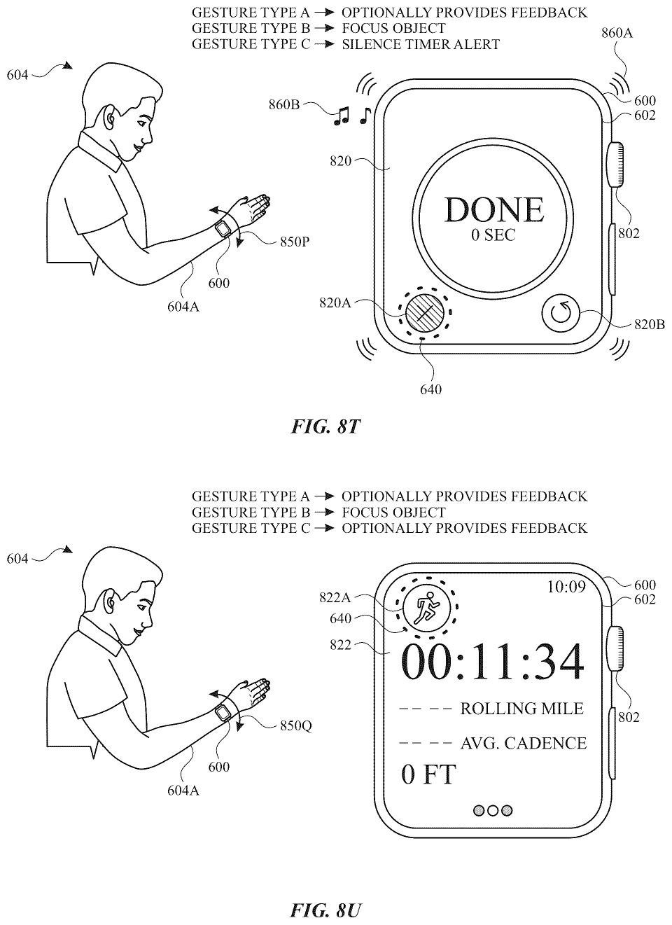

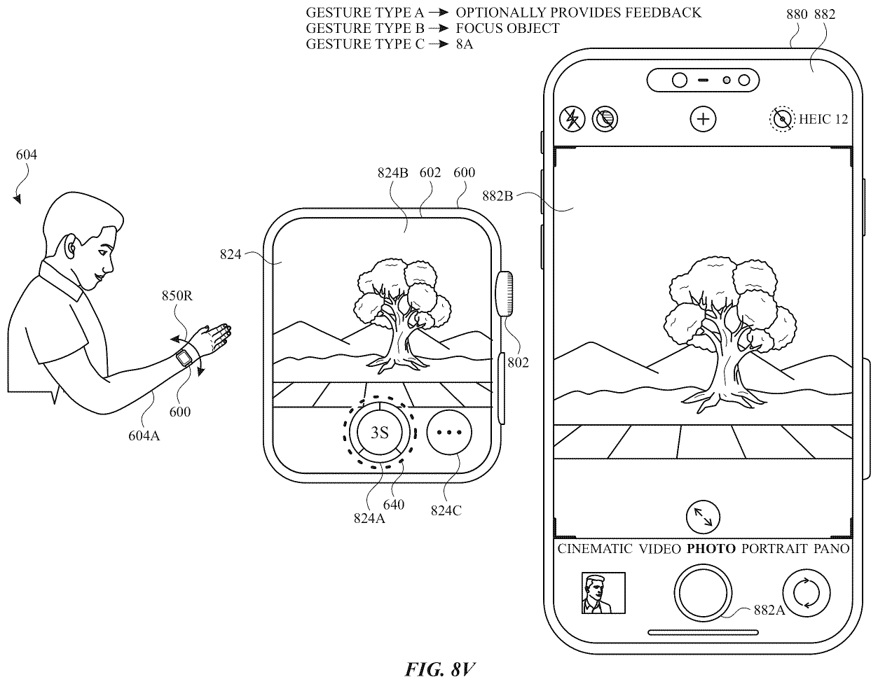

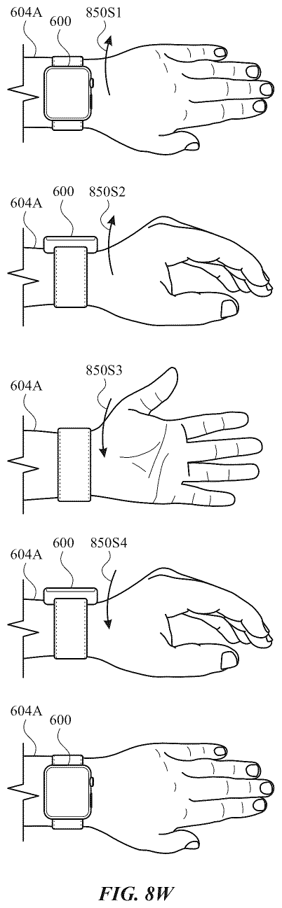

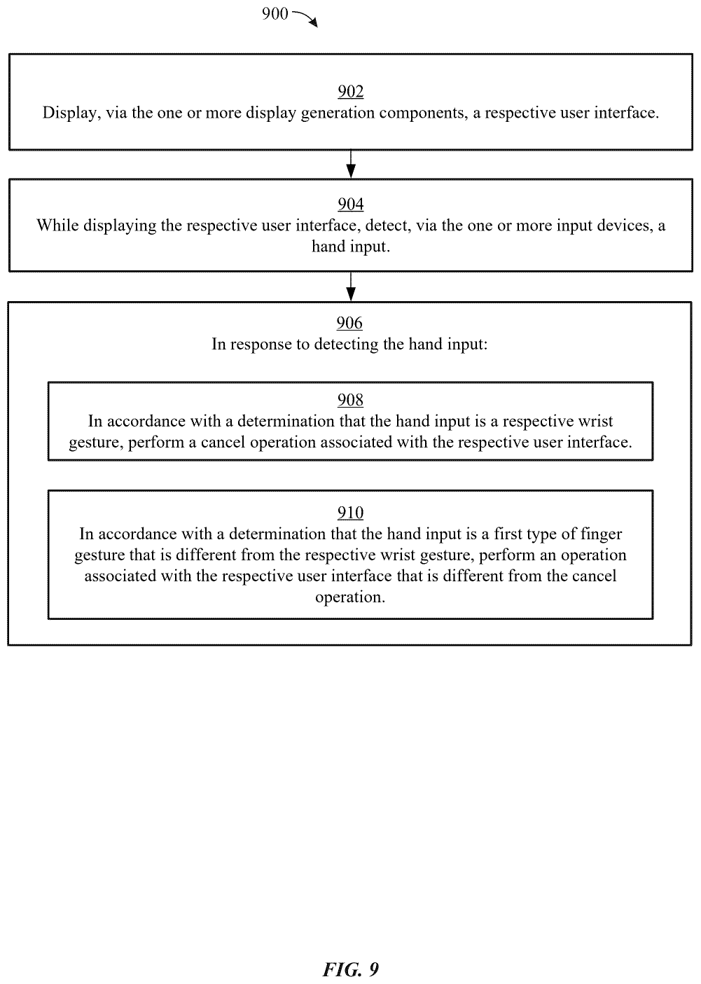

Below, FIGS. 1A-1B, 2, 3A, 4A-4B, and 5A-5B provide a description of exemplary devices for performing the techniques for managing air gesture inputs. FIGS. 6A-6AC illustrate exemplary user interfaces for managing air gestures, in accordance with some embodiments. FIG. 7 is a flow diagram illustrating methods of managing air gestures, in accordance with some embodiments. The user interfaces in FIGS. 6A-6AC are used to illustrate the processes described below, including the processes in FIG. 7. FIGS. 8A-8W illustrate exemplary user interfaces for managing air gestures, in accordance with some embodiments. FIG. 9 is a flow diagram illustrating methods of managing air gestures, in accordance with some embodiments. The user interfaces in FIGS. 8A-8W are used to illustrate the processes described below, including the processes in FIG. 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage media), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

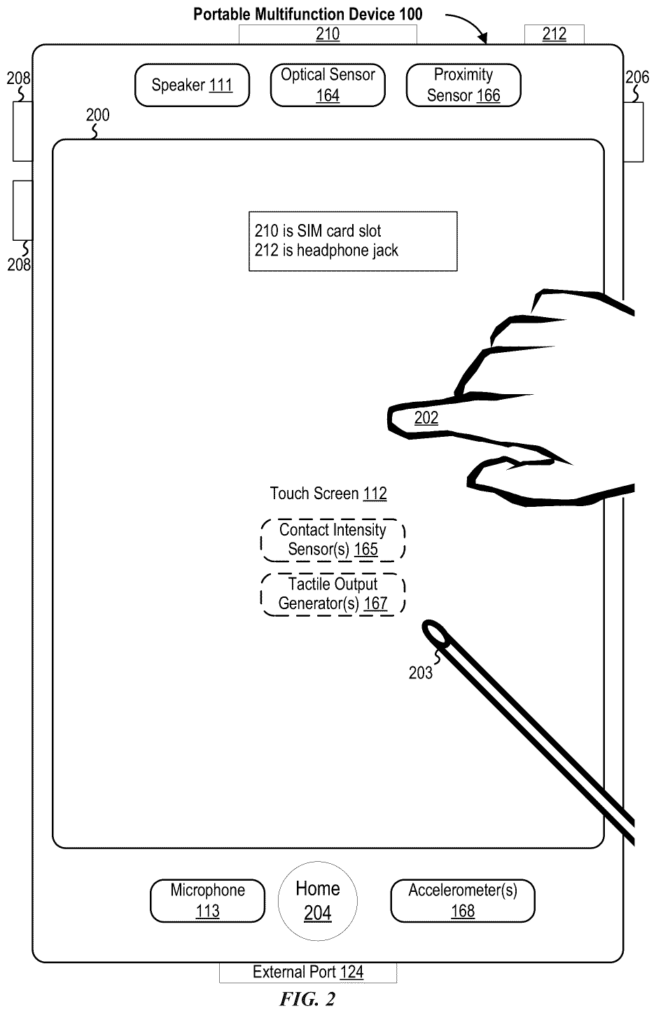

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) (e.g., even if the user is touching a different part of the device such as a housing of the device or a light seal of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, a gesture (e.g., a motion gesture) includes an air gesture. In some embodiments, input gestures (e.g., motion gestures) used in the various examples and embodiments described herein include air gestures performed by movement of the user's finger(s) relative to other finger(s) (or part(s) of the user's hand) for interacting with a computer system, in some embodiments. In some embodiments, an air gesture is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body). In some embodiments, the motion of the portion(s) of the user's body is not directly detected and is inferred from measurements/data from one or more sensors (e.g., one or more accelerometers, one or more gyroscopes, an inertial measurement unit (IMU), one or more visual sensors, one or more muscle sensors, one or more electromyography sensors, and/or one or more electrical impulse sensors).

In some embodiments, input gestures (e.g., air gestures) used in the various examples and embodiments described herein include pinch inputs and tap inputs, for interacting with a computer system, in some embodiments. For example, the pinch inputs and tap inputs described below are optionally performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture (optionally referred to as a pinch air gesture) includes movement of two or more fingers of a hand to make contact with one another, that is, optionally, followed by an immediate (e.g., within 0-1 seconds) break in contact from each other. In some embodiments, the contact of the portions of the user's body (e.g., two or more fingers) is not directly detected and is inferred from measurements/data from one or more sensors (one or more accelerometers, one or more gyroscopes, an inertial measurement unit (IMU), one or more visual sensors, one or more muscle sensors, one or more electromyography sensors, and/or one or more electrical impulse sensors). A long pinch gesture that is an air gesture (optionally referred to as a pinch-and-hold air gesture or a long pinch air gesture) includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture (optionally referred to as a double-pinch air gesture) comprises two (e.g., or more) pinch inputs (e.g., performed by the same hand) detected in immediate (e.g., within a predefined time period, such as 1 second or 2 seconds) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

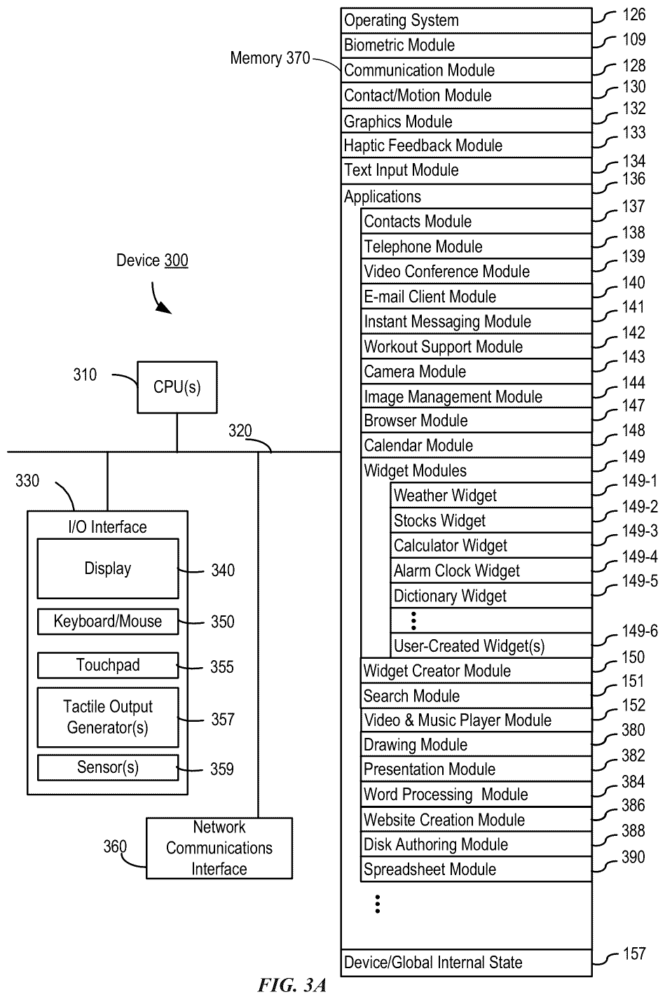

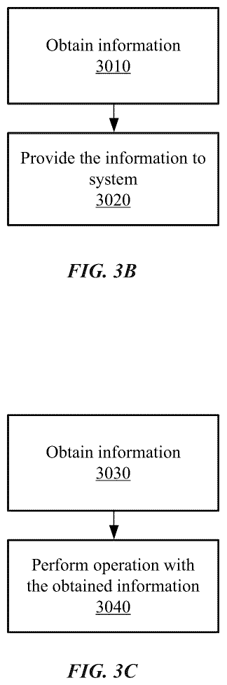

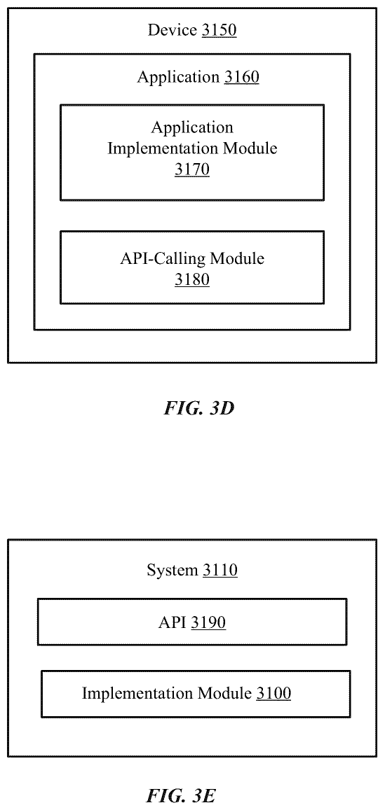

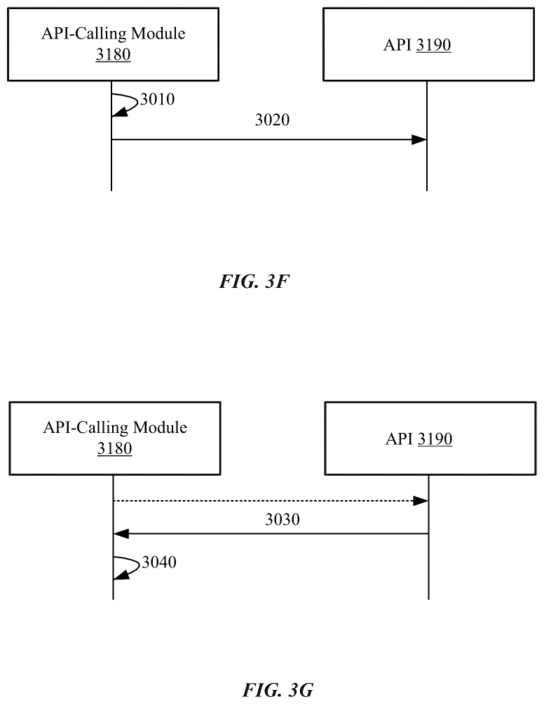

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

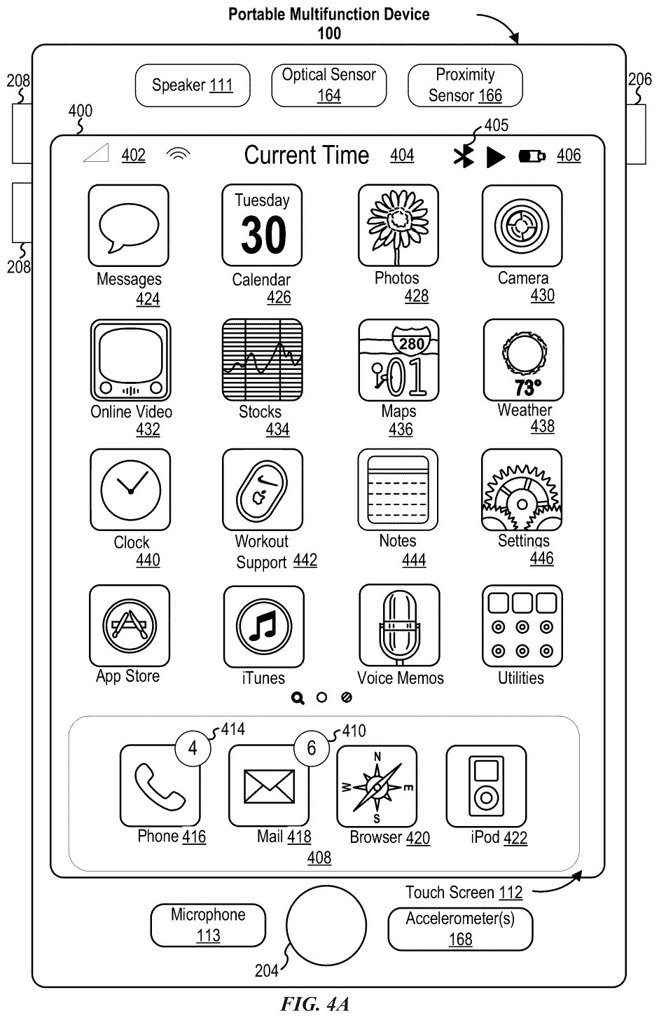

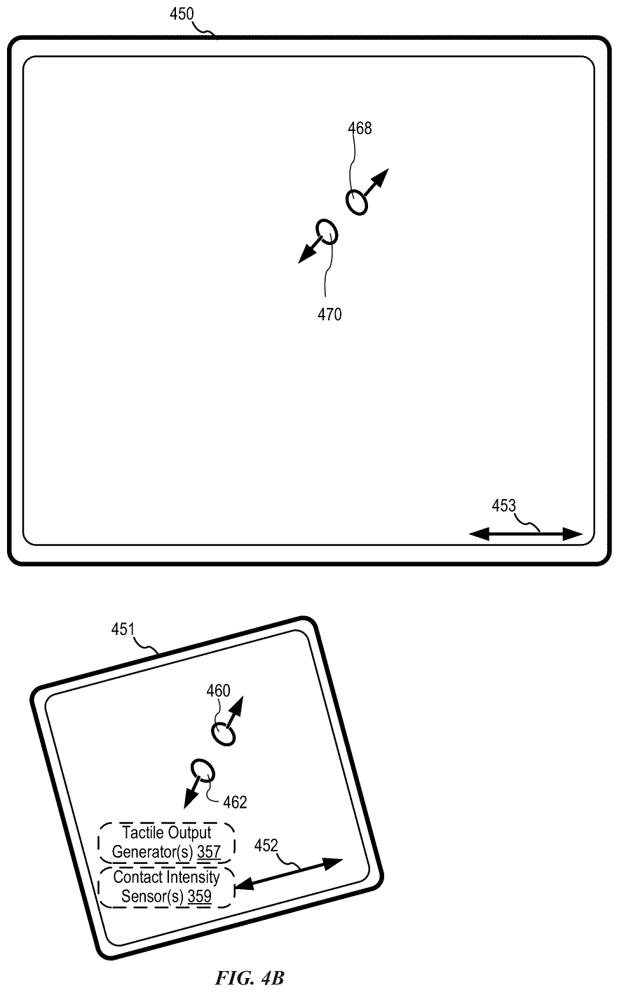

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

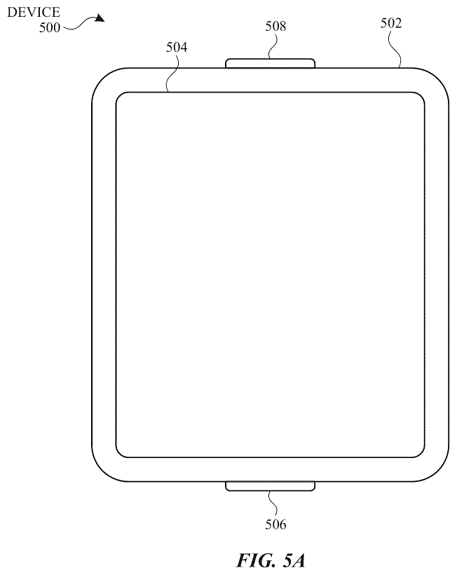

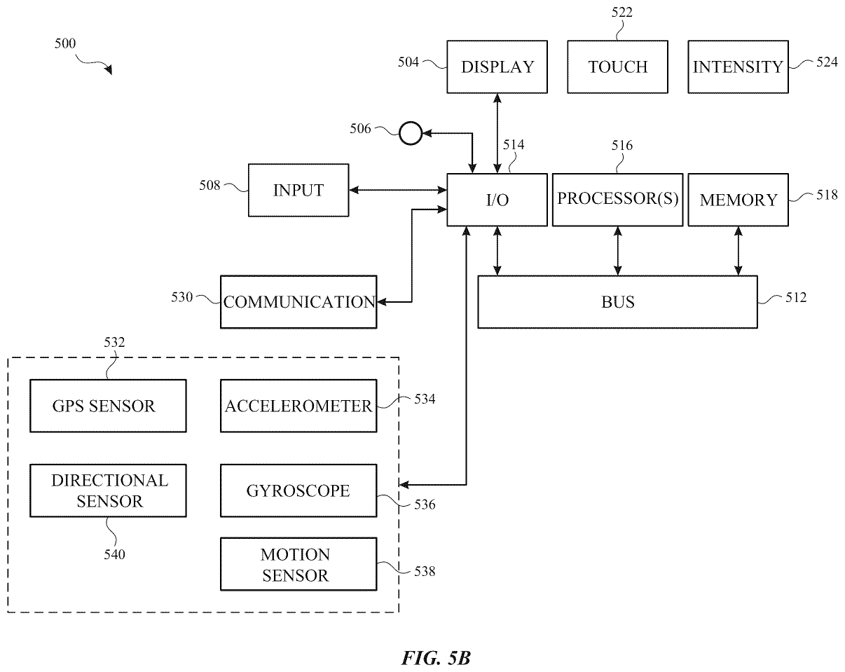

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage media, for storing computer-executable instructions, which, when executed by one or more computer processors 516, for example, can cause the computer processors to perform the techniques described below, including process 700 (FIG. 7). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

Attention is now directed towards embodiments of user interfaces (“UI”) and associated processes that are implemented on an electronic device, such as portable multifunction device 100, device 300, or device 500.

FIGS. 6A-6AC illustrate exemplary user interfaces for managing air gestures, in accordance with some embodiments. The user interfaces in these figures are used to illustrate the processes described below, including the processes in FIG. 7.

FIGS. 6A-6M illustrate user interfaces for a real-time call. FIG. 6A illustrates wrist-worn computer system 600 (e.g., also referred to as computer system 600) (e.g., a smart watch and/or a smart band) being worn on wrist 604A of user 604. Computer system 600 includes display 602, which is optionally a touch-screen display. At FIG. 6A, computer system 600 is displaying a time user interface, such as watch face 610, which is a user interface that includes an indication of the current time and a plurality of complications. In some embodiments, complications display information received from respective applications of computer system 600. At FIG. 6A, computer system 600 is operating in a low-power mode (e.g., low-power screen display and/or low-power processor configuration), as illustrated in FIG. 6A by the dimmed view of watch face 610 on display 602. For ease of reference, computer system 600 is in the low-power mode during FIGS. 6A and 6C-6D and is not in the low-power mode during FIGS. 6B and 6E-6M. In some embodiments, computer system 600 displays one or more other time user interfaces in place of, or in addition to, watch face 610 (e.g., as part of the process described with respect to FIGS. 6A-6M). For example, in some embodiments, computer system 600 displays a time user interface (e.g., other than watch face 610) while computer system 600 is in the low-power mode at FIGS. 6A and 6C. In some embodiments, the time user interface(s) include an indication of the current time, are not watch user interfaces, and/or do not include complications.

Although FIGS. 6A-6M are illustrated and described with respect to watch face 610, it should be recognized that other time user interfaces can be used instead of, or in addition to, watch face 610. For example, computer system 600 optionally displays a time user interface (e.g., instead of watch face 610) that is a lock screen with an indication of the current time (e.g., when computer system 600 is a smart phone and/or a tablet). For another example, computer system 600 optionally displays a time user interface (e.g., instead of watch face 610) that includes a prompt for authentication (e.g., for entering a password, for entering a passcode, and/or for providing biometric authentication) with an indication of the current time.

At FIG. 6A, while in the low-power mode, computer system 600 detects an incoming call (e.g., audio and/or video call). Because wrist 604A of user 604 is already raised when computer system 600 detects the incoming call, in response to detecting the incoming call, computer system 600 transitions out of the low-power mode (e.g., into a normal-power mode and/or a high-power mode), as illustrated in FIG. 6B by display 602 not being dimmed, and displays call user interface 620 without any elements of call user interface 620 having input focus. For example, call user interface 620 at FIG. 6B includes answer element 620A for answering the call, decline element 620B for declining the call, menu element 620C for accessing additional options, and status information 620D about the call (e.g., a name of the caller).

At FIG. 6B, while displaying call user interface 620, computer system 600 detects air gesture 650A performed by user 604. In response to detecting air gesture 650A and in accordance with a determination that air gesture 650A is a first type of air gesture (e.g., single tap air gesture and/or a single tap-and-hold air gesture), computer system 600 forgoes displaying an input focus and optionally continues to display call user interface 620 without an input focus (optionally, without performing any other operation because no input focus is displayed when the first type of air gesture is detected). In response to detecting air gesture 650A and in accordance with a determination that air gesture 650A is a second type of air gesture (e.g., double tap air gesture and/or a double tap-and-hold air gesture), computer system 600 initiates a process to display an input focus by transitioning to the user interface of FIG. 6F. In some embodiments, a tap air gesture (e.g., single tap and/or double tap) is the same as a pinch air gesture (e.g., single pinch and/or double pinch). In some embodiments, a tap-and-hold air gesture (e.g., single tap and hold and/or double tap and hold) is the same as a pinch-and-hold air gesture (e.g., single pinch and hold and/or double pinch and hold). In some embodiments a double tap and hold gesture is referred to as a tap and a half (e.g., touching down, lifting off, and then touching down again and holding). In some embodiments a double pinch and hold gesture is referred to as a pinch and a half (e.g., pinching, unpinching, and then pinching again and holding). Thus, in some embodiments, when the second type of air gesture (e.g., double tap air gesture and/or a double tap-and-hold air gesture) is detected when input focus is not displayed, the computer system displays the input focus.

At FIG. 6C, computer system 600 is operating in the low-power mode (e.g., low-power screen display and/or low-power processor configuration), as illustrated in FIG. 6C by the dimmed view of watch face 610 on display 602, while wrist 604A is not raised. At FIG. 6C, while in the low-power mode, computer system 600 detects an incoming call (e.g., audio and/or video call). Because wrist 604A of user 604 is not raised when computer system 600 detects the incoming call, in response to detecting the incoming call, computer system 600 does not transition out of the low-power mode (e.g., does not transition into a normal-power mode and/or a high-power mode), as illustrated in FIG. 6D by display 602 remaining dimmed, and displays call user interface 620 without any elements of call user interface 620 having input focus. In some embodiments, computer system 600 does not perform any operations in response to detecting the first type of air gesture and/or the second type of air gesture while in the low-power mode, such as at FIG. 6D. In some embodiments, computer system 600 does not monitor for the first type and/or the second type of air gestures while in the low-power mode, such as at FIG. 6D, and thus when a user motion is performed that would otherwise meet the criteria for the gesture, it does not cause the computer system to respond in the way that the computer system would typically respond to the gesture because the computer system does not detect the gesture (e.g., because the computer system was not monitoring for the gesture).

At FIG. 6D, while displaying call user interface 620, computer system 600 detects wrist raise 650B of wrist 604A, as shown in FIG. 6E. At FIG. 6E, in response to detecting wrist raise 650B of wrist 604A during the incoming call, computer system 600 transitions out of the low-power mode (e.g., into a normal-power mode and/or a high-power mode), continues to display call user interface 620, and initiates a process to display an input focus. In some embodiments, as shown in FIG. 6F, the process to display the input focus includes emphasizing elements of the user interface that can be selected via air gestures. For example, at FIG. 6F, computer system 600 emphasizes answer element 620A and decline element 620B by reducing a brightness of other portions (e.g., 620C and 620D) of call user interface 620 and/or computer system 600 emphasizes answer element 620A and decline element 620B by increasing a brightness of answer element 620A and decline element 620B (e.g., relative to other portions of call user interface 620). By emphasizing the elements that can be selected via air gestures, computer system 600 indicates to the user which elements the user can select (and, optionally, activate) via air gestures and without the need to use other forms of input (e.g., without using touch inputs or button presses). At FIG. 6F, computer system 600 also displays (e.g., before or after emphasizing the elements that can be selected via air gestures) input focus 640 on a primary element (e.g., a default element, a largest element, and/or a most prominent element) of call user interface 620 (e.g., without displaying an input focus on any other element of call user interface 620), such as answer element 620A.

At FIG. 6G, as part of the process to display the input focus, computer system 600 ceases emphasizing the elements that can be selected via air gestures and continues to display input focus 640 on the primary element (e.g., 620A). At FIG. 6G, while displaying call user interface 620 and answer element 620A having input focus 640, computer system 600 detects a user input. In response to detecting the user input and in accordance with a determination that the user input is touch input 652A directed to answer element 620A, computer system 600 answers the call (e.g., as shown in FIG. 6I). In response to detecting the user input and in accordance with a determination that the user input is touch input 652B directed to decline element 620B, computer system 600 declines the call (and optionally ceases to display call user interface 620). In response to detecting the user input and in accordance with a determination that the user input is the first type of air gesture 650C (e.g., single tap air gesture and/or a single tap-and-hold air gesture), computer system 600 activates answer element 620A that has input focus 640, as shown in FIGS. 6H-6I (e.g., as described in further detail below). In some embodiments, in response to detecting the user input and in accordance with the determination that the user input is the first type of air gesture 650C (e.g., single tap air gesture and/or a single tap-and-hold air gesture), computer system 600 does not activate decline element 620B and/or does not decline the call. In some embodiments, in response to detecting the user input and in accordance with the determination that the user input is the first type of air gesture 650C (e.g., single tap air gesture and/or a single tap-and-hold air gesture), computer system 600 displays hang up element 620F at FIG. 6I with input focus 640. In response to detecting the user input and in accordance with a determination that the user input is the second type of air gesture 650C (e.g., double tap air gesture and/or a double tap-and-hold air gesture), computer system 600 moves input focus 640 from answer element 620A to decline element 620B, as shown in FIGS. 6J-6M and described in further detail below. In some embodiments, in response to detecting the user input and in accordance with the determination that the user input is the second type of air gesture 650C (e.g., double tap air gesture and/or a double tap-and-hold air gesture), computer system 600 does not activate answer element 620A and/or does not answer the call. Thus, in some embodiments, when the first type of air gesture (e.g., single tap air gesture and/or a single tap-and-hold air gesture) is detected when an element is displayed with input focus, the computer system activates the element that is displayed with input focus and the computer system performs the operation that corresponds to the element that is displayed with input focus. In some embodiments, when the second type of air gesture (e.g., double tap air gesture and/or a double tap-and-hold air gesture) is detected when an element is displayed with input focus, the computer system moves the input focus to a different element (e.g., without performing the operation corresponding to the element that originally had input focus).

At FIG. 6H, in response to detecting the first type of air gesture 650C (e.g., single tap air gesture and/or a single tap-and-hold air gesture) at FIG. 6G, computer system 600 optionally changes a visual appearance of answer element 620A to indicate that answer element 620A has been activated and performs the operation corresponding to answer element 620A (e.g., answering the call). For example, changing the visual appearance of answer element 620A includes changing a color, a brightness, and/or a size of answer element 620A. At FIG. 6I, in response to detecting the first type of air gesture 650C (e.g., single tap air gesture and/or a single tap-and-hold air gesture), computer system 600 has answered the incoming call. At FIG. 6I, call user interface 620 includes mute element 620E for muting an audio input at computer system 600 and hang up element 620F for hanging up the call. Status information 620D has been updated to show the duration of the call.

At FIGS. 6J-6M, in response to detecting the second type of air gesture 650C (e.g., double tap air gesture and/or a double tap-and-hold air gesture) at FIG. 6G, computer system 600 displays an animation of input focus 640 moving from answer element 620A to decline element 620B, with FIG. 6L showing an enlarged view of answer element 620A, decline element 620B, and input focus 640 as in FIG. 6K. Throughout FIGS. 6J-6M, the size, shape, and/or appearance of input focus 640 changes based on answer element 620A, decline element 620B, and the background of call user interface 620. For example, as input focus 640 transitions from answer element 620A to decline element 620B, the size of input focus 640 changes from a size based on the size of answer element 620A to a size that is based on the size of decline element 620B. For another example, as input focus 640 transitions from answer element 620A to decline element 620B, the shape of input focus 640 changes from a shape based on (e.g., the same as or similar to) the shape of answer element 620A to a shape that is based on (e.g., the same as or similar to) the shape of decline element 620B.

As shown in FIG. 6L, in some embodiments, input focus 640 is an additive layer that is displayed on top of the visual elements of call user interface 620. In some embodiments, input focus 640 includes outer portion 640A and inner portion 640B, which have different visual characteristics. For example, while input focus 640 is on answer element 620A (e.g., at FIG. 6G), a visual characteristic (e.g., a color and/or a brightness) of inner portion 640B is based on a visual characteristic (e.g., a color and/or a brightness) of answer element 620A and a visual characteristic (e.g., a color and/or a brightness) of outer portion 640A is based on a visual characteristic (e.g., a color and/or a brightness) of the background of call user interface 620 (e.g., the area surrounding answer element 620A). In some embodiments, the visual characteristics of outer portion 640A and/or inner portion 640B are based on the visual characteristics of the areas adjacent to the respective portions. In some embodiments, input focus 640 (e.g., a focus element) exhibits a lensing effect that distorts the visual elements over which input focus 640 is displayed. For example, as shown in FIG. 6L, while input focus 640 is partially over parts of both answer element 620A and decline element 620B, portion 640C is based on a color and/or shape of answer element 620A and portion 640D is based on a color and/or shape of decline element 620B.

At FIG. 6M, while displaying call user interface 620 with decline element 620B having input focus 640, computer system 600 detects a user input. In response to detecting the user input and in accordance with a determination that the user input is touch input 652C directed to menu element 620C, computer system 600 displays additional options corresponding to menu element 620C. In response to detecting the user input and in accordance with a determination that the user input is the first type of air gesture 650D (e.g., single tap air gesture and/or a single tap-and-hold air gesture), computer system 600 activates decline element 620B that has input focus 640, which declines the call. In some embodiments, in response to detecting the user input and in accordance with the determination that the user input is the first type of air gesture 650D (e.g., single tap air gesture and/or a single tap-and-hold air gesture), computer system 600 transitions computer system 600 to displaying watch face 610. In some embodiments, in response to detecting the user input and in accordance with the determination that the user input is the first type of air gesture 650D (e.g., single tap air gesture and/or a single tap-and-hold air gesture), computer system 600 does not activate answer element 620A and/or does not answer the call. In response to detecting the user input and in accordance with a determination that the user input is the second type of air gesture 650D (e.g., double tap air gesture and/or a double tap-and-hold air gesture), computer system 600 moves input focus 640 from decline element 620B to answer element 620A (e.g., because there are no other elements in call user interface 620 that can be selected using air gestures), optionally following a reverse animation as that shown in FIGS. 6J-6M. In some embodiments, in response to detecting the user input and in accordance with the determination that the user input is the second type of air gesture 650D (e.g., double tap air gesture and/or a double tap-and-hold air gesture), computer system 600 does not activate answer element 620A and/or does not activate decline element 620B. In some embodiments, if menu element 620C could be selected using air gestures, input focus 640 would instead move from decline element 620B to menu element 620C in response to detecting the user input and in accordance with the determination that the user input is the second type of air gesture 650D (e.g., double tap air gesture and/or a double tap-and-hold air gesture).

FIGS. 6N-6S illustrate user interfaces for a timer application. At FIG. 6N, computer system 600 displays, via display 602, timer user interface 630 of the timer application. Timer user interface 630 includes status indication 630A (e.g., indicating that 1 second remains on the timer as the timer is counting down), end element 630C for ending an active timer, and pause element 630B for pausing an active timer. At FIG. 6N, computer system 600 is operating in the low-power mode (e.g., low-power screen display and/or low-power processor configuration), as illustrated in FIG. 6N by the dimmed view of timer user interface 630 on display 602. At FIG. 6N, wrist 604A of user 604 is in the raised position. For ease of reference, computer system 600 is in the low-power mode during FIGS. 6N and 6P-6Q and is not in the low-power mode during FIGS. 6O and 6R-6S.

At FIG. 6N, while in the low-power mode, computer system 600 detects that the timer has completed (e.g., expired and/or finished counting down to 0 seconds). Because wrist 604A of user 604 is already raised when computer system 600 detects that the timer has completed, in response to detecting that the timer has completed, computer system 600 transitions out of the low-power mode (e.g., into a normal-power mode and/or a high-power mode), as illustrated in FIG. 6O by display 602 not being dimmed, and displays timer user interface 630 without any elements of timer user interface 630 having input focus, as shown in FIG. 6O. For example, timer user interface 630 at FIG. 6O includes end element 630C for canceling a timer and/or exiting timer user interface 630 and repeat element 630D for restarting the timer, neither of which have input focus at FIG. 6O. At FIG. 6O, in response to detecting that the timer has completed, computer system 600 has also updated status indication 630A to indicate (e.g., “DONE”) that the timer has completed and output tactile output 632A to notify user 604 that the timer has completed.

At FIG. 6P, computer system 600 is operating in the low-power mode (e.g., low-power screen display and/or low-power processor configuration), as illustrated in FIG. 6P by the dimmed view of timer user interface 630 on display 602, while wrist 604A is not raised. At FIG. 6P, while in the low-power mode, computer system 600 detects that the timer has completed. Because wrist 604A of user 604 is not raised when computer system 600 detects that the timer has completed, in response to detecting that the timer has completed, computer system 600 does not transition out of the low-power mode (e.g., does not transition into a normal-power mode and/or a high-power mode), as illustrated in FIG. 6Q by display 602 remaining dimmed, and computer system displays timer user interface 630 without any elements of timer user interface 630 having input focus. At FIG. 6Q, in response to detecting that the timer has completed, computer system 600 has updated status indication 630A to indicate (e.g., “DONE”) that the timer has completed and outputs tactile output 632B to notify user 604 that the timer has completed. In some embodiments, computer system 600 does not perform any operations in response to detecting the first type of air gesture and/or the second type of air gesture while in the low-power mode, such as at FIG. 6Q. In some embodiments, computer system 600 does not monitor for air gestures while in the low-power mode, such as at FIG. 6Q, and thus when a user motion is performed that would otherwise meet the criteria for the gesture, it does not cause the computer system to respond in the way that the computer system would typically respond to the gesture because the computer system does not detect the gesture (e.g., because the computer system was not monitoring for the gesture).

At FIG. 6Q, while in the low-power mode and displaying timer user interface 630, computer system 600 detects wrist raise 650T of wrist 604A, as shown in FIG. 6R. At FIG. 6R, in response to detecting wrist raise 650T of wrist 604A, computer system 600 transitions out of the low-power mode (e.g., into a normal-power mode and/or a high-power mode), continues to display timer user interface 630, and initiates a process to display an input focus. In some embodiments, as described with respect to FIG. 6F, the process to display the input focus optionally includes emphasizing elements of the user interface that can be selected via air gestures without emphasizing elements that cannot be selected via air gestures.

At FIG. 6R, as part of the process to display the input focus, computer system 600 displays input focus 640 on the primary element (e.g., repeat element 630D) of timer user interface 630. At FIG. 6R, while displaying timer user interface 630 and repeat element 630D having input focus 640, computer system 600 detects a user input. In response to detecting the user input and in accordance with a determination that the user input is the first type of air gesture 650F (e.g., single tap air gesture and/or a single tap-and-hold air gesture), computer system 600 activates repeat element 630D that has input focus 640, causing the timer to repeat from the original 10 minutes, as shown in FIG. 6S (e.g., without activating end element 630C). In response to detecting the user input and in accordance with a determination that the user input is the second type of air gesture 650F (e.g., double tap air gesture and/or a double tap-and-hold air gesture), computer system 600 moves input focus 640 from repeat element 630D to end element 630C (e.g., without activating any element of timer user interface 630).

FIGS. 6T-6Y illustrate user interfaces for a media application. At FIG. 6T, computer system 600 displays, via display 602, media user interface 660 of the media application. Media user interface 660 includes status indication 660A (e.g., indicating a title and artist of the current media), play-pause element 660B for starting and pausing media playback, previous element 660C for skipping to a previous media, and next element 660D for skipping to a next media. In some embodiments, the current media is audio media and/or video media. At FIG. 6T, computer system 600 is operating in the low-power mode (e.g., low-power screen display and/or low-power processor configuration), as illustrated in FIG. 6T by the dimmed view of media user interface 660 on display 602 while media is playing. At FIG. 6T, wrist 604A of user 604 is in the raised position. For ease of reference, computer system 600 is in the low-power mode during FIG. 6T and is not in the low-power mode during FIGS. 6U-6Y.

At FIG. 6T, computer system 600 detects (e.g., via a touch-sensitive surface) a touch user input 650G (e.g., directed to play-pause element 660B). In response to detecting the touch user input 650G (e.g., directed to play-pause element 660B) and in accordance with a determination that the computer system is in the low-power mode, computer system 600 transitions out of the low power mode without pausing the media playback (e.g., without performing the operation corresponding to play-pause element 660B), as shown in FIG. 6U. Thus, in some embodiments, computer system 600 transitions out of the low-power mode when a touch input is detected (e.g., without performing an operation that corresponds to an element that the touch input was directed to).

At FIG. 6U, while displaying media user interface 660 without any element having input focus, computer system 600 detects a user input. In response to detecting the user input and in accordance with a determination that the user input is touch input 6501 directed to previous element 660C, computer system 600 ceases playing the current media and plays a previous media (e.g., a previous media in an active media playlist). In response to detecting the user input and in accordance with a determination that the user input is touch input 650J directed to play-pause element 660B, computer system 600 pauses playback of the current media. In response to detecting the user input and in accordance with a determination that the user input is touch input 650K directed to next element 660D, computer system 600 ceases playing the current media and plays a next media (e.g., a next media in an active media playlist). In response to detecting the user input and in accordance with a determination that the user input is the first type of air gesture 650H (e.g., single tap air gesture and/or a single tap-and-hold air gesture), computer system 600 maintains display of media user interface 660 without performing any media operation (e.g., without pausing or changing media being played). In response to detecting the user input and in accordance with a determination that the user input is the second type of air gesture 650H (e.g., double tap air gesture and/or a double tap-and-hold air gesture), computer system 600 initiates a process to display an input focus. In some embodiments, as described with respect to FIG. 6F, the process to display the input focus optionally includes emphasizing elements of the user interface that can be selected via air gestures without emphasizing elements that cannot be selected via air gestures.

At FIG. 6V, as part of the process to display the input focus, computer system 600 displays input focus 640 on the primary element (e.g., play-pause element 660B) of media user interface 660. At FIG. 6V, while displaying media user interface 660 and play-pause element 660B having input focus 640, computer system 600 detects a user input. In response to detecting the user input and in accordance with a determination that the user input is the first type of air gesture 650L (e.g., single tap air gesture and/or a single tap-and-hold air gesture), computer system 600 activates play-pause element 660B that has input focus 640, causing the media player to pause playback of the media, as shown in FIG. 6W (e.g., without activating previous element 660C and/or without activating next element 660D). In response to detecting the user input and in accordance with a determination that the user input is the second type of air gesture 650L (e.g., double tap air gesture and/or a double tap-and-hold air gesture), computer system 600 moves input focus 640 from play-pause element 660B to previous element 660C, similar to the user interface shown in FIG. 6X (e.g., but with playback continuing). In some embodiments, in response to detecting the user input and in accordance with the determination that the user input is the second type of air gesture 650L (e.g., double tap air gesture and/or a double tap-and-hold air gesture), computer system 600 does not activate any element of media user interface 660.

At FIG. 6W, while displaying media user interface 660 and play-pause element 660B having input focus 640, computer system 600 detects a user input. In response to detecting the user input and in accordance with a determination that the user input is the first type of air gesture 650M (e.g., single tap air gesture and/or a single tap-and-hold air gesture), computer system 600 activates play-pause element 660B that has input focus 640, causing the media player to play the media, as shown in FIG. 6V (e.g., without activating previous element 660C and/or without activating next element 660D). In response to detecting the user input and in accordance with a determination that the user input is the second type of air gesture 650M (e.g., double tap air gesture and/or a double tap-and-hold air gesture), computer system 600 moves input focus 640 from play-pause element 660B to previous element 660C, as shown in FIG. 6X (e.g., without activating any element of media user interface 660).

At FIG. 6X, while displaying media user interface 660 and previous element 660C having input focus 640, computer system 600 detects a user input. In response to detecting the user input and in accordance with a determination that the user input is the first type of air gesture 650N (e.g., single tap air gesture and/or a single tap-and-hold air gesture), computer system 600 activates previous element 660C that has input focus 640, causing the media player to play a previous media (e.g., without activating play-pause element 660B and without activating next element 660D). In response to detecting the user input and in accordance with a determination that the user input is the second type of air gesture 650N (e.g., double tap air gesture and/or a double tap-and-hold air gesture), computer system 600 moves input focus 640 from previous element 660C to next element 660D, as shown in FIG. 6Y (e.g., without activating any element of media user interface 660).

At FIG. 6Y, while displaying media user interface 660 and next element 660D having input focus 640, computer system 600 detects a user input. In response to detecting the user input and in accordance with a determination that the user input is the first type of air gesture 650O (e.g., single tap air gesture and/or a single tap-and-hold air gesture), computer system 600 activates next element 660D that has input focus 640, causing the media player to play a next media (e.g., without activating play-pause element 660B and without activating previous element 660C). In response to detecting the user input and in accordance with a determination that the user input is the second type of air gesture 650O (e.g., double tap air gesture and/or a double tap-and-hold air gesture), computer system 600 moves input focus 640 from next element 660D to play-pause element 660B, as shown in FIG. 6W (e.g., without activating any element of media user interface 660).

FIGS. 6Z-6AC illustrate user interfaces for a messaging application. At FIG. 6Z, computer system 600 displays, via display 602, messaging user interface 670 of a messaging application in response to computer system 600 receiving the message. As shown in FIG. 6Z, a portion of received message 670A is displayed on messaging user interface 670. Because the displayed portion of messaging user interface 670 does not include any elements that can be selected with an air gesture, computer system 600 does not display any input focus. At FIG. 6Z, while displaying the portion of received message 670A and without any displayed element having input focus, computer system 600 detects a user input. In response to detecting the user input and in accordance with a determination that the user input is the first type of air gesture 650P (e.g., single tap air gesture and/or a single tap-and-hold air gesture), computer system 600 maintains display of messaging user interface 670 (e.g., without performing any operation and/or without scrolling messaging user interface 670). In response to detecting the user input and in accordance with a determination that the user input is the second type of air gesture 650P (e.g., double tap air gesture and/or a double tap-and-hold air gesture), computer system 600 scrolls messaging user interface 670, as shown in FIG. 6AA. Thus, in some embodiments, when a scrollable user interface does not include any displayed elements that can be selected using air gestures (e.g., no elements are displayed that can have input focus), computer system 600 scrolls the user interface in response to detecting the second type of gesture.

At FIG. 6AA, computer system 600 displays the bottom portion of received message 670A. At FIG. 6AA, while displaying the bottom portion of received message 670A and without any displayed element having input focus, computer system 600 detects user input 650Q. In response to detecting user input 650Q and in accordance with a determination that user input 650Q is the first type of air gesture (e.g., single tap air gesture and/or a single tap-and-hold air gesture), computer system 600 maintains display of messaging user interface 670 (e.g., without performing any operation and/or without scrolling messaging user interface 670). In response to detecting user input 650Q and in accordance with a determination that the user input is the second type of air gesture (e.g., double tap air gesture and/or a double tap-and-hold air gesture), computer system 600 scrolls messaging user interface 670 to display reply element 670B and (optionally) dismiss element 670C, as shown in FIG. 6AB. At FIG. 6AB, reply element 670B has input focus 640 because reply element is displayed and is the primary element (e.g., a default element, a largest element, and/or a most prominent element) of messaging user interface 670. Thus, in some embodiments, when a scrollable user interface does not include any displayed elements that can be selected using air gestures (e.g., that can have the input focus), computer system 600 scrolls the user interface (e.g., in response to detecting the second type of air gesture) to reveal one or more elements and displays the primary element with input focus.

At FIG. 6AB, while displaying reply element 670B with input focus 640, computer system 600 detects user input 650R. In response to detecting user input 650R and in accordance with a determination that user input 650R is the first type of air gesture (e.g., single tap air gesture and/or a single tap-and-hold air gesture), computer system 600 activates reply element 670B and initiates a process to reply to the received message (e.g., by displaying a reply text entry field and/or by activating a microphone to receive user speech). In response to detecting user input 650R and in accordance with a determination that user input 650R is the second type of air gesture (e.g., double tap air gesture and/or a double tap-and-hold air gesture), computer system 600 moves input focus 640 from reply element 670B to dismiss element 670C and optionally scrolls messaging user interface 670 to display all of dismiss element 670C with input focus 640.

At FIG. 6AC, computer system 600 displays, via display 602, messaging user interface 670 of the messaging application in response to computer system 600 receiving a second message. As shown in FIG. 6AC, received second message 670D is displayed on messaging user interface 670. Because messaging user interface 670 also includes reply element 670B, computer system 600 displays input focus 640 for reply element 670B. Thus, in some embodiments, when a user interface is displayed that includes a primary element (e.g., 670B), computer system 600 displays the primary element with input focus.

At FIG. 6AC, while displaying reply element 670B with input focus 640, computer system 600 detects user input 650S. In response to detecting user input 650S and in accordance with a determination that user input 650S is the first type of air gesture (e.g., single tap air gesture and/or a single tap-and-hold air gesture), computer system 600 activates reply element 670B and initiates a process to reply to the received second message (e.g., by displaying a reply text entry field and/or by activating a microphone to receive user speech). In response to detecting user input 650S and in accordance with a determination that user input 650S is the second type of air gesture, computer system 600 moves input focus 640 from reply element 670B to dismiss element 670C and optionally scrolls messaging user interface 670 to display all of dismiss element 670C with input focus 640.

FIG. 7 is a flow diagram illustrating a method for managing air gestures using a computer system, in accordance with some embodiments. Method 700 is performed at a computer system (e.g., 100, 300, 500, and/or 600) (e.g., a smartphone, a wearable device, a tablet computer, a desktop computer, a laptop computer, and/or a head-mounted device) that is in communication (e.g., includes, is in wired communication, and/or is in wireless communication) with a display generation component (e.g., 602) (e.g., a display controller, a touch-sensitive display system, a display screen, a monitor, a projector, a holographic display, and/or a head-mounted display system). In some embodiments, the wearable device is a smartwatch. In some embodiments, the head-mounted device is a head-mounted augmented reality and/or an extended reality device. Some operations in method 700 are, optionally, combined, the orders of some operations are, optionally, changed, and some operations are, optionally, omitted.

As described below, method 700 provides an intuitive way for managing air gestures. The method reduces the cognitive burden on a user for operating a device using air gestures, thereby creating a more efficient human-machine interface. For battery-operated computing devices, enabling a user to operate a device and/or navigate a user interface faster and more efficiently conserves power and increases the time between battery charges.

The computer system (e.g., 600) detects (702) an occurrence of an event (e.g., incoming call as in FIG. 6B, wrist raise 650B, completion of a timer as in FIG. 6O, and/or wrist raise 650T) to transition (e.g., wake up and/or shift) the computer system (e.g., 600) from a lower power state (e.g., as in FIGS. 6A, 6D, 6N, and/or 6Q) to a higher power state (e.g., as in FIGS. 6B, 6E, 60, and/or 6R) that is different from the lower power state. In response (704) to detecting the occurrence of the event to transition the computer system from the lower power state to the higher power state and in accordance with a determination that a first set of criteria is satisfied, the computer system (e.g., 600) displays (706), via the display generation component (e.g., 602), a first element (e.g., 620A at FIG. 6F) with a visual indication (e.g., 640) that the first element has input focus (e.g., a selection ring, underlining, changed color, changed brightness, changed size, and/or other visual emphasis that visually differentiates the first element from other elements of the user interface). In response (704) to detecting the occurrence of the event to transition the computer system from the lower power state to the higher power state and in accordance with a determination that the first set of criteria is not satisfied, the computer system (e.g., 600) forgoes (708) display, via the display generation component, of the first element with the visual indication that the first element has input focus (e.g., as in FIG. 6B) (e.g., display the first element without the visual indication that the first element has input focus or do not display the first element).

The computer system (e.g., 600) detects (710) a first air gesture (e.g., 650C) (e.g., a single tap air gesture, a single tap-and-hold air gesture, a double-tap air gesture, and/or a double tap-and-hold air gesture). In response (712) to detecting the first air gesture (e.g., 650C) and in accordance with a determination that the first air gesture is a first type of gesture (e.g., single tap air gesture and/or a single tap-and-hold air gesture) detected while displaying the visual indication that the first element has input focus (e.g., as in FIG. 6G), the computer system (e.g., 600) performs (714) an operation (e.g., as shown in FIG. 6H) corresponding to the first element (and, optionally, without performing an operation corresponding to a second element and without displaying a visual indication that a second element (different from the first element) has input focus). Displaying a visual indication that the first element has input focus provides the user with visual feedback that first set of criteria is satisfied and that the user can perform an operation corresponding to the first element by performing the first air gesture, thereby providing improved visual feedback.

In some embodiments, in response to detecting the occurrence of the event to transition the computer system (e.g., 600) from the lower power state to the higher power state and in accordance with the determination that the first set of criteria is not satisfied, the computer system (e.g., 600) displays, via the display generation component, the first element (e.g., 620A) without displaying the visual indication that the first element has input focus (e.g., as in FIG. 6B). Displaying the first element when the event occurs without displaying the visual indication that the first element has input focus provides the user with visual feedback that the first set of criteria is not satisfied and that the first element does not have input focus (and therefore is limited in how it can be activated), thereby providing improved visual feedback.

In some embodiments, in response (712) to detecting the first air gesture (e.g., 650C) and in accordance with a determination that the first air gesture is a second type of gesture (e.g., double tap air gesture and/or a double tap-and-hold air gesture), different from the first type of gesture, detected while displaying the visual indication that the first element has input focus, the computer system (e.g., 600) displays (716), via the display generation component (e.g., 602), a visual indication that a second element (e.g., 620B at FIG. 6M), different from the first element, has input focus (e.g., 640) without performing the operation corresponding to the first element (and, optionally, without performing the operation corresponding to the second element) and without displaying, via the display generation component, the visual indication that the first element has input focus. In some embodiments, in response to detecting the first air gesture and in accordance with the determination that the first air gesture is the second type of gesture (e.g., double tap air gesture and/or a double tap-and-hold air gesture) detected while displaying the visual indication that the first element has input focus, the computer system ceases to display, via the display generation component, the visual indication that the first element has input focus. Displaying a visual indication that the second element has input focus when the computer system detects the second type of gesture provides the user with visual feedback that the second type of gesture was detected and that the second element now has input focus (and can therefore be activated with the first type of gesture), thereby providing improved visual feedback. Moving the visual indication of input focus when the second type of gesture is detected enables the computer system to select a user-desired element for activation, thereby improving the man-machine interface.

In some embodiments, in response to detecting the first air gesture (e.g., 650A) and in accordance with a determination that the first air gesture is the first type of gesture (e.g., single tap air gesture and/or a single tap-and-hold air gesture) detected while not displaying the visual indication (e.g., 640) that an element has input focus (e.g., as in FIG. 6B), the computer system (e.g., 600) forgoes performing the operation corresponding to the first element (and, optionally, forgoing performing the operation corresponding to the second element). In some embodiments, when the first type of gesture (e.g., single tap air gesture and/or a single tap-and-hold air gesture) is detected while the user interface does not display input focus for any element (does not display any indication that any element has input display), the operations corresponding to the first element and the second element are not performed. Not performing the operation corresponding to the first element when the first type of gesture is detected while an indication of input focus is not displayed prevents unintended operations from being performed with the first type of gesture is detected, thereby improving the man-machine interface and making the computer system more secure.

In some embodiments, in response to detecting the first air gesture (e.g., 650A and/or 650E) and in accordance with the determination that the first air gesture is the first type of gesture (e.g., single tap air gesture and/or a single tap-and-hold air gesture) detected while not displaying the visual indication that an element has input focus (e.g., as in FIGS. 6B and/or 60), the computer system (e.g., 600) forgoes display, via the display generation component (e.g., 602), of the visual indication (e.g., 640) that the first element (e.g., 620A and/or 630D) has input focus (e.g., displaying a user interface that includes the first element without displaying the visual indication that the first element has focus). In some embodiments, when the first type of gesture (e.g., single tap air gesture and/or a single tap-and-hold air gesture) is detected while the user interface does not display focus for any element, the computer system does not display the visual indication that the first element (and, optionally, any element) has input focus. Not displaying the visual indication that the first element has input focus when the first type of gesture is detected when there is no input focus provides the user with visual feedback that the first type of gesture does not initiate use of the focus, thereby providing improved visual feedback.

In some embodiments, in response to detecting the first air gesture (e.g., 650A and/or 650E) and in accordance with a determination that the first air gesture is a second type of gesture (e.g., double tap air gesture and/or a double tap-and-hold air gesture), different from the first type of gesture, detected while not displaying a visual indication (e.g., 640) that an element has input focus (e.g., as in FIGS. 6B and/or 60), the computer system (e.g., 600) displays, via the display generation component (e.g., 602), the visual indication (e.g., 640) that the first element (e.g., 620A and/or 630D) has input focus (e.g., as in FIGS. 6F and/or 6R) without performing the operation corresponding to the first element (and, optionally, without displaying the visual indication that the second element has input focus and without performing the operation corresponding to the second element). In some embodiments, when the second type of gesture (e.g., double tap air gesture and/or a double tap-and-hold air gesture) is detected while the user interface does not display input focus for any element (does not display any indication that any element has input display), the computer system displays the visual indication that the first element has input focus without performing the operation corresponding to the first element. Displaying the visual indication that the first element has input focus when the second type of gesture is detected when there is no input focus provides the user with visual feedback that the second type of gesture was detected and that the first element has input focus (and can therefore be activated with the first type of gesture), thereby providing improved visual feedback.

In some embodiments, subsequent detecting the first air gesture (e.g., 650A, 650C, and/or 650H), the computer system (e.g., 600) detects a second air gesture (e.g., 650C and/or 650L) (e.g., a single tap air gesture, a single tap-and-hold air gesture, a double-tap air gesture, and/or a double tap-and-hold air gesture). In response to detecting the second air gesture: in accordance with a determination that the second air gesture is the first type of gesture (e.g., single tap air gesture and/or a single tap-and-hold air gesture) detected while displaying the visual indication that the first element has input focus, the computer system (e.g., 600) performs the operation corresponding to the first element (e.g., activation of the element, as in FIGS. 6H and/or 6W) (and, optionally, without performing an operation corresponding to a second element and without displaying a visual indication that a second element (different from the first element) has input focus) and in accordance with a determination that the second air gesture is a second type of gesture (e.g., double tap air gesture and/or a double tap-and-hold air gesture), different from the first type of gesture, detected while displaying the visual indication that the first element has input focus, the computer system (e.g., 600) displays, via the display generation component (e.g., 602), a visual indication that a second element, different from the first element, has input focus without performing the operation corresponding to the first element (and, optionally, without performing the operation corresponding to the second element) (e.g., as in FIGS. 6J and/or 6X with media continuing to play) and without displaying, via the display generation component, the visual indication that the first element has input focus. In some embodiments, in accordance with the determination that the second air gesture is the second type of gesture (e.g., double tap air gesture and/or a double tap-and-hold air gesture) detected while displaying the visual indication that the first element has input focus, the computer system ceases to display, via the display generation component, the visual indication that the first element has input focus. Performing an operation corresponding to the first element that is in focus or moving the focus to a second element based on the type of input received enables the computer system to be controlled by air gestures of the user and to provide the user with visual feedback about the current focus of the user interface, thereby providing improved visual feedback.

In some embodiments, in response to detecting the first air gesture (e.g., 650D and/or 650N) and in accordance with a determination that the first air gesture is the first type of gesture (e.g., single tap air gesture and/or a single tap-and-hold air gesture) detected while displaying a visual indication (e.g., 640) that the second element (e.g., 620B and/or 660C) has input focus, the computer system (e.g., 600) performs an operation corresponding to the second element that is different from the operation corresponding to the first element (and, optionally, without performing the operation corresponding to the first element). Performing the operation corresponding to the second element when the first type of gesture is detected while displaying the visual indication that the second element has input focus enables the computer system to initiate the operation based on detected air gestures, thereby improving the man-machine interface.

In some embodiments, in response to detecting the first air gesture (e.g., 650D and/or 650N) and in accordance with a determination that the first air gesture is a second type of gesture (e.g., double tap air gesture and/or a double tap-and-hold air gesture), different from the first type of gesture, detected while displaying a visual indication that the second element (e.g., 620B and/or 660C) has input focus, the computer system (e.g., 600) displays, via the display generation component (e.g., 602), a visual indication that a third element (e.g., 660D) (e.g., the first element and/or a different element), different from the second element, has input focus (e.g., as in FIG. 6Y) without performing the operation corresponding to the second element (and, optionally, without performing the operation corresponding to the third element (e.g., the first element and/or a different element)) and without displaying, via the display generation component, the visual indication that the second element has input focus. In some embodiments, in response to detecting the first air gesture and in accordance with a determination that the first air gesture is a second type of gesture (e.g., double tap air gesture and/or a double tap-and-hold air gesture) detected while displaying a visual indication that the second element has input focus, the computer system ceases to display, via the display generation component, the visual indication that the second element has input focus. Displaying a visual indication that the third element has input focus when the computer system detects the second type of gesture when the second element has input focus provides the user with visual feedback that the second type of gesture was detected and that the third element now has input focus (and can therefore be activated with the first type of gesture), thereby providing improved visual feedback. Moving the visual indication of input focus when the second type of gesture is detected enables the computer system to select a user-desired element for activation, thereby improving the man-machine interface.

In some embodiments, displaying, via the display generation component (e.g., 602), a user interface that includes one or more elements, including: while displaying a visual indication (e.g., 6040) that an element (e.g., 620A in FIG. 6F) (e.g., the first element, the second element, and/or the third element) has input focus (e.g., as part of the user interface and/or separate from the user interface), the computer system (e.g., 600) displays at least some (e.g., one, two, and/or all) (e.g., 620C in FIG. 6F) of the one or more elements with a first degree of visual emphasis (e.g., dimmed, reduced color saturation, and/or reduced size) (e.g., as in FIG. 6F). While displaying the element without a visual indication that the element (e.g., the first element, the second element, and/or the third element) has input focus (e.g., as part of the user interface and/or separate from the user interface), the computer system (e.g., 600) displays the at least some (e.g., one, two, and/or all) (e.g., 620C in FIG. 6E) of the one or more elements with a second degree of visual emphasis that is higher than the first degree of visual emphasis (e.g., are not dimmed, reduced color saturation, and/or reduced size) (e.g., no elements are deemphasized). In some embodiments, while an input focus is displayed on the user interface, portions of the user interface are deemphasized (e.g., dimmed, reduced color saturation, and/or reduced in size). In some embodiments, elements that can have the input focus (e.g., based on user input to move the input focus) are not deemphasized. In some embodiments, all displayed elements of the user interface, other than elements that can have the input focus (e.g., based on user input to move the input focus), are deemphasized when an input focus is displayed (e.g., when the input focus is initially displayed). In some embodiments, the computer system ceases to visual deemphasize the one or more elements after one or more conditions are met (e.g., a threshold duration of time passes, a user input is received, the first type of gesture is detected, the second type of gesture is detected). Visually deemphasizing one or more elements of the user interface when a visual indication of input focus is displayed provides the user with visual feedback that the computer system is operating in a mode by which an input focus is displayed and can be moved to other elements, thereby providing improved visual feedback.

In some embodiments, in response to detecting the first air gesture (e.g., 650P at FIG. 6Z and/or 650Q at FIG. 6AA) and in accordance with a determination that the first air gesture is a second type of gesture (e.g., double tap air gesture and/or a double tap-and-hold air gesture), different from the first type of gesture, detected while no elements that can be selected with an air gesture are displayed (e.g., no elements are displayed that can receive input focus), the computer system (e.g., 600) navigates through (e.g., scrolling, paginating, moving through a virtual stack of elements) a user interface (e.g., a currently displayed user interface) (e.g., as in FIGS. 6AA and/or 6AB) (e.g., with or without removing, adding, and/or moving an indication of input focus). In some embodiments, when the second type of gesture is detected while displaying a user interface that does not include any currently displayed elements that can be selected with an air gesture, the computer system navigates through the user interface in response to the detected second type of gesture. Navigating through the user interface when the second type of gesture is detected and there are no displayed elements that can be selected with an air gesture provides the user with visual feedback that there are no elements that can be selected with an air gesture displayed and enables the computer system to navigate to other portions of the user interface using the same input, thereby providing improved visual feedback and improving the man-machine interface.

In some embodiments, in response to detecting the first air gesture: in accordance with a determination that the first air gesture is a second type of gesture (e.g., double tap air gesture and/or a double tap-and-hold air gesture), different from the first type of gesture, detected while one or more elements that can be selected with an air gesture are displayed (e.g., one or more elements are displayed that can receive input focus) (e.g., as in FIG. 6U), the computer system (e.g., 600) displays, via the display generation component (e.g., 602), a visual indication (e.g., 640) that a respective element of the one or more elements that can be selected with an air gesture has input focus (e.g., a selection ring, underlining, changed color, changed brightness, changed size, and/or other visual emphasis that visually differentiates the respective element from other elements (e.g., other elements that can be selected with an air gesture) of the user interface) (e.g., as in FIG. 6V) without navigating through a user interface that includes the one or more elements that can be selected with an air gesture; and in accordance with a determination that the first air gesture is the second type of gesture (e.g., double tap air gesture and/or a double tap-and-hold air gesture) detected while no elements that can be selected with an air gesture are displayed (e.g., no elements are displayed that can receive input focus or no element are displayed that can receive input focus via an air gesture), the computer system (e.g., 600) navigates through a user interface (e.g., as in FIG. 6AA) (e.g., with or without displaying, via the display generation component, a visual indication that a respective element (e.g., displayed as a result of the navigation and or displayed subsequent to detecting the first air gesture) has input focus). In some embodiments, in accordance with a determination that the first air gesture is the second type of gesture (e.g., double tap air gesture and/or a double tap-and-hold air gesture) detected while a visual indication of input focus is displayed for the only displayed element that can be selected with an air gesture, the computer system navigates through the user interface in response to the detected first air gesture. In some embodiments, in response to detecting the second type of gesture, the computer system prioritizes displaying a visual indication that an element that can be selected with an air gesture has input focus and/or moving an input focus to another element that can be selected with an air gesture over navigating through the user interface. In some embodiments, where the computer system can both change the input focus and navigate through the user interface, the computer system prioritizes changing the input focus over navigating through the user interface. Prioritizing placing focus on an element and/or moving the focus to another element over navigating through the user interface enables the computer system to allow user selection of elements that can be selected with an air gesture, thereby providing feedback about which elements can be selected with an air gesture and improving the man-machine interface.

In some embodiments, the user interface is paginated and navigating through the user interface comprises: in accordance with a determination that a currently displayed (and, optionally focused and/or emphasized) first view (e.g., a first page and/or a first platter) of the user interface is scrollable and that the currently displayed first view of the user interface can be scrolled in a first direction (e.g., because the bottom and/or end of the first view is off the display and/or there is more content of the first view to display when scrolling in a first direction), scrolling the first view of the user interface in the first direction (e.g., to display additional content of the first view of the user interface) without paginating to a second view (e.g., a second page and/or a second platter) of the user interface; and in accordance with a determination that the currently displayed first view (e.g., a first page and/or a first platter) of the user interface is scrollable and that the currently displayed first view of the user interface cannot be scrolled in the first direction (e.g., because the bottom and/or end of the first view is on the display and/or there is no more content of the first view to display when scrolling in a first direction), paginating to the second view of the user interface (e.g., without scrolling the first view of the user interface to reveal additional content of the first view). In some embodiments, in response to detecting the second type of gesture, the computer system prioritizes scrolling content of a current view over paginating from a current view to another view. In some embodiments, where the computer system can both scroll the current view of the user interface and paginate to another view of the user interface, the computer system prioritizes scrolling the current view over paginating to another view. In some embodiments, when the computer system has scrolled to the end of the first view and detects the second type of gesture, the computer system paginates to another (e.g., the second) view of the user interface. Prioritizing scrolling content of a view of a user interface over paginating through a user interface enables the computer system to display additional information of the scrollable first view, rather than paginating to a second view, thereby providing the user with the additional information and improving the man-machine interface.

In some embodiments, subsequent to (e.g., in response to) performing the operation corresponding to the first element, providing feedback (e.g., as in FIGS. 6I and/or 6W) (e.g., visual feedback, audio feedback, and/or tactile feedback) that indicates that (e.g., at a time based on and/or different feedback based on) (e.g., based on start of, completion of, and/or result of) the operation corresponding to the first element was performed. In some embodiments, subsequent to (e.g., in response to) performing the operation corresponding to the second element, the computer system provides feedback (e.g., visual feedback, audio feedback, and/or tactile feedback) based on (e.g., at a time based on and/or different feedback based on) performance (e.g., based on start of, completion of, and/or result of) the operation corresponding to the second element. In some embodiments, the computer system provides different feedback for different operations. Providing feedback when an operation is performed provides the user with feedback that the operation has been performed, thereby providing improved user feedback.

In some embodiments, the occurrence of the event is based on detecting user input (e.g., 650B and/or 650T) (e.g., detecting a wrist raise operation, a button press, a touch input on a touch-sensitive surface, a tap air gesture, and/or a double-tap air gesture) (and, optionally, not based on a system event). The occurrence of the event being based on user input enables the computer system to display the indication that the first element has input focus based on the user input, thereby providing visual feedback that the user input was detected and improving the man-machine interface.

In some embodiments, the occurrence of the event is based on the occurrence of a system event (e.g., as in FIGS. 6B and/or 60) (e.g., receiving an incoming communication (e.g., an instant message, an email message, a phone call, and/or a video call), detecting the completion of a timer, and/or detecting a software-initiated event) (and, optionally, not based on a user input). In some embodiments, the occurrent of the event is determined and/or detected when the computer system detects a particular system event (e.g., incoming communication, end of a timer, alarm, or other software event). The occurrence of the event being based on a system event enables the computer system to display the indication that the first element has input focus based on the system event, thereby providing visual feedback that the system event was detected and improving the man-machine interface.

In some embodiments, the occurrence of the event is detected during an incoming request (e.g., as in FIG. 6E) to join (e.g., accept and/or participate in) a real-time communication session (e.g., an audio call and/or a video call) (e.g., the computer system has received information including a request that the computer system participate in a call and the computer system has not yet accepted or declined the request) (and/or the occurrence of the event is detected based on receiving an incoming request to join the real-time communication session). In some embodiments, the first element is a user interface object (e.g., 620A) configured to initiate a process to join the real-time communication session. In some embodiments, performing the operation corresponding to the first element includes initiating the process to join (e.g., joining and/or prompting for a display name or camera selection for use in the session) the real-time communication session (e.g., as in FIG. 6I). In some embodiments, in response to detecting the occurrence of the event to transition the computer system from the lower power state to the higher power state and in accordance with the determination that the first set of criteria is satisfied, the computer system displays, via the display generation component, a button (e.g., the first element) to join the real-time communication session that is in focus (a visual indication that the button to join the real-time communication session has input focus). In some embodiments, the visual indication that the button has input focus includes displaying a selection ring, underlining, changed color, changed brightness, changed size, and/or other visual emphasis that visually differentiates the button from other elements of the user interface. In some embodiments, after initiating the process to join the real-time communication session, the computer system joins the real-time communication session. Displaying the indication that the first element has input focus enables the computer system to receive the first type of input to quickly join the real-time communication session, thereby reducing the number of inputs required to join the real-time communication session and improving the man-machine interface.

In some embodiments, the occurrence of the event is based on completion of a timer (e.g., expiration of a count-down timer and/or a count-up timer) (e.g., as in FIGS. 6O and 6R). In some embodiments, the first element is a user interface object configured to initiate a process to restart the timer (e.g., 630D). In some embodiments, performing the operation corresponding to the first element includes initiating the process to restart the timer (e.g., as in FIG. 6S). In some embodiments, after initiating the process to restart the timer the computer system restarts the timer (e.g., as part of the process to restart the timer). In some embodiments, performing the operation corresponding to the first element includes (e.g., in addition to and/or instead of restarting) disposing of the timer (e.g., getting rid of the timer instance that indicates the current amount of time for the timer that completed). In some embodiments, in response to detecting the occurrence of the event to transition the computer system from the lower power state to the higher power state and in accordance with the determination that the first set of criteria is satisfied, the computer system displays, via the display generation component, a button (e.g., the first element) to restart the timer that is in focus (a visual indication that the button to restart the timer has input focus). In some embodiments, the visual indication that the button has input focus includes displaying a selection ring, underlining, changed color, changed brightness, changed size, and/or other visual emphasis that visually differentiates the button from other elements of the user interface. In some embodiments, the computer system detects activation of the button to restart the timer (e.g., an air gesture to activate the button that has input focus) and, in response, restarts the timer. Displaying the indication that the first element has input focus enables the computer system to receive the first type of input to quickly restart the timer, thereby reducing the number of inputs required to restart the timer and improving the man-machine interface.

In some embodiments, the occurrence of the event is detected during playback of media (e.g., as in FIG. 6T) (e.g., during playback of an audio file and/or a video file) (and/or the occurrence of the event is based on detecting a user input (e.g., a wrist raise gesture and/or a touch input) while media is playing, and/or the occurrence of the event is based on a media playback user interface being active and/or displayed). In some embodiments, the first element is a user interface object configured to initiate a process to change a playback state (e.g., play and/or pause) of the media (e.g., 660B). In some embodiments, performing the operation corresponding to the first element includes initiating the process to change the playback state of the media (e.g., as in FIG. 6W). In some embodiments, after initiating the process to change the playback state of the media, the computer system changes the playback state of the media (e.g., as part of the process to change the playback state of the media). In some embodiments, in response to detecting the occurrence of the event to transition the computer system from the lower power state to the higher power state and in accordance with the determination that the first set of criteria is satisfied, the computer system displays, via the display generation component, a button (e.g., the first element) to change a playback state (e.g., skip to a next media, skip to a previous media, fast forward through the media, rewind through the media, start playback of the media, and/or pause playback of the media) in focus (a visual indication that the button to change the playback state has input focus). In some embodiments, the visual indication that the button has input focus includes displaying a selection ring, underlining, changed color, changed brightness, changed size, and/or other visual emphasis that visually differentiates the button from other elements of the user interface. In some embodiments, the computer system detects activation of the button to change the playback state of the media (e.g., an air gesture to activate the button that has input focus) and, in response, changes the playback state of the media. Displaying the indication that the first element has input focus enables the computer system to receive the first type of input to quickly change the playback state of the media, thereby reducing the number of inputs required to change the media playback state and improving the man-machine interface.

In some embodiments, in response to detecting the occurrence of the event to transition the computer system from the lower power state to the higher power state and in accordance with a determination that a first set of criteria is satisfied, prior to displaying the first element (e.g., 620A) with the visual indication (e.g., as in FIG. 6F) that the first element has input focus, the computer system (e.g., 600) displays, via the display generation component (e.g., 602), the first element (e.g., 620A) without displaying the visual indication that the first element has input focus (e.g., as in FIG. 6E). In some embodiments, the computer system first displays the user interface that includes the first element without the visual indication that the first element has input focus and, subsequently, automatically (e.g., after a threshold period of time) displays the visual indication that the first element has input focus concurrently with the first element. In some embodiments, in response to detecting the first air gesture and in accordance with the determination that the first air gesture is the second type of gesture (e.g., double tap air gesture and/or a double tap-and-hold air gesture), different from the first type of gesture, detected while not displaying a visual indication that an element has input focus, the computer system displays the first element without displaying the visual indication that the first element has input focus and then, subsequently, displays the visual indication that the first element has input focus concurrently with the first element. Displaying the user interface without the visual indication of input focus and subsequently displaying the visual indication of input focus draws the user's attention to the visual indication and provides visual feedback that the element has input focus, thereby providing improved visual feedback and improving the man-machine interface.

In some embodiments, displaying a visual indication (e.g., 640) that a respective element (e.g., the first element, the second element, and/or the third element) has input focus includes displaying, via the display generation component (e.g., 602), an additive visual layer on top of (e.g., directly on top of or indirectly on top of (e.g., two or more layers above)) a visual layer that includes the respective element (e.g., as shown in FIG. 6L). In some embodiments, the visual indication is an additive visual layer that is displayed on top of the visual layer that includes the respective element. Displaying the visual indication as an additive visual layer on top of the visual layer that includes the element enables the computer system to identify the element that has input focus, thereby providing improved visual feedback.

In some embodiments, the additive visual layer (e.g., the visual indication) includes a lensing effect that at least partially distorts underlying user interface elements as the lensing effect moves (e.g., as it moves in a user interface and/or as it moves on the display) (e.g., as shown in FIGS. 6J-6L). Showing a lensing effect that partially distorts the first element (and other underlying elements as the visual indication moves) provides the user with visual feedback about the location of the visual indication and which element has input focus, thereby providing improved visual feedback.

In some embodiments, the additive visual layer (e.g., the visual indication) includes one or more colors (e.g., as shown in FIG. 6L) based on (e.g., same as or uses) one or more colors of the respective element (e.g., the first element, the second element, and/or the third element). In some embodiments, the additive visual layer includes colors that are based on colors of the button being identified as having input focus. Displaying colors of the additive visual layer based on one or more colors of the element having input focus provides the user with visual feedback about the relationship between the visual indication and the element having input focus, thereby providing improved visual feedback.

In some embodiments, the additive visual layer (e.g., the visual indication) includes a visual element (e.g., a ring and/or an element with the same shape as the respective element) with an outer layer (e.g., 640A) and an inner layer (e.g., 640B) and wherein a color of the outer layer is based on (e.g., same as or uses) a color of an edge of the respective element (e.g., as shown in FIG. 6L). Displaying colors of the additive visual layer based on one or more colors of the element having input focus provides the user with visual feedback about the relationship between the visual indication and the element having input focus, thereby providing improved visual feedback.

In some embodiments, a color of the inner layer (e.g., 640B) is based on (e.g., same as or uses) a color of a region (e.g., background) outside of (e.g., around and/or under) the respective element (and, optionally, adjacent to the respective element) (e.g., as shown in FIG. 6L). Displaying colors of the additive visual layer based on one or more colors of a region outside of the respective element provides the user with visual feedback about the location of the visual indication, thereby providing improved visual feedback.

In some embodiments, a size of the additive visual layer (e.g., the visual indication) is substantially the same size as (e.g., the same size as or within 5%, 10%, and/or 15% of the size of) the respective element (e.g., as shown in FIGS. 6J-6L). Displaying the additive visual layer as substantially the same size as the element that has input focus provides the user with visual feedback about which element has input focus, thereby providing improved visual feedback. This is particularly helpful for user interface elements that are displayed close to an edge of a display, where there is limited room or no room to expand further toward the edge of the display without cutting off the user interface element, thus providing the user with improved visual feedback about which element has input focus.

In some embodiments, one or more elements (e.g., first element, second element, third element, and/or buttons) of a user interface are configured as being able to be selected with an air gesture by a developer. For example, a developer configures the one or more elements as being selectable with an air gesture. In some embodiments, a second set of one or more elements (e.g., a fourth element and/or a fifth element) are not configured as being selectable with an air gesture (e.g., by the developer). Enabling a developer to configure elements as able or not able to be selected with an air gesture enables the computer system to display some element as being selectable with an air gesture and other elements as not being selectable with an air gesture, thereby providing an improved man-machine interface.

In some embodiments, while displaying a visual indication (e.g., 640 at FIG. 6F) that a respective element (e.g., 620A) has input focus, the computer system (e.g., 600) increases a visual emphasis of (e.g., by dimming a background, by dimming buttons/elements that cannot be selected with an air gesture, and/or by highlighting buttons/elements that can be selected with an air gesture) one or more (e.g., less than all or all) elements that can be selected with an air gesture (e.g., as in FIG. 6F) (e.g., without increasing a visual emphasis of one or more (e.g., less than all or all) elements that cannot be selected with an air gesture). In some embodiments, in response to, concurrently with, and/or before (e.g., immediately before and/or within a threshold duration of) transitioning from not displaying any visual indications of input focus to displaying the visual indication that the respective element has input focus, the computer system increases a visual emphasis of (e.g., by dimming a background, by dimming buttons/elements that cannot be selected with an air gesture, and/or by highlighting buttons/elements that can be selected with an air gesture) one or more (e.g., less than all or all) elements that can be selected with an air gesture (e.g., without increasing a visual emphasis of one or more (e.g., less than all or all) elements that cannot be selected with an air gesture). Increasing a visual emphasis of elements that can be selected with an air gesture provides the user with visual feedback about which elements can be selected with an air gesture, thereby providing improved visual feedback.

Note that details of the processes described above with respect to method 700 (e.g., FIG. 7) are also applicable in an analogous manner to the methods described below. For example, method 900 optionally includes one or more of the characteristics of the various methods described above with reference to method 700. For example, the computer systems in the two methods are the same computer system. For another example, the air gestures and corresponding operation in one method can be applied to the other method(s). For another example, the air gestures and corresponding operation in one method can be applied to the other method(s). For another example, the first type of gesture is optionally the same as the second type of finger gesture (e.g., a single pinch air gesture). For another example, the second type of gesture is optionally the same as the first type of finger gesture (e.g., a double pinch air gesture). For brevity, these details are not repeated below.

FIGS. 8A-8W illustrate exemplary user interfaces for managing air gestures, in accordance with some embodiments. The user interfaces in these figures are used to illustrate the processes described below, including the processes in FIG. 9.

FIG. 8A illustrates wrist-worn computer system 600 (e.g., also referred to as computer system 600) (e.g., a smart watch and/or a smart band) that is being worn on wrist 604A of user 604. Computer system 600 includes display 602, which is optionally a touch-screen display. At FIG. 8A, computer system 600 is displaying a time user interface, such as watch face 610, which is a user interface that includes an indication of the current time and, optionally, one or more (e.g., one, two, or a plurality of) complications. In some embodiments, complications display information received from respective applications of computer system 600.

Although some of FIGS. 8A-8W are illustrated and described with respect to watch face 610, it should be recognized that other time user interfaces can be used instead of, or in addition to, watch face 610. For example, computer system 600 optionally displays a time user interface (e.g., instead of watch face 610) that is a lock screen with an indication of the current time (e.g., when computer system 600 is a smart phone and/or a tablet). For another example, computer system 600 optionally displays a time user interface (e.g., instead of watch face 610) that includes a prompt for authentication (e.g., for entering a password, for entering a passcode, and/or for providing biometric authentication) with an indication of the current time.

At FIG. 8A, while displaying watch face 610, computer system 600 detects an input (e.g., performed by the hand of the user (e.g., the hand with wrist 604A on which computer system 600 is worn)). In some embodiments, in response to detecting the input at FIG. 8A and in accordance with a determination that the input is a hand input gesture of type A (e.g., a single pinch air gesture or a single fist clench air gesture), computer system 600 optionally provides feedback (e.g., audio, tactile, and/or visual feedback) to the user indicating that the gesture of type A is not currently valid and/or does not currently perform a navigation operation (e.g., based on a focus (also described as an input focus) not being displayed and/or based on the state of computer system 600), as shown in FIG. 8B (e.g., where the background user interface is watch face 610). In some embodiments, in response to detecting the input at FIG. 8A and in accordance with a determination that the input is a hand input gesture of type A (e.g., a single pinch air gesture or a single fist clench air gesture), computer system 600 does not perform an operation (e.g., does not perform a navigation operation) and does not provide user feedback. In response to detecting the input at FIG. 8A and in accordance with a determination that the input is a hand input gesture of type B (e.g., a double pinch air gesture or a double fist clench air gesture), computer system 600 updates watch face 610 to display a stack of widgets through which the user can scroll and to place input focus 640 on the top widget (e.g., media widget 810A) of the stack of widgets, as shown in FIG. 8C. In some embodiments, in response to detecting the input at FIG. 8A and in accordance with a determination that the input is a hand input gesture of type C (e.g., a wrist flick air gesture, as described with respect to FIG. 8W), computer system 600 optionally provides feedback (e.g., audio, tactile, and/or visual feedback) to the user indicating that the gesture of type C is not currently valid and/or does not currently perform a navigation operation (e.g., based on the state of computer system 600), as shown in FIG. 8B (e.g., where the background user interface is watch face 610). In some embodiments, in response to detecting the input at FIG. 8A and in accordance with a determination that the input is a hand input gesture of type C (e.g., a wrist flick air gesture), computer system 600 does not perform an operation (e.g., does not perform a cancel operation) and does not provide user feedback.

At FIG. 8B, computer system 600 optionally maintains (e.g., with or without dimming 806) the user interface (e.g., watch face 610) that was being displayed when the respective gesture (e.g., of type A and/or of type C) was detected (e.g., indicated as “background UI” in FIG. 8B) and provides feedback (e.g., tactile feedback, visual feedback 804, and/or the audio feedback) that the respective gesture (e.g., of type A and/or of type C) is not currently valid and/or does not perform a navigation operation (e.g., based on the state of computer system 600). In some embodiments, the tactile feedback, visual feedback 804, and/or the audio feedback corresponds to (e.g., is specific to and/or is based on) the detected respective gesture, thereby providing the user with additional information about the hand input that was detected. In some embodiments, after a timeout period (e.g., 1 second, 3 seconds, and/or 10 seconds), computer system 600 reverts to displaying the user interface (e.g., watch face 610) that was being displayed when the respective gesture (e.g., of type A and/or of type C) was detected (e.g., without dimming the user interface and/or without displaying visual feedback 804).

At FIG. 8C, computer system 600 displays watch face 610 with a stack of widgets 810A-810C. As shown in FIG. 8C, in response to detecting the gesture of type B at FIG. 8A, computer system 600 displays input focus 640 at FIG. 8C, which provides visual feedback indicating a user interface object (e.g., media widget 810A in FIG. 8C) that will be activated in response to computer system 600 detecting a subsequent gesture (e.g., a gesture of type A, a gesture that meets selection criteria, and/or a particular gesture). In some embodiments, computer system 600 visually differentiates between user interface elements having focus and user interface elements not having focus (e.g., by dimming user interface elements not having focus and/or changing a brightness of user interface elements having focus), as shown in FIG. 8C. In some embodiments, computer system 600 visually differentiates between user interface elements that can have focus and/or that can be selected using air gestures and user interface elements that cannot have focus and/or that cannot be selected using air gestures (e.g., by dimming user interface elements that do not have focus and cannot have focus and/or changing a brightness of user interface elements that have focus and user interface elements that can have focus). Accordingly, computer system 600 provides the user with visual feedback about how computer system 600 is being navigated and/or which user interface elements can be selected and/or activated using air gestures (e.g., gestures of type A and/or gestures of type B). In some embodiments, the stack of widgets optionally includes one or more widgets (e.g., media widget 810A) that provides updates about an ongoing activity. For example, media widget 810A provides visual feedback about a media (e.g., a song or podcast) that is currently playing and provides a name of the media and option 810A1 for changing a playback state (e.g., pausing and/or stopping playback) of the media. At FIG. 8C, computer system 600 detects an input. In response to detecting the input at FIG. 8C and accordance with a determination that the input is a stationary touch gesture (e.g., tap input 850B and/or press-and-hold) directed to media widget 810A, computer system 600 displays a user interface (e.g., media user interface 812) corresponding to media widget 810A, as shown in FIG. 8D. In response to detecting the input at FIG. 8C and accordance with a determination that the input is a swipe touch gesture (e.g., swipe up input 850C and/or a drag gesture) directed to media widget 810A and/or stack of widgets 810A-810C, computer system 600 scrolls stack of widgets 810A-810C (e.g., by translating one or more widgets toward the top of the display, by ceasing to display the top widget (e.g., media widget 810A), and/or by displaying at least a portion of a widget (e.g., widget 81OD) that was previously not displayed), such as shown in FIGS. 8E-8F. In response to detecting the input at FIG. 8C and accordance with a determination that the input is a rotation (e.g., 850D, with a magnitude, such as a duration, distance, and/or velocity) of rotatable input mechanism 802 (e.g., a watch crown and/or a rotatable physical component), computer system 600 scrolls (e.g., with an amount of scroll based on a magnitude of the detected rotation 850D) stack of widgets 810A-810C (e.g., by translating one or more widgets toward the top of the display, by ceasing to display the top widget (e.g., media widget 810A), and/or by displaying a at least a portion of a widget (e.g., widget 810D) that was previously not displayed), such as shown in FIGS. 8E-8F. In response to detecting the input at FIG. 8C and in accordance with a determination that the input is a hand input gesture of type A (e.g., a single pinch air gesture or a single fist clench air gesture), computer system 600 activates the user interface object currently having focus. As shown in FIG. 8C, media widget 810A has focus when the input is detected and, accordingly, the gesture of type A causes computer system 600 to activate media widget 810A, thereby causing computer system 600 to display a user interface (e.g., media user interface 812) corresponding to media widget 810A, as shown in FIG. 8D. In response to detecting the input at FIG. 8C and in accordance with a determination that the input is a hand input gesture of type B (e.g., double pinch air gesture 850A or a double fist clench air gesture), computer system 600 navigates watch face 610 by moving input focus 640 from media widget 810A to a next user interface object, such as to weather widget 810B, and/or by scrolling watch face 610, as shown in FIG. 8E. In response to detecting the input at FIG. 8C and in accordance with a determination that the input is a hand input gesture of type C (e.g., a wrist flick gesture), computer system 600 returns to displaying watch face 610 without stack of widgets 810A-810C and without input focus 640 by ceasing display of widgets 810A-810C and ceasing display of input focus 640, as shown in FIG. 8A.

At FIG. 8D, computer system 600 is displaying media user interface 812, which corresponds to media widget 810A. Media user interface 812 includes title 812A of a currently selected (e.g., currently playing) media, previous media option 812B for playing a previous media (e.g., of a playlist or album), next media option 812C for playing a next media (e.g., of a playlist or album), and pause option 812D for changing a playback state (e.g., pausing and/or stopping playback) of the media. In some embodiments (e.g., when computer system 600 navigates to media user interface 812 in response to an air gesture), computer system 600 displays input focus 640. In some embodiments (e.g., when computer system 600 navigates to media user interface 812 in response to a touch input and/or an input other than an air gesture), computer system 600 does not display input focus 640. At FIG. 8D, computer system 600 detects an input. In response to detecting the input at FIG. 8D and in accordance with a determination that the input is a touch gesture (e.g., a stationary touch gesture, tap input 850F, and/or a press-and-hold touch gesture) directed to pause option 812D, computer system 600 changes a playback state of the currently selected media, such as by pausing and/or stopping playback of the media. In response to detecting the input at FIG. 8D when input focus 640 is displayed and in accordance with a determination that the input is a hand input gesture of type A (e.g., single pinch air gesture 850E or a single fist clench air gesture), computer system 600 activates the user interface object currently having focus. As shown in FIG. 8D, pause option 812D has focus when the input is detected and, accordingly, the gesture of type A causes computer system 600 to activate pause option 812D, thereby causing computer system 600 to pause playback of the media. In some embodiments, in response to detecting the input at FIG. 8D when input focus 640 is not displayed and in accordance with a determination that the input is a hand input gesture of type A (e.g., single pinch air gesture 850E or a single fist clench air gesture), computer system 600 optionally provides feedback (e.g., audio feedback, tactile feedback, and/or visual feedback 804) to the user indicating that the gesture of type A is not currently valid and/or does not currently perform a navigation operation (e.g., based on a focus not being displayed and/or based on the state of computer system 600), such as shown in FIG. 8B (e.g., where the background user interface is media user interface 812). In some embodiments, in response to detecting the input at FIG. 8D when input focus 640 is not displayed and in accordance with a determination that the input is a hand input gesture of type A (e.g., single pinch air gesture 850E or a single fist clench air gesture), computer system 600 optionally does not perform a navigation operation, does not perform a cancel operation, and does not provide feedback indicating that the gesture of type A is not currently valid and/or does not currently perform a navigation operation. In response to detecting the input at FIG. 8D when input focus 640 is not displayed and in accordance with a determination that the input is a hand input gesture of type B (e.g., a double pinch air gesture or a double fist clench air gesture), computer system 600 displays input focus 640 on a default and/or prominent user interface object, such as pause option 812D. In response to detecting the input at FIG. 8D when input focus 640 is displayed and in accordance with a determination that the input is a hand input gesture of type B (e.g., a double pinch air gesture or a double fist clench air gesture), computer system 600 navigates media user interface 812 by moving input focus 640 from pause option 812D to a next user interface object, such as to next media option 812C. In response to detecting the input at FIG. 8D and in accordance with a determination that the input is a hand input gesture of type C (e.g., a wrist flick gesture), computer system 600 ceases displaying media user interface 812 and returns to displaying watch face 610 without stack of widgets 810A-810C and without input focus 640, as shown in FIG. 8A, while continuing to play the media.

At FIG. 8E, computer system 600 has scrolled watch face 610 and moved input focus 640 from media widget 810A to weather widget 810B (e.g., in response to detecting the input gesture of type B at FIG. 8C). As shown in FIG. 8E, input focus 640 provides visual feedback indicating that weather widget 810B will be activated in response to computer system 600 detecting a subsequent gesture (e.g., a gesture of type A, a gesture that meets selection criteria, and/or a particular gesture). At FIG. 8E, computer system 600 detects an input. In response to detecting the input at FIG. 8E and in accordance with a determination that the input is a hand input gesture of type A (e.g., single pinch air gesture 850G or a single fist clench air gesture), computer system 600 activates the user interface object currently having focus. As shown in FIG. 8E, weather widget 810B has focus when the input is detected and, accordingly, the gesture of type A causes computer system 600 to activate weather widget 810B, thereby causing computer system 600 to display a user interface (e.g., weather user interface 814) corresponding to weather widget 810B, as shown in FIG. 8G. In response to detecting the input at FIG. 8E and in accordance with a determination that the input is a hand input gesture of type B (e.g., a double pinch air gesture or a double fist clench air gesture), computer system 600 navigates watch face 610 by moving input focus 640 from weather widget 810B to a next user interface object, such as to activity widget 810C, and/or by scrolling watch face 610, as shown in FIG. 8F. In response to detecting the input at FIG. 8E and in accordance with a determination that the input is a hand input gesture of type C (e.g., a wrist flick gesture), computer system 600 returns to displaying watch face 610 without stack of widgets 810A-810D and without input focus 640 by ceasing display of widgets 810A-810D and ceasing display of input focus 640, as shown in FIG. 8A.

At FIG. 8F, computer system 600 has scrolled watch face 610 and moved input focus 640 from weather widget 810B to activity widget 810C (e.g., in response to detecting the input gesture of type B at FIG. 8E). As shown in FIG. 8F, input focus 640 provides visual feedback indicating that activity widget 810C will be activated in response to computer system 600 detecting a subsequent gesture (e.g., a gesture of type A, a gesture that meets selection criteria, and/or a particular gesture). At FIG. 8F, computer system 600 detects an input. In response to detecting the input at FIG. 8F and in accordance with a determination that the input is a hand input gesture of type A (e.g., single pinch air gesture 850H or a single fist clench air gesture), computer system 600 activates the user interface object currently having focus. As shown in FIG. 8F, activity widget 810C has focus when the input is detected and, accordingly, the gesture of type A causes computer system 600 to activate activity widget 810C, thereby causing computer system 600 to display a user interface (e.g., a user interface of an activity application) corresponding to activity widget 810C. In response to detecting the input at FIG. 8F and in accordance with a determination that the input is a hand input gesture of type B (e.g., double pinch air gesture or a double fist clench air gesture), computer system 600 navigates watch face 610 by moving input focus 640 from activity widget 810C to a next user interface object, such as to widget 810D, and/or by scrolling watch face 610. In some embodiments, in response to detecting the input at FIG. 8F and in accordance with a determination that the input is a hand input gesture of type C (e.g., a wrist flick gesture), computer system 600 returns to displaying watch face 610. In response to detecting the input at FIG. 8F and in accordance with a determination that the input is a hand input gesture of type C (e.g., a wrist flick gesture), computer system 600 displays watch face 610 without a stack of widgets (e.g., without stack of widgets 810B-810E), as shown in FIG. 8H.

At FIG. 8G, computer system 600 is displaying weather user interface 814, which corresponds to weather widget 810B. Weather user interface 814 includes location option 814A to access a list of locations for weather information and a plurality of weather metrics, such as current temperature 814B, current humidity 814C, a current wind speed and/or direction, and/or the high and low temperatures for the day. In some embodiments (e.g., when computer system 600 navigates to weather user interface 814 in response to an air gesture), computer system 600 displays input focus 640 (e.g., to indicate that location option 814A has focus). In some embodiments (e.g., when computer system 600 navigates to weather user interface 814 in response to a touch input and/or an input other than an air gesture), computer system 600 does not display input focus 640. At FIG. 8G, computer system 600 detects an input. In response to detecting the input at FIG. 8G when input focus 640 is displayed and in accordance with a determination that the input is a hand input gesture of type A (e.g., single pinch air gesture or a single fist clench air gesture), computer system 600 activates the user interface object currently having focus. As shown in FIG. 8G, location option 814A has focus when the input is detected and, accordingly, the gesture of type A causes computer system 600 to activate location option 814A, thereby causing computer system 600 to display a list of selected locations for weather information. In some embodiments, in response to detecting the input at FIG. 8G when input focus 640 is not displayed and in accordance with a determination that the input is a hand input gesture of type A (e.g., single pinch air gesture 850E or a single fist clench air gesture), computer system 600 optionally provides feedback (e.g., audio feedback, tactile feedback, and/or visual feedback 804) to the user indicating that the gesture of type A is not currently valid and/or does not currently perform a navigation operation (e.g., based on a focus not being displayed and/or based on the state of computer system 600), such as shown in FIG. 8B (e.g., where the background user interface is weather user interface 814). In some embodiments, in response to detecting the input at FIG. 8G when input focus 640 is not displayed and in accordance with a determination that the input is a hand input gesture of type A (e.g., single pinch air gesture or a single fist clench air gesture), computer system 600 optionally does not perform a navigation operation, does not perform a cancel operation, and does not provide feedback indicating that the gesture of type A is not currently valid and/or does not currently perform a navigation operation. In response to detecting the input at FIG. 8G when input focus 640 is not displayed and in accordance with a determination that the input is a hand input gesture of type B (e.g., a double pinch air gesture or a double fist clench air gesture), computer system 600 displays input focus 640 on a default and/or prominent user interface object, such as location option 814A. In response to detecting the input at FIG. 8G when input focus 640 is displayed and in accordance with a determination that the input is a hand input gesture of type B (e.g., a double pinch air gesture or a double fist clench air gesture), computer system 600 navigates weather user interface 814 by moving input focus 640 from location option 814A to a next user interface object, such as to current temperature 814B. In some embodiments, in response to detecting the input at FIG. 8G and in accordance with a determination that the input is a hand input gesture of type C (e.g., wrist flick gesture 850I) and that there is no ongoing activity at computer system 600 (e.g., no widgets of the stack of widgets is updating based on ongoing activity), computer system 600 displays watch face 610 without stack of widgets 810A-810C, as shown in FIG. 8H. In some embodiments, in response to detecting the input at FIG. 8G and in accordance with a determination that the input is a hand input gesture of type C (e.g., wrist flick gesture 850I) and that there is an ongoing activity at computer system 600 (e.g., one or more widgets of the stack of widgets are updating based on ongoing activity, such as music playing or a weather alert), computer system 600 displays watch face 610 with stack of widgets (e.g., stack of widgets 810A-810C and/or stack of widgets 810E-810G), as shown in FIG. 8I.

At FIG. 8J, computer system 600 is receiving an incoming call. In response to receiving the incoming call (and before the call is answered or declined), computer system 600 displays call user interface 816 and outputs one or more alert (e.g., tactile output 860A and/or audio output 860B) indicating that a call is incoming. Call user interface 816 includes an indication of the person calling, decline option 816A, answer option 816B, and more options 816C. At FIG. 8J, computer system 600 detects an input. In response to detecting the input at FIG. 8J and in accordance with a determination that the input is a hand input gesture of type A (e.g., single pinch air gesture or a single fist clench air gesture), computer system 600 does not decline or answer the incoming call and optionally provides feedback (e.g., audio feedback, tactile feedback, and/or visual feedback 804) to the user indicating that the gesture of type A is not currently valid and/or does not currently perform a navigation operation (e.g., based on a focus not being displayed and/or based on the state of computer system 600), such as shown in FIG. 8B (e.g., where the background user interface is call user interface 816). In response to detecting the input at FIG. 8J and in accordance with a determination that the input is a hand input gesture of type B (e.g., double pinch air gesture or a double fist clench air gesture), computer system 600 does not decline or answer the incoming call and displays input focus 640 on a default and/or prominent user interface object, such as answer option 816B, as shown in FIG. 8N. In response to detecting the input at FIG. 8J and in accordance with a determination that the input is a hand input gesture of type C (e.g., a wrist flick gesture), computer system 600 reduces a prominence of (e.g., by reducing a volume or intensity and/or by ceasing) the one or more alerts (e.g., tactile output 860A and/or audio output 860B) without answering or declining the call (e.g., the call is not automatically transferred to voicemail) and while optionally continuing to display call user interface 816, as shown in FIG. 8K. In response to detecting the input at FIG. 8J and in accordance with a determination that the input is a hand input gesture of type D (e.g., a wrist down gesture, as shown in FIG. 8R), computer system 600 does not decline or answer the incoming call and reduces a prominence of (e.g., by reducing a volume or intensity and/or by ceasing) the one or more alerts (e.g., tactile output 860A and/or audio output 860B) and/or transitions display 602 into a low-power mode while optionally continuing to display call user interface 816, as shown in FIG. 8R.

At FIG. 8K, computer system 600 is receiving an incoming call and the prominence of the one or more alerts has been reduced (e.g., in response to detecting a hand input gesture of type C (e.g., a wrist flick gesture) at FIG. 8J). At FIG. 8K, computer system 600 detects an input. In response to detecting the input at FIG. 8K and in accordance with a determination that the input is a hand input gesture of type A (e.g., single pinch air gesture or a single fist clench air gesture), computer system 600 does not answer or decline the incoming call and optionally provides feedback (e.g., audio feedback 860D, tactile feedback 860C, and/or visual feedback 804) to the user indicating that the gesture of type A is not currently valid and/or does not currently perform a navigation operation (e.g., based on a focus not being displayed and/or based on the state of computer system 600), such as shown in FIG. 8B (e.g., where the background user interface is call user interface 816). In response to detecting the input at FIG. 8K and in accordance with a determination that the input is a hand input gesture of type B (e.g., double pinch air gesture or a double fist clench air gesture), computer system 600 does not answer or decline the incoming call and displays input focus 640 on a default and/or prominent user interface object, such as answer option 816B, as shown in FIG. 8N. In response to detecting the input at FIG. 8K and in accordance with a determination that the input is a hand input gesture of type C (e.g., wrist flick gesture 850J), computer system 600 declines the incoming call without answering the call (e.g., the call is automatically transferred to voicemail and/or can no longer be answered at computer system 600), indicates that the call has been declined (e.g., as shown in FIG. 8L), and optionally automatically proceeds to display watch face 610, as shown in FIG. 8M (or whatever user interface was being displayed when the incoming call was initially received). In response to detecting the input at FIG. 8K and in accordance with a determination that the input is a hand input gesture of type D (e.g., a wrist down gesture, as shown in FIG. 8R), computer system 600 optionally reduces a prominence of (e.g., by reducing a volume or intensity and/or by ceasing) the one or more alerts (e.g., tactile output 860A and/or audio output 860B) and/or transitions display 602 into a low-power mode without answering or declining the call (e.g., the call is not automatically transferred to voicemail) and while optionally continuing to display call user interface 816, as shown in FIG. 8R.

At FIG. 8N, computer system 600 displays call user interface 816 with answer option 816B having input focus 640 (e.g., in response to detecting a hand input gesture of type B (e.g., double pinch air gesture or a double fist clench air gesture) at FIG. 8J or 8K). At FIG. 8N, computer system 600 detects an input. In response to detecting the input at FIG. 8N and in accordance with a determination that the input is a hand input gesture of type A (e.g., single pinch air gesture or a single fist clench air gesture), computer system 600 activates the user interface object currently having focus. As shown in FIG. 8N, answer option 816B has focus when the input is detected and, accordingly, the gesture of type A causes computer system 600 to activate answer option 816B, thereby causing computer system 600 to answer the incoming call, as shown in FIG. 8P. In response to detecting the input at FIG. 8N and in accordance with a determination that the input is a hand input gesture of type B (e.g., double pinch air gesture 850K or a double fist clench air gesture), computer system 600 does not answer or decline the incoming call and navigates call user interface 816 by moving input focus 640 from answer option 816B to a next user interface object, such as to decline option 816A, as shown in FIG. 8O. In some embodiments, in response to detecting the input at FIG. 8N and in accordance with a determination that the input is a hand input gesture of type C (e.g., a wrist flick gesture), computer system 600 declines the incoming call without answering the call (e.g., the call is automatically transferred to voicemail and/or can no longer be answered at computer system 600), indicates that the call has been declined (e.g., as shown in FIG. 8L), and optionally automatically proceeds to display watch face 610, as shown in FIG. 8M (or whatever user interface was being displayed when the incoming call was initially received). In some embodiments, in response to detecting the input at FIG. 8N and in accordance with a determination that the input is a hand input gesture of type C (e.g., a wrist flick gesture), computer system 600 ceases to display input focus 640 without answering or declining the incoming call, as shown in FIG. 8K. In response to detecting the input at FIG. 8N and in accordance with a determination that the input is a hand input gesture of type D (e.g., a wrist down gesture, as shown in FIG. 8R), computer system 600 optionally reduces a prominence of (e.g., by reducing a volume or intensity and/or by ceasing) the one or more alerts (e.g., tactile output 860A and/or audio output 860B) and/or transitions display 602 into a low-power mode without answering or declining the call (e.g., the call is not automatically transferred to voicemail) and while optionally continuing to display call user interface 816, as shown in FIG. 8R.

At FIG. 8O, computer system 600 detects an input. In response to detecting the input at FIG. 8O and in accordance with a determination that the input is a hand input gesture of type A (e.g., single pinch air gesture 850L or a single fist clench air gesture), computer system 600 activates the user interface object currently having focus. As shown in FIG. 8O, decline option 816A has focus when the input is detected and, accordingly, the gesture of type A causes computer system 600 to activate decline option 816A, thereby causing computer system 600 to decline the incoming call without answering the call (e.g., the call is automatically transferred to voicemail and/or can no longer be answered at computer system 600), to optionally indicate that the call has been declined (e.g., as shown in FIG. 8L), and to optionally automatically proceed to display watch face 610, as shown in FIG. 8M (or whatever user interface was being displayed when the incoming call was initially received). In response to detecting the input at FIG. 8O and in accordance with a determination that the input is a hand input gesture of type B (e.g., double pinch air gesture 850K or a double fist clench air gesture), computer system 600 does not answer or decline the incoming call and navigates call user interface 816 by moving input focus 640 from decline option 816A to a next user interface object, such as back to answer option 816B, as shown in FIG. 8N. In some embodiments, in response to detecting the input at FIG. 8O and in accordance with a determination that the input is a hand input gesture of type C (e.g., a wrist flick gesture), computer system 600 declines the incoming call without answering the call (e.g., the call is automatically transferred to voicemail and/or can no longer be answered at computer system 600), indicates that the call has been declined (e.g., as shown in FIG. 8L), and optionally automatically proceeds to display watch face 610, as shown in FIG. 8M (or whatever user interface was being displayed when the incoming call was initially received). In some embodiments, in response to detecting the input at FIG. 8O and in accordance with a determination that the input is a hand input gesture of type C (e.g., a wrist flick gesture), computer system 600 ceases to display input focus 640 without answering or declining the incoming call, as shown in FIG. 8K. In some embodiments, in response to detecting the input at FIG. 8O and in accordance with a determination that the input is a hand input gesture of type D (e.g., a wrist down gesture, as shown in FIG. 8R), computer system 600 optionally reduces a prominence of (e.g., by reducing a volume or intensity and/or by ceasing) the one or more alerts (e.g., tactile output 860A and/or audio output 860B) and/or transitions display 602 into a low-power mode without answering or declining the call (e.g., the call is not automatically transferred to voicemail) and while optionally continuing to display call user interface 816, as shown in FIG. 8R.

At FIG. 8P, computer system 600 has answered the incoming call and displays call user interface 816 with mute option 816D and hang up option 816E having input focus 640 (e.g., in response to detecting a hand input gesture of type A (e.g., single pinch air gesture or a single fist clench air gesture) at FIG. 8N and/or a tap input directed to answer option 816B in FIGS. 8J-8K or 8N-8O). At FIG. 8P, computer system 600 detects an input. In response to detecting the input at FIG. 8P and in accordance with a determination that the input is a hand input gesture of type A (e.g., single pinch air gesture or a single fist clench air gesture), computer system 600 provides feedback 816F indicating how to end the call without automatically ending the call, as shown in FIG. 8Q. In some embodiments, feedback 816F directs the user to activate hang up option 816E using a touch input (e.g., a tap input and/or a tap-and-hold input) to end the call, as shown in FIG. 8Q. In response to detecting the input at FIG. 8P and in accordance with a determination that the input is a hand input gesture of type B (e.g., double pinch air gesture 850K or a double fist clench air gesture), computer system 600 does not end the call and navigates call user interface 816 by moving input focus 640 from hang up option 816E to a next user interface object, such as to mute option 816D. In response to detecting the input at FIG. 8P and in accordance with a determination that the input is a hand input gesture of type C (e.g., wrist flick gesture 850M), computer system 600 provides feedback 816F indicating how to end the call without automatically ending the call, as shown in FIG. 8Q.

At FIG. 8Q, computer system 600 the call is ongoing and computer system 600 displays call user interface 816 with mute option 816D and hang up option 816E. At FIG. 8Q, computer system 600 detects an input. In response to detecting the input at FIG. 8Q and in accordance with a determination that the input is a touch input (e.g., tap input 850N and/or a press-and-hold input) directed to hang up option 816E, computer system 600 ends the call.

At FIG. 8R, computer system 600 is receiving an incoming call and display 602 is operating in a low-power mode. In some embodiments, touch inputs (e.g., on decline option 816A or answer option 816B) on display 602 transition display 602 out of the low-power mode without declining or answering the call.

At FIG. 8S, computer system 600 is displaying alarm user interface 818 and outputting one or more alerts (e.g., tactile output 860A and/or audio output 860B) indicating that an alarm time has been reached. Alarm user interface 818 includes snooze option 818A to snoozes the one or more alerts indicating that the alarm time has been reached such that computer system 600 ceases to output the one or more alerts indicating that the alarm time has been reached and configures computer system 600 to later output another one or more alerts to indicate that the alarm time has been reached. Alarm user interface 818 also includes stop option 818B to stop the one or more alerts indicating that the alarm time has been reached without configuring computer system 600 to later output another one or more alerts to indicate that the alarm time has been reached. At FIG. 8S, computer system 600 detects an input. In some embodiments, in response to detecting the input at FIG. 8S when input focus 640 is displayed and in accordance with a determination that the input is a hand input gesture of type A (e.g., single pinch air gesture or a single fist clench air gesture), computer system 600 activates the user interface object currently having focus. As shown in FIG. 8S, snooze option 818A has focus when the input is detected and, accordingly, the gesture of type A causes computer system 600 to activate snooze option 818A, thereby causing computer system 600 to snooze the one or more alerts (e.g., tactile output 860A and/or audio output 860B), as described above. In some embodiments, in response to detecting the input at FIG. 8S when input focus 640 is not displayed and in accordance with a determination that the input is a hand input gesture of type A (e.g., a single pinch air gesture or a single fist clench air gesture), computer system 600 optionally provides feedback (e.g., audio feedback, tactile feedback, and/or visual feedback 804) to the user indicating that the gesture of type A is not currently valid and/or does not currently perform a navigation operation (e.g., based on a focus not being displayed and/or based on the state of computer system 600), such as shown in FIG. 8B (e.g., where the background user interface is alarm user interface 818). In some embodiments, in response to detecting the input at FIG. 8S when input focus 640 is not displayed and in accordance with a determination that the input is a hand input gesture of type A (e.g., single pinch air gesture or a single fist clench air gesture), computer system 600 optionally does not perform a navigation operation, does not perform a cancel operation, and does not provide feedback indicating that the gesture of type A is not currently valid and/or does not currently perform a navigation operation. In some embodiments, in response to detecting the input at FIG. 8S when input focus 640 is not displayed and in accordance with a determination that the input is a hand input gesture of type B (e.g., a double pinch air gesture or a double fist clench air gesture), computer system 600 displays input focus 640 on a default and/or prominent user interface object, such as snooze option 818A. In some embodiments, in response to detecting the input at FIG. 8S when input focus 640 is displayed and in accordance with a determination that the input is a hand input gesture of type B (e.g., a double pinch air gesture or a double fist clench air gesture), computer system 600 navigates alarm user interface 818 by moving input focus 640 from snooze option 818A to a next user interface object, such as to stop option 818B. In response to detecting the input at FIG. 8S and in accordance with a determination that the input is a hand input gesture of type C (e.g., wrist flick gesture 850O), computer system 600 reduces a prominence of (e.g., reduces and or ceases output of) the one or more alerts (e.g., tactile output 860A and/or audio output 860B) indicating that an alarm time has been reached (e.g., with or without configuring computer system 600 to later output another one or more alerts to indicate that the alarm time has been reached). In some embodiments, hand input gesture of type C snoozes the alarm. In some embodiments, hand input gesture of type C stops the alarm.

At FIG. 8T, computer system 600 is displaying timer user interface 820 and outputting one or more alerts (e.g., tactile output 860A and/or audio output 860B) indicating that the timer has elapsed. Timer user interface 820 includes stop option 820A to stop the one or more alerts and repeated option 820B to initiate another countdown. At FIG. 8T, computer system 600 detects an input. In some embodiments, in response to detecting the input at FIG. 8T when input focus 640 is displayed and in accordance with a determination that the input is a hand input gesture of type A (e.g., single pinch air gesture or a single fist clench air gesture), computer system 600 activates the user interface object currently having focus. As shown in FIG. 8T, stop option 820A has focus when the input is detected and, accordingly, the gesture of type A causes computer system 600 to activate stop option 820A, thereby causing computer system 600 to stop outputting the one or more alerts (e.g., tactile output 860A and/or audio output 860B). In some embodiments, in response to detecting the input at FIG. 8T when input focus 640 is not displayed and in accordance with a determination that the input is a hand input gesture of type A (e.g., a single pinch air gesture or a single fist clench air gesture), computer system 600 optionally provides feedback (e.g., audio feedback, tactile feedback, and/or visual feedback 804) to the user indicating that the gesture of type A is not currently valid and/or does not currently perform a navigation operation (e.g., based on a focus not being displayed and/or based on the state of computer system 600), such as shown in FIG. 8B (e.g., where the background user interface is timer user interface 820). In some embodiments, in response to detecting the input at FIG. 8T when input focus 640 is not displayed and in accordance with a determination that the input is a hand input gesture of type A (e.g., single pinch air gesture or a single fist clench air gesture), computer system 600 optionally does not perform a navigation operation, does not perform a cancel operation, and does not provide feedback indicating that the gesture of type A is not currently valid and/or does not currently perform a navigation operation. In some embodiments, in response to detecting the input at FIG. 8T when input focus 640 is not displayed and in accordance with a determination that the input is a hand input gesture of type B (e.g., a double pinch air gesture or a double fist clench air gesture), computer system 600 displays input focus 640 on a default and/or prominent user interface object, such as stop option 820A. In some embodiments, in response to detecting the input at FIG. 8T when input focus 640 is displayed and in accordance with a determination that the input is a hand input gesture of type B (e.g., a double pinch air gesture or a double fist clench air gesture), computer system 600 navigates timer user interface 820 by moving input focus 640 from stop option 820A to a next user interface object, such as to repeat option 820B. In response to detecting the input at FIG. 8T and in accordance with a determination that the input is a hand input gesture of type C (e.g., wrist flick gesture 850P), computer system 600 reduces a prominence of (e.g., reduces and or ceases output of) the one or more alerts (e.g., tactile output 860A and/or audio output 860B) indicating that the timer has elapsed.

At FIG. 8U, computer system 600 is displaying workout user interface 822. Workout user interface 822 includes activity option 822A to change the workout activity being tracked that the user is currently performing. At FIG. 8U, computer system 600 detects an input. In some embodiments, in response to detecting the input at FIG. 8U when input focus 640 is displayed and in accordance with a determination that the input is a hand input gesture of type A (e.g., single pinch air gesture or a single fist clench air gesture), computer system 600 activates the user interface object currently having focus. As shown in FIG. 8U, activity option 822A has focus when the input is detected and, accordingly, the gesture of type A causes computer system 600 to activate activity option 822A, thereby causing computer system 600 to initiate a process to change the physical activity being tracked. In some embodiments, in response to detecting the input at FIG. 8U when input focus 640 is not displayed and in accordance with a determination that the input is a hand input gesture of type A (e.g., a single pinch air gesture or a single fist clench air gesture), computer system 600 optionally provides feedback (e.g., audio feedback, tactile feedback, and/or visual feedback 804) to the user indicating that the gesture of type A is not currently valid and/or does not currently perform a navigation operation (e.g., based on a focus not being displayed and/or based on the state of computer system 600), such as shown in FIG. 8B (e.g., where the background user interface is workout user interface 822). In some embodiments, in response to detecting the input at FIG. 8U when input focus 640 is not displayed and in accordance with a determination that the input is a hand input gesture of type A (e.g., single pinch air gesture or a single fist clench air gesture), computer system 600 optionally does not perform a navigation operation, does not perform a cancel operation, and does not provide feedback indicating that the gesture of type A is not currently valid and/or does not currently perform a navigation operation. In some embodiments, in response to detecting the input at FIG. 8U when input focus 640 is not displayed and in accordance with a determination that the input is a hand input gesture of type B (e.g., a double pinch air gesture or a double fist clench air gesture), computer system 600 displays input focus 640 on a default and/or prominent user interface object, such as activity option 822A. In some embodiments, in response to detecting the input at FIG. 8U when input focus 640 is displayed and in accordance with a determination that the input is a hand input gesture of type B (e.g., a double pinch air gesture or a double fist clench air gesture), computer system 600 navigates workout user interface 822 by moving input focus 640 from activity option 822A to a next user interface object. In response to detecting the input at FIG. 8U and in accordance with a determination that the input is a hand input gesture of type C (e.g., wrist flick gesture 850Q) and that a respective time of activity is ongoing (e.g., a workout activity, running, and/or exercising), computer system 600 continues to display workout user interface 822 (e.g., without displaying watch face 610) and optionally provides feedback (e.g., audio, tactile, and/or visual feedback) to the user indicating that the gesture of type C is not currently valid and/or does not currently perform a selection/activation operation (e.g., based on the state of computer system 600 and/or during a respective activity of the user of computer system 600), as shown in FIG. 8B (e.g., where the background user interface is workout user interface 822).

At FIG. 8V, computer system 600 is displaying camera control user interface 824 and companion device 880 (e.g., a smart phone, a tablet, and/or a laptop) is displaying camera user interface 882. Computer system 600 and companion device 880 are in communication (e.g., wireless communication and/or paired) and are optionally signed into the same service using the same account and/or username. Camera user interface 882 includes viewfinder 882B that shows at least a portion of a field-of-view of one or more camera sensors of companion device 880 and shutter button 882A, which when activated causes companion device 880 to capture an image and/or a video of at least a portion of the field-of-view of the one or more camera sensors of companion device 880. Camera control user interface includes viewfinder 824B that shows at least a portion of a field-of-view of one or more camera sensors of companion device 880 (e.g., via a data stream received from companion device 880) and shutter button 824A, which when activated causes (e.g., via an instruction sent to) companion device 880 to capture (e.g., after a delay, such as of 1 second, 3 seconds, or 5 seconds) an image and/or a video of at least a portion of the field-of-view of the one or more camera sensors of companion device 880. At FIG. 8V, computer system 600 detects an input. In some embodiments, in response to detecting the input at FIG. 8V when input focus 640 is displayed and in accordance with a determination that the input is a hand input gesture of type A (e.g., single pinch air gesture or a single fist clench air gesture), computer system 600 activates the user interface object currently having focus. As shown in FIG. 8V, shutter button 824A has focus when the input is detected and, accordingly, the gesture of type A causes computer system 600 to activate shutter button 824A, thereby causing computer system 600 to instruct companion device 880 to capture an image and/or video. In some embodiments, in response to detecting the input at FIG. 8V when input focus 640 is not displayed and in accordance with a determination that the input is a hand input gesture of type A (e.g., a single pinch air gesture or a single fist clench air gesture), computer system 600 optionally provides feedback (e.g., audio feedback, tactile feedback, and/or visual feedback 804) to the user indicating that the gesture of type A is not currently valid and/or does not currently perform a navigation operation (e.g., based on a focus not being displayed and/or based on the state of computer system 600), such as shown in FIG. 8B (e.g., where the background user interface is camera control user interface 824). In some embodiments, in response to detecting the input at FIG. 8V when input focus 640 is not displayed and in accordance with a determination that the input is a hand input gesture of type A (e.g., single pinch air gesture or a single fist clench air gesture), computer system 600 optionally does not perform a navigation operation, does not perform a cancel operation, and does not provide feedback indicating that the gesture of type A is not currently valid and/or does not currently perform a navigation operation. In some embodiments, in response to detecting the input at FIG. 8V when input focus 640 is not displayed and in accordance with a determination that the input is a hand input gesture of type B (e.g., a double pinch air gesture or a double fist clench air gesture), computer system 600 displays input focus 640 on a default and/or prominent user interface object, such as shutter button 824A. In some embodiments, in response to detecting the input at FIG. 8V when input focus 640 is displayed and in accordance with a determination that the input is a hand input gesture of type B (e.g., a double pinch air gesture or a double fist clench air gesture), computer system 600 navigates camera control user interface 824 by moving input focus 640 from shutter button 824A to a next user interface object, such as settings option 824C. In response to detecting the input at FIG. 8V and in accordance with a determination that the input is a hand input gesture of type C (e.g., wrist flick gesture 850R), computer system 600 ceases displaying camera control user interface 824 (and, optionally, displays watch face 610, as shown in FIG. 8A) and instructs companion device 880 to cease displaying camera user interface 882.

FIG. 8W illustrates example hand gestures illustrated from a viewpoint of a user of computer system 600. For example, computer system 600 detects a hand input gesture of type C (e.g., a wrist flick gesture) when computer system 600 detects the user providing (e.g., continuous or near-continuous) movement 850S1-850S4 of wrist 604A of the user in a back-and-forth motion (e.g., turning a display of computer system 600 away from the user and then turning (e.g., without pausing) the display of computer system 600 back toward the user). In some embodiments, computer system 600 detects an input as a hand input gesture of type C (e.g., a wrist flick gesture) when the back-and-forth motion illustrated in FIG. 8W exceeds a threshold rotation (e.g., 45 degrees, 60 degrees, 90 degrees, or 180 degrees) of wrist 604A of the user and/or of computer system 600 and computer system 600 does not detect the input as a hand input gesture of type C when the back-and-forth motion does not exceed the threshold rotation (e.g., arm was not rotated enough to register as a wrist flick gesture). In some embodiments, computer system 600 detects an input as a hand input gesture of type C (e.g., a wrist flick gesture) when the back-and-forth motion illustrated in FIG. 8W is a continuous or near-continuous motion (e.g., no pauses and/or no significant pauses) and computer system 600 does not detect an input as a hand input gesture of type C when the back-and-forth motion is not continuous or near-continuous (e.g., computer system 600 detects rotation of wrist 604A and/or computer system 600 away from the user via input 850S1-850S2, then a pause (e.g., of 1 second, 2 seconds, or 5 seconds), then detects rotation of wrist 604A and/or computer system 600 back via input 850S3-850S4). Similarly, computer system 600 does not detect an input as a hand input gesture of type C when the back-and-forth motion is not continuous or near-continuous and includes a pause before completing the gesture (e.g., computer system 600 detects rotation of wrist 604A and/or computer system 600 away from the user via input 850S1-850S2 and partially back via input 850S3, then a pause (e.g., of 1 second, 2 seconds, or 5 seconds), then detects rotation of wrist 604A and/or computer system 600 back via input 850S4 to complete the motion). In some embodiments, computer system 600 detects an input as a hand input gesture of type C (e.g., a wrist flick gesture) when the back-and-forth motion illustrated in FIG. 8W is performed within a threshold duration of time (e.g., within 0.3 seconds, within 0.5 seconds, or within 1 second). In some embodiments, computer system 600 detects an input as a hand input gesture of type C (e.g., a wrist flick gesture) when the back-and-forth motion illustrated in FIG. 8W is a continuous or near-continuous motion (e.g., no pauses and/or no significant pauses), the rotation of the back-and-forth motion exceeds a threshold rotation, and/or the back-and-forth is performed within a threshold duration of time. In some embodiments, computer system 600 detects input 850S1-850S2 without detecting a continuation that includes inputs 850S3-850S4 and detects the input as a hand input gesture of type D (e.g., a wrist down gesture).

FIG. 9 is a flow diagram illustrating a method for managing air gestures using a computer system, in accordance with some embodiments. Method 900 is performed at a computer system (e.g., 100, 300, 500, and/or 600) (e.g., a smartphone, a wearable device (e.g., a smartwatch), a tablet computer, a desktop computer, a laptop computer, and/or a head-mounted device (e.g., a head-mounted augmented reality and/or extended reality device)) that is in communication (e.g., is in wired communication and/or is in wireless communication) with one or more display generation components (e.g., 602) (e.g., one or more display controllers, touch-sensitive display systems, display screens, monitors, projectors, holographic displays, and/or a head-mounted display system) and one or more input devices (e.g., one or more camera sensors (e.g., one or more optical sensors 164 and/or one or more depth camera sensors 175), touch-sensitive surfaces, accelerometers, gyroscopes, and/or motion sensors).

Some operations in method 900 are, optionally, combined, the orders of some operations are, optionally, changed, and some operations are, optionally, omitted.

As described below, method 900 provides an intuitive way for managing air gestures. The method reduces the cognitive burden on a user for operating a device using air gestures, thereby creating a more efficient human-machine interface. For battery-operated computing devices, enabling a user to operate a device and/or navigate a user interface faster and more efficiently conserves power and increases the time between battery charges.

The computer system (e.g., 600) displays (902), via the one or more display generation components (e.g., 602), a respective user interface (e.g., 610, 812, 814, 816, 818, 820, 822, and/or 824) (e.g., a user interface of an application, a system user interface, a notification user interface, and/or a home screen user interface). While displaying the respective user interface (e.g., 610, 812, 814, 816, 818, 820, 822, and/or 824), the computer system (e.g., 600) detects (904), via the one or more input devices, a hand input (e.g., 850A, 850E, 850G, 860H, 850I, 850J, 850K, 850L, 850M, 850O) (e.g., a movement of a hand and/or a gesture performed by a hand of a user). In some embodiments, the computer system (e.g., 600) detects (e.g., via one or more sensors of the computer system) that a hand (e.g., of wrist 604A) that is wearing the computer system performs the hand input. In response (906) to detecting the hand input and in accordance with a determination that the hand input is a respective wrist gesture (e.g., gesture type C in FIGS. 8A-8V) (e.g., a respective movement of a wrist of the user and/or a rotation of a wrist), the computer system (e.g., 600) performs (908) a cancel operation (e.g., returning to FIG. 8A from FIGS. 8C-8F, returning to FIGS. 8H-8I from FIG. 8G, reducing prominence of an alert as in FIG. 8K, declining a call as in FIG. 8L, silencing an alarm as in FIG. 8S-8T), associated with (e.g., corresponding to and/or performed on) the respective user interface (and, optionally, without performing the operation associated with the respective user interface). In response (906) to detecting the hand input and in accordance with a determination that the hand input is a first type of finger gesture (e.g., a double pinch air gesture, a double tap gesture, and/or a swipe gesture) (e.g., gesture type B in FIGS. 8A-8V) that is different from the respective wrist gesture, the computer system (e.g., 600) performs (910) an operation (e.g., displaying a focus, changing a focus, activated an element having focus, and/or providing feedback) associated with the respective user interface that is different from the cancel operation (and, optionally, without performing the cancel operation). Performing a cancel operation associated with a respective user interface or performing a different operation associated with the respective user interface based on a detected hand input enables the computer system to quickly and accurately perform different operations in response to user hand inputs, thereby reducing the number of inputs needed to perform various operations and providing additional control options without cluttering the user interface with additional displayed controls. For example, quickly performing a cancel operation reduces power consumption and saves battery power.

In some embodiments, the cancel operation associated with the respective user interface (e.g., 610, 812, 814, 816, 818, 820, 822, and/or 824) is related to a respective function (e.g., incoming call management as in FIGS. 8J-8R, alarm management as in FIG. 8S, timer management as in FIG. 8T, workout management as in FIG. 8U, and/or camera management as in FIG. 8V) and the operation associated with the respective user interface is related to the respective function. In some embodiments, the cancel operation associated with the respective user interface cancels and/or forgoes performance of a respective function and the operation associated with the respective user interface performs the respective function. Performing a cancel operation related to a respective function or performing a different operation related to the same respective function based on a detected hand input enables the computer system to quickly and accurately perform different operations in response to user hand inputs, thereby reducing the number of inputs needed to perform various operations and providing additional control options without cluttering the user interface with additional displayed controls.

In accordance with some embodiments, the first type of finger gesture is a tap air gesture (e.g., gesture type A and/or gesture type B in FIGS. 8A-8W) (e.g., a single tap air gesture or a double tap air gesture). In some embodiments, the first type of finger gesture includes the ends of two fingers (e.g., a thumb and pointer finger) of a hand of the user tapping together. In some embodiments, the computer system detects (e.g., via one or more sensors of the computer system) that a hand that is wearing the computer system performs the hand input.

In some embodiments, performing the operation associated with the respective user interface includes performing a first operation (and, optionally, not performing a second operation and not performing the cancel operation). In some embodiments, in response to detecting the hand input: in accordance with a determination that the hand input is a second type of finger gesture (e.g., gesture type A of FIGS. 8A-8W) (e.g., a single pinch air gesture, a single tap gesture, and/or a swipe gesture) that is different from the first type of finger gesture (e.g., gesture type B of FIGS. 8A-8W) and the respective wrist gesture (e.g., gesture type C of FIGS. 8A-8W), performing a second operation (e.g., activating a user interface object that has focus and/or activating an application) that is different from the first operation and the cancel operation (and, optionally, without performing the second operation and without performing the cancel operation). Performing different operations based on a detected type of finger gesture of a hand input enables the computer system to quickly and accurately perform different operations in response to finger gestures, thereby reducing the number of inputs needed to perform various operations and providing additional control options without cluttering the user interface with additional displayed controls.

In some embodiments, the first operation is a navigation operation (e.g., as in FIGS. 8C to 8E to 8F and/or FIGS. 8N to 8O) (e.g., a scroll operation that causes one or more user interface objects to scroll and/or a next item operation that causes the computer system to navigate to a next item) and the second operation is a selection operation (e.g., as in FIG. 8N to 8P, snooze in FIG. 8S, and/or stop in FIG. 8T) (e.g., that selects a user interface object that currently has focus (e.g., is identified by a visual indication of input focus)) (e.g., as in gesture type A performed at FIGS. 8C, 8E, and/or 8F). Performing a navigation operation or a selection operation based on a detected type of finger gesture of a hand input enables the computer system to quickly and accurately perform different operations in response to finger gestures, thereby reducing the number of inputs needed to perform various operations and providing additional control options without cluttering the user interface with additional displayed controls.

In some embodiments, the first type of finger gesture (e.g., gesture type B in FIGS. 8A-8W) is a multiple (e.g., double, triple, or quadruple) tap air gesture (e.g., an air gesture that includes a repeated tap of two fingers or more than two fingers together) and the second type of finger gesture (e.g., gesture type A in FIGS. 8A-8W) is a single tap air gesture (e.g., an air gesture that includes a single tap of two fingers or more than two fingers together). Performing different operations based on a detected multiple-tap finger gesture or a single-tap finger gesture enables the computer system to quickly and accurately perform different operations in response to different finger tap gestures, thereby reducing the number of inputs needed to perform various operations and providing additional control options without cluttering the user interface with additional displayed controls.

In some embodiments, performing the first operation includes displaying, via the one or more display generation components (e.g., 602), a visual indication of input focus (e.g., 640) (e.g., displaying a focus selector, a selection ring, underlining, changed color, changed brightness, changed size, and/or other visual emphasis that visually differentiates the focused object from other objects of the user interface). In some embodiments, prior to performing the first operation, the respective user interface is displayed without displaying a visual indication of input focus and performing the first operation causes the visual indication of input focus to be displayed. In some embodiments, performing the first operation includes transitioning from not indicating a focus for any user interface object to indicating a focus for a respective user interface object (e.g., be enlarging, translating, and/or highlighting the respective user interface object). In some embodiments, the visual indication of input focus provides visual feedback indicating a user interface object that will be activated in response to the computer system detecting a subsequent gesture (e.g., a gesture that meets selection criteria and/or a particular gesture). Displaying a visual indication of input focus based on a detected type of finger gesture of a hand input enables the computer system to quickly and accurately show input focus in response to finger gestures, thereby reducing the number of inputs needed to show input focus and providing additional control options without cluttering the user interface with additional displayed controls.

In some embodiments, performing the second operation includes performing a selection (e.g., activation of a user interface object and/or option, as in FIGS. 8C, 8D, and/or 8G) based on the visual indication of input focus. In some embodiments, performing a selection based on the visual indication of input focus includes activating a user interface object (e.g., a user-selectable option and/or a button) that currently has focus as indicated by the visual indication of input focus. Performing a selection based on the visual indication of input focus based on a detected type of finger gesture of a hand input enables the computer system to quickly and accurately perform a selection in response to finger gestures, thereby reducing the number of inputs needed to select an object and providing additional control options without cluttering the user interface with additional displayed controls.

In some embodiments, while displaying the visual indication (e.g., 640) of input focus (e.g., as in FIG. 8E) (e.g., displaying the visual indication of input focus to indicate that a first user interface object has focus and/or subsequent to performing the first operation that includes displaying the focus selector), the computer system (e.g., 600) detects, via the one or more input devices, a second hand input (e.g., a second movement of a hand and/or a gesture performed by a hand of a user). In response to detecting the second hand input and in accordance with a determination that the second hand input is the first type of finger gesture (e.g., gesture type B at FIG. 8E) (e.g., a double pinch air gesture, a double tap gesture, and/or a swipe gesture), moving the visual indication of input focus (e.g., as in the transition from FIG. 8E to 8F and/or the transition from FIG. 8N to 8O) (e.g., from a first user interface object to a second user interface object, from a first option to a second option, and/or from a first portion of the respective user interface to a second portion of the respective user interface). In some embodiments, in response to detecting the second hand input and in accordance with a determination that the second hand input is the first type of finger gesture, the computer system updates the first user interface object to indicate that it does not have focus and updates (e.g., enlarges, translates, and/or highlights) the second user interface object to indicate that it has focus. Moving the visual indication of input focus in response to the first type of finger gesture when the visual indication of input focus is already displayed enables the computer system to quickly and accurately move the input focus among different objects in response to finger gestures, thereby reducing the number of inputs needed to navigate among objects and providing additional control options without cluttering the user interface with additional displayed controls.

In some embodiments, moving the visual indication (e.g., 640) of input focus includes moving the visual indication (e.g., 640) of input focus from a primary action of a user interface object to a sub-element of the user interface object. In some embodiments, the user interface object includes a plurality of sub-elements. In some embodiments, the visual indication of input focus moves from indicating the primary action of the user interface object (e.g., highlighting the plurality of sub-elements) has focus to indicating that a respective sub-element of the plurality of sub-elements has focus (e.g., by highlighting the respective sub-element and not other sub-elements). Moving the visual indication of input focus in response to the first type of finger gesture to a sub-element enables the computer system to quickly and accurately move the input focus among different objects and/or parts of objects in response to finger gestures, thereby reducing the number of inputs needed to navigate among objects and providing additional control options without cluttering the user interface with additional displayed controls.

In some embodiments, the respective user interface includes a plurality of user interface objects. In some embodiments, performing the first operation includes: (e.g., in accordance with a determination that the first user interface object is a selectable user interface object) dimming (e.g., as in FIG. 8N) one or more first user interface objects, of the plurality of user interface objects, that cannot be selected using an air gesture without dimming one or more second user interface objects (e.g., 816A and 816B in FIG. 8N), of the plurality of user interface objects, that can be selected using an air gesture. In some embodiments, displaying the visual indication of input focus includes visually indicating that a first user interface object has focus (and not dimming the first user interface object). Dimming user interface objects that cannot be selected using air gestures provides the user with visual feedback about which user interface elements can be selected using air gestures and/or hand gestures, thereby providing improved visual feedback.

In some embodiments, the respective user interface includes a plurality of user interface objects. In some embodiments, performing the first operation includes: in accordance with a determination that a user interface object of the plurality of user interface objects is a selectable user interface object (e.g., 810A and/or 810E) that corresponds to updates to an ongoing activity (e.g., ongoing device activity). For example, a user interface object that includes display of updates about the status of an activity (e.g., time remaining until a food order arrives, time remaining in a countdown timer, flight status information for an upcoming flight, and/or up-to-date information about an event or activity from an application of the computer system) by providing frequent and/or live information updates about the activity that is managed by an application that the system, displaying, via the one or more display generation components, a visual indication of input focus to indicate that the selectable user interface object that corresponds to the updates to the ongoing activity (e.g., ongoing device activity) has focus. In some embodiments, in accordance with a determination that no user interface object of the plurality of user interface objects is a selectable user interface object that corresponds to updates to an ongoing activity, the computer system displays, via the one or more display generation components, a visual indication of input focus to indicate that a selectable user interface object that does not correspond to updates to the ongoing activity has focus. In some embodiments, when a selectable user interface object that corresponds to updates to an ongoing activity and/or an ongoing operation is available to have focus, the computer system places the focus on the selectable user interface object that corresponds to the updates to the ongoing activity and/or ongoing operation and when there are no selectable user interface objects that correspond to updates to an ongoing activity or an ongoing operation, the computer system places the focus on a selectable user interface object that does not corresponding to updates an ongoing activity or an ongoing operation. Displaying the visual indication of input focus at a user interface object that corresponds to updates to an ongoing activity enables the computer system to quickly and easily provide the user with access to the user interface object, thereby reducing the number of inputs needed to navigate among objects and providing additional control options without cluttering the user interface with additional displayed controls.

In some embodiments, performing the cancel operation associated with (e.g., corresponding to and/or performed on) the respective user interface includes reducing a prominence of (e.g., silencing or reducing a volume of) audio being output via one or more output devices (e.g., speakers) of the computer system (e.g., as illustrated in FIG. 8K and described with respect to FIGS. 8S and 8T) (e.g., audio indicating an alarm time of an alarm clock has been reached, audio of an elapsed timer, audio of an alert (e.g., ringing or ringtone) of an incoming call (e.g., audio call, phone call, and/or video call), audio of media playback). In some embodiments, the computer system is outputting the audio (e.g., via device speakers, via an audio output device, and/or via headphones) when the hand input is detected and, in response, silences the audio. Reducing a prominence of audio as part of the cancel operation enables the computer system to provide the user with a quick means of reducing the audio level of an alert or notification, thereby improving the man-machine interface and providing additional control options without cluttering the user interface with additional displayed controls.

In some embodiments, performing the cancel operation associated with (e.g., corresponding to and/or performed on) the respective user interface includes reducing a prominence of (e.g., ceasing or reducing an intensity of) tactile output being output via one or more output devices (e.g., haptic output devices) of the computer system (e.g., as illustrated in FIG. 8K and described with respect to FIGS. 8S and 8T) (e.g., tactile output indicating an alarm time of an alarm clock has been reached, tactile output of an elapsed timer, and/or tactile output of an alert of an incoming call (e.g., audio call, phone call, and/or video call)). In some embodiments, the computer system is outputting the tactile output when the hand input is detected and, in response, ceases outputting the tactile output. Reducing a prominence of tactile output as part of the cancel operation enables the computer system to provide the user with a quick means of reducing tactile output of an alert or notification, thereby improving the man-machine interface and providing additional control options without cluttering the user interface with additional displayed controls.

In some embodiments, performing the cancel operation associated with (e.g., corresponding to and/or performed on) the respective user interface includes ending (e.g., stopping or pausing) an active timer that is counting down (e.g., as in FIG. 8T if the countdown timer had not yet completed). In some embodiments, a countdown timer is actively counting down when the cancel operation is detected, and the cancel operation causes the countdown to terminate. In some embodiments, the cancel operation optionally causes the respective user interface (e.g., of the timer) to cease being displayed (e.g., the countdown timer continues in the background or is terminated). In some embodiments, the computer system replaces display of the respective user interface of the timer with a different user interface (e.g., a watch face) that includes countdown information about the timer. Ending a timer (e.g., that has expired) as part of the cancel operation enables the computer system to provide the user with a quick means of stopping a timer, thereby improving the man-machine interface and providing additional control options without cluttering the user interface with additional displayed controls.

In some embodiments, performing the cancel operation associated with (e.g., corresponding to and/or performed on) the respective user interface includes snoozing an alarm that has expired (e.g., as in FIG. 8S) (e.g., the alarm time has been reached). In some embodiments, the alarm time has been reached and the alarm is outputting (e.g., audio, tactile, and/or visual) an indication that the alarm time has been reached when the hand input is detected, and the cancel operation snoozes the alarm such that the computer system ceases to output the indication that the alarm time has been reached and configures the computer system to later output another indication that the alarm time has been reached (e.g., in a defined amount of time, such as in 3, 8, or 10 minutes after detecting the hand input). Snoozing an alarm that has expired as part of the cancel operation enables the computer system to provide the user with a quick means of snoozing the alert of the alarm, thereby improving the man-machine interface and providing additional control options without cluttering the user interface with additional displayed controls.

In some embodiments, performing the cancel operation associated with (e.g., corresponding to and/or performed on) the respective user interface includes canceling an operation that is pending and has not yet been completed. In some embodiments, the operation that is pending is to send a message (e.g., an email and/or an instant message) at a particular time and/or when a countdown timer expires and the cancel operation cancels the operation such that the message is not sent at the particular time and/or when the countdown timer was set to expire. In some embodiments, the computer system receives an audio request to send a message to a recipient and, in response, schedules the message to be sent to the recipient, thereby providing the user with time to cancel sending the message before the message is sent (e.g., if the message is no longer relevant or the recipient is incorrect). Canceling an operation that is pending and has not yet been completed enables the computer system to provide the user with a quick means of canceling an operation before it is performed, thereby improving the man-machine interface and providing additional control options without cluttering the user interface with additional displayed controls.

In some embodiments, performing the cancel operation associated with (e.g., corresponding to and/or performed on) the respective user interface includes ceasing to display (e.g., dismissing) the respective user interface (e.g., as described with respect to transitioning from application user interfaces to watch face 610 of FIGS. 8A and/or 8H-8I). Dismissing a user interface as part of the cancel operations enables the computer system to provide the user with a quick means of moving away from an existing displayed user interface, thereby improving the man-machine interface and providing additional control options without cluttering the user interface with additional displayed controls. For example, ceasing to display the respective user interface can reduce power consumption and save battery power.

In some embodiments, the respective user interface is a system user interface (e.g., a user interface for changing/configures system settings, a notification initiated by the computer system, a user interface indicating a currently playing media and/or providing control options for the currently playing media, and/or a system keyboard) and performing the cancel operation associated with (e.g., corresponding to and/or performed on) the respective user interface includes displaying, via the one or more display generation components, a wake screen user interface (e.g., watch face 610) (e.g., a watch face user interface that includes a current time and one or more complications and/or a user interface of an application that is currently active). An example of an application that is currently active includes a timer application with a timer that is actively counting down. In some embodiments, displaying the wake screen user interface includes replacing the respective user interface with the wake screen user interface. In some embodiments, the computer system displays the wake screen user interface when the computer system transitions out of a low-power mode (e.g., into a standard- or high-power mode). In some embodiments, a complication refers to a feature of a user interface (e.g., a home screen, a wake screen, a clock face, and/or a watch face) other than those used to indicate the hours and minutes of a time (e.g., clock hands and/or hour/minute indications). In some embodiments, complications provide data obtained from an application of the computer system. In some embodiments, a complication updates the displayed data in accordance with a determination that the data obtained from the application has been updated. In some embodiments, the complication updates the displayed data over time. In some embodiments, a complication includes a user interface object that when selected and/or activated launches a corresponding application. In some embodiments, a complication includes a user interface object that, when selected and/or activated, causes the computer system to perform a specific task. In some embodiments, a complication is displayed at a fixed location on the display. In some embodiments, complications occupy respective locations at particular regions (e.g., lower-right, lower-left, upper-right, and/or upper-left) of a user interface (e.g., a home screen, a wake screen, a clock face, and/or a watch face). In some embodiments, the computer system receives user input selecting a type of complication to include on the display. In some embodiments, the computer system receives user input selecting parameters to display for a specific type of complication.

In some embodiments, the respective user interface is an application user interface (e.g., 812, 814, 816, 818, 820, 822, and/or 824) (e.g., a user interface for a timer, a user interface for a camera remote, a user interface for an audio and/or video call). In some embodiments, performing the cancel operation associated with (e.g., corresponding to and/or performed on) the respective user interface includes displaying, via the one or more display generation components (e.g., 602), a system user interface (e.g., watch face 610) (e.g., wake screen user interface (e.g., a watch face user interface that includes a current time and one or more complications), a user interface that includes one or more options for launching applications and/or causing user interfaces of applications to be displayed, and/or a user interface that includes a stack of widgets through which the user can scroll). In some embodiments, the computer system displays the wake screen user interface when the computer system transitions out of a low-power mode (e.g., into a standard- or high-power mode).

In some embodiments, displaying the system user interface (e.g., watch face 610 and/or a system user interface different from watch face 610) includes: in accordance with a determination that display of the respective user interface was initiated from a first system user interface (e.g., the computer system detected activation of an object of the first system user interface (e.g., an object of a stack of contextual widgets) and, in response, displayed the respective user interface), displaying, via the one or more display generation components, the first system user interface (e.g., without displaying the second system user interface) and in accordance with a determination that display of the respective user interface was initiated from a second system user interface (e.g., the computer system detected activation of an object of the second system user interface and, in response, displayed the respective user interface) that is different from the first system user interface, displaying, via the one or more display generation components, the second system user interface (e.g., without displaying the first system user interface). In some embodiments, the first system user interface is a user interface that includes a stack of widgets with one or more contextual widgets (e.g., as shown in FIG. 8C). In some embodiments, the second system user interface is a user interface that does not include a stack of widgets, does not include a stack of widgets with one or more contextual widgets, and/or a home screen that includes a plurality of activatable application icons (e.g., arranged in a grid and/or a repeating pattern). Dismissing an application user interface as part of the cancel operation and optionally displaying a first system user interface or a second system user interface based on how the application user interface was initiated enables the computer system to provide the user with a quick means of moving away from an existing displayed user interface to a more relevant user interface, thereby improving the man-machine interface and providing additional control options without cluttering the user interface with additional displayed controls.

In some embodiments, performing the cancel operation associated with (e.g., corresponding to and/or performed on) the respective user interface includes displaying, via the one or more display generation components, a respective system user interface (e.g., watch face 610), including: in accordance with a determination that an application is providing updates to an ongoing activity (e.g., ongoing device activity) (e.g., is providing frequent information updates about an activity managed by an application that the system uses to display updates about the status of the activity (e.g., time remaining until a food order arrives, media information for media that is currently playing at the computer system, time remaining in a countdown timer, and/or flight status information for an upcoming flight)), displaying, via the one or more display generation components, a stack of widgets (e.g., 810A-810D and/or 810E-810G at FIG. 8I) (e.g., as part of a watch face user interface) that includes (e.g., at the top of the stack) information about the ongoing activity; and in accordance with a determination that no application is providing updates to an ongoing activity (e.g., no application is providing frequent information updates about an activity managed by an application that the system uses to display updates about the status of the activity (e.g., time remaining until a food order arrives, time remaining in a countdown timer, and/or flight status information for an upcoming flight)), displaying, via the one or more display generation components (e.g., 602), a watch user interface that does not include a stack of widgets (e.g., 610 at FIG. 8H). Displaying a watch user interface without a stack of widgets or to a user interface with a stack of widgets as part of the cancel operation based on whether an application is providing updates to an ongoing activity enables the computer system to provide the user with a quick means of accessing a relevant user interface, thereby improving the man-machine interface and providing additional control options without cluttering the user interface with additional displayed controls.

In some embodiments, performing the cancel operation associated with (e.g., corresponding to and/or performed on) the respective user interface includes displaying, via the one or more display generation components (e.g., 602), a respective system user interface, including: in accordance with a determination that the respective wrist gesture is detected within a threshold duration of time (e.g., 0.5 seconds, 1 second, 2 seconds, 5 seconds, or 10 seconds) of initiating display of the respective user interface (e.g., that display of the respective user interface was initiated less than the threshold duration of time before the respective wrist gesture was detected), displaying, via the one or more display generation components, an application launching user interface that includes a plurality of application user interface objects, including a first application user interface object configured to cause display of a user interface of a first application and a second application user interface object configured to cause display of a user interface of a second application; and in accordance with a determination that the respective wrist gesture is not detected within the threshold duration of time (e.g., is detected after more than the threshold duration of time has passed) of initiating display of the respective user interface (e.g., that display of the respective user interface was initiated more than the threshold duration of time before the respective wrist gesture was detected), displaying, via the one or more display generation components, a watch face user interface (e.g., a watch face user interface that includes a current time and one or more complications) that does not include the plurality of application user interface objects. In some embodiments, the plurality of application user interface objects are configured to launch (e.g., when selected and/or activated) corresponding respective applications and/or to display user interfaces of corresponding respective applications. In some embodiments, the plurality of application user interface objects includes a first application user interface object that, when activated, causes the computer system to display a user interface of the first application, and a second application user interface object that, when activated, causes the computer system to display a user interface of the second application. Displaying different user interfaces as part of the cancel operation based on the timing of detecting the respective wrist gesture enables the computer system to provide the user with a quick means of accessing a relevant user interface, thereby improving the man-machine interface and providing additional control options without cluttering the user interface with additional displayed controls.

In some embodiments, in response to detecting the hand input: in accordance with the determination that the hand input is the respective wrist gesture, the computer system (e.g., 600) sends (e.g., transmitting an instruction and/or sending a command) to a companion device (e.g., 880 in FIG. 8V) that is different from the computer system (e.g., 600), information that causes the companion device (e.g., 880 in FIG. 8V) to change the state of an application of the companion device (e.g., instructing the companion device (e.g., a smart phone) to close a camera application on the companion device when cancel operation corresponding to the respective user interface (a user interface of a camera remote application) on the computer system (e.g., a smart watch) is performed). In some embodiments, the companion device has a special relationship to the computer system, such as a paired relationship and/or being associated with (e.g., logged into the same service with) the same user account. In some embodiments, the computer system and the companion device share one or more (e.g., a plurality) of settings. In some embodiments, the computer system can be used to configure settings of the companion device and/or the companion device can be used to configure settings of the computer system. In some embodiments, the computer system and the companion device cooperate to concurrently output (or forgo outputting) notifications corresponding to the same event and/or alert. Changing the state of an application of a companion device based on the detected hand input enables the computer system to provide the user with a quick means of controlling an external device, thereby improving the man-machine interface and providing additional control options without cluttering the user interface with additional displayed controls.

In some embodiments, after performing the cancel operation associated with (e.g., corresponding to and/or performed on) the respective user interface, the computer system (e.g., 600) detects (e.g., at FIG. 8K), via the one or more input devices, a second hand input (e.g., while displaying the respective user interface). In response to detecting the second hand input and in accordance with a determination that the second hand input is the respective wrist gesture (e.g., a respective movement of a wrist of the user and/or a rotation of a wrist), the computer system (e.g., 600) performs a second operation (e.g., declining an incoming call as in FIG. 8L) (e.g., associated with (e.g., corresponding to and/or performed on) the respective user interface and/or a second cancel operation) that is different from the cancel operation (e.g., reducing a prominence of alerts as in FIG. 8K) (and, optionally that is different from the operation associated with the respective user interface). In some embodiments, the second operation includes one or more of rejecting an incoming call (e.g., so that it can no longer be answered and/or so that it is routed to voicemail), ceasing to display a user interface, and/or operating a display of the computer system in a low-power mode. In some embodiments, in response to detecting the second hand input and in accordance with a determination that the second hand input is the first type of finger gesture (e.g., a double pinch air gesture, a double tap gesture, and/or a swipe gesture), performing an operation associated with the respective user interface that is different from the cancel operation and the second operation (and, optionally, without performing the cancel operation). Performing different operations on subsequent detections of the respective wrist gesture enables the computer system to provide the user with a quick means of performing different operations using air gestures, thereby improving the man-machine interface and providing additional control options without cluttering the user interface with additional displayed controls.

In some embodiments, the cancel operation includes silencing a notification (e.g., silencing audio (e.g., ringing and/or caller name announcement) and/or ceasing haptic output) corresponding to an incoming call (e.g., a phone call, an audio call, and/or a video call) (e.g., as in FIG. 8K). In some embodiments, the cancel operation includes silencing (and/or reducing the prominence of) a notification corresponding to an incoming call without rejecting the call, while maintaining an ability to answer the call, and/or while continuing to display a user interface for the call. In some embodiments, the second operation includes rejecting the incoming call (e.g., as in FIG. 8L) (e.g., routing the call to voicemail, no longer maintaining the ability to answer the call, and/or ceasing to display the user interface for the call). Silencing a notification of a call and subsequently rejecting the call enables the computer system to provide the user with the ability to reduce the distraction of the incoming call before deciding whether to reject the incoming call, thereby improving the man-machine interface and providing additional control options without cluttering the user interface with additional displayed controls.

In some embodiments, the computer system (e.g., 600) displays, via the one or more display generation components (e.g., 602), a second respective user interface (e.g., a user interface of a second application, a second system user interface, a second notification user interface, and/or a second home screen user interface). While displaying the second respective user interface (e.g., same as or different from the respective user interface), the computer system (e.g., 600) detects, via the one or more input devices, a respective hand input (e.g., a movement of a hand and/or a gesture performed by a hand of a user). In some embodiments, the second respective user interface is displayed after displaying the respective user interface. In response to detecting the respective hand input and in accordance with a determination that the respective hand input is the respective wrist gesture (e.g., a respective movement of a wrist of the user and/or a rotation of a wrist) and a determination that the cancel operation cannot be performed based on (e.g., in response to) the respective wrist gesture, the computer system (e.g., 600) provides an indication (e.g., 804 at FIG. 8B) (e.g., displaying a visual indication, outputting an audio indication, and/or outputting a haptic indication) that the respective wrist gesture was detected (e.g., providing directions to perform an action, such as to end an active call). In some embodiments, in accordance with a determination that the respective hand input is the first type of finger gesture (e.g., a double pinch air gesture, a double tap gesture, and/or a swipe gesture) that is different from the respective wrist gesture, the computer system performs an operation associated with the second respective user interface that is different from the cancel operation (and, optionally, without performing the cancel operation). Providing an indication that the respective wrist gesture was detected when the cancel operation cannot be performed provides the user with improved feedback (e.g., that the wrist gesture was detected).

In some embodiments, the respective wrist gesture includes a rotation of a user's wrist (e.g., as shown in FIG. 8W) (e.g., with the rotation having a magnitude (e.g., speed, acceleration, and/or rotation amount) that exceeds a threshold magnitude). In some embodiments, the respective wrist gesture includes a quick rotation of the wrist. In some embodiments, the computer system (e.g., a smart watch) is worn on the wrist that performs the rotation. In some embodiments, the rotation is a rotation down (e.g., a quick rotation down and/or a rotation that moves a display of the computer system away from the user) or a rotation down and back (e.g., a quick rotation down and back).

In some embodiments, the respective wrist gesture is different from a wrist down gesture. In some embodiments, in response to detecting the wrist down gesture, the computer system performs an operation that is different from the cancel operation and/or performs the cancel operation after a delay that is longer than a delay used for the respective wrist gesture. In some embodiments, the computer system performs the same operation (e.g., the cancel operation) in response to detecting either the respective wrist gesture or the wrist down gesture, but the computer system introduces a delay before performing the operation when the wrist down gesture is detected. In some embodiments, the respective wrist gesture (e.g., a wrist flick gesture) includes a back-and-forth gesture (e.g., rotating a display of the computer system away from the user and then rotating the display of the computer system back towards the user, as shown in FIG. 8W), while the wrist down gesture does not include a back-and-forth gesture. In some embodiments, the wrist down gesture includes a display of the computer system turning away from the user without turning back toward the user.

In some embodiments, the respective wrist gesture is a gesture performed by (e.g., detected, via the one or more input devices, based on movement of) a hand (e.g., 604A) wearing the computer system (e.g., 600) that is displaying the respective user interface. In some embodiments, the finger gesture is a gesture performed by (e.g., detected, via the one or more input devices, based on movement of) a hand (e.g., 604A) wearing the computer system (e.g., 600) that is displaying the respective user interface. In some embodiments, the computer system is a smart watch that includes a display that is displaying the respective user interface when the hand input is detected. In some embodiments, the computer system is worn on a hand and/or wrist of a user and the computer system detects gestures of the hand on which the computer system is worn. In some embodiments, the respective wrist gesture is an air gesture and/or the finger gesture is an air gesture. Detecting gestures performing by a hand wearing the computer system enables the computer system to detect the gestures more accurately and, optionally, without the need to receive visual feedback about the gestures, thereby making the gesture detection more reliable.

In some embodiments, while displaying the respective user interface, the computer system (e.g., 600) detects, via the one or more input devices, a subsequent hand input (e.g., a movement of a hand and/or a gesture performed by a hand of a user). In response to detecting the subsequent hand input and in accordance with a determination that the subsequent hand input is the respective wrist gesture (e.g., a respective movement of a wrist of the user and/or a rotation of a wrist) and that a respective type of activity (e.g., workout activity such as tracking a walk, tracking a run, or tracking swimming, a mindfulness activity such as breathing exercises, an emergency activity such as contacting emergency services via audio and/or messaging, and/or a fall detection activity that corresponds to the user falling down) was not being performed when the subsequent hand input was detected, the computer system (e.g., 600) performs a cancel operation associated with (e.g., corresponding to and/or performed on) the respective user interface (and, optionally, without performing the operation associated with the respective user interface). For example, when the respective type of activity was not being performed when the subsequent hand input was detected, the computer system declines a call that is incoming without answering the call, reduces the prominence of a notification that is being output, dismisses a notification without marking a notification as viewed, and/or displays a system user interface. In response to detecting the subsequent hand input and in accordance with a determination that the subsequent hand input is the respective wrist gesture (e.g., a respective movement of a wrist of the user and/or a rotation of a wrist) and that the respective type of activity was being performed when the subsequent hand input was detected (e.g., as in FIG. 8U), forgoing performing the cancel operation associated with (e.g., corresponding to and/or performed on) the respective user interface (and, optionally, without performing the operation associated with the respective user interface). For example, when the respective type of activity was being performed when the subsequent hand input was detected, the computer system forgoes declining a call that is incoming (e.g., the incoming call remains pending and can be answered) without answering the call, forgoes reducing the prominence of a notification that is being output, forgoes dismissing a notification without marking the notification as viewed, and/or forgoes displaying a system user interface. In some embodiments, in response to detecting the subsequent hand input and in accordance with a determination that the subsequent hand input is the first type of finger gesture (e.g., a double pinch air gesture, a double tap gesture, and/or a swipe gesture) that is different from the respective wrist gesture (and, optionally, independent of whether the respective activity is being performed), the computer system performs an operation associated with the respective user interface that is different from the cancel operation (and, optionally, without performing the cancel operation). Forgoing performing the cancel operation during certain types of activity enables the computer system to avoid performing the cancel operation when the user unintentionally performs the respective wrist gesture, thereby improving the man-machine interface.

Note that details of the processes described above with respect to method 900 (e.g., FIG. 9) are also applicable in an analogous manner to the methods described above. For example, method 700 optionally includes one or more of the characteristics of the various methods described above with reference to method 900. For example, the computer systems in the two methods are the same computer system. For another example, the air gestures and corresponding operation in one method can be applied to the other method(s). For another example, the first type of gesture is optionally the same as the second type of finger gesture (e.g., a single pinch air gesture). For another example, the second type of gesture is optionally the same as the first type of finger gesture (e.g., a double pinch air gesture). For brevity, these details are not repeated below.

In some embodiments, the computer system (e.g., 600) performs different operations when the respective wrist gesture (e.g., Gesture Type C and/or a Wrist flick) is detected based on the context of the computer system (e.g., the user interface currently displayed, the power saving mode of the computer system/display, and/or the state of the computer system). The below table provides example user interfaces and the corresponding action(s) performed by the computer system in response to detecting the respective wrist gesture in different device contexts and/or when different user interface are displayed.

| | Operation performed |
|---|---|
| Use case/State of the | when a respective |
| computer system | wrist gesture (e.g., gesture type B |
| (e.g., 600) | and/or a wrist flick) is detected |
| Watch face user | Don't provide feedback or optionally |
| interface (e.g., 610) is | provide feedback (e.g., 804 at FIG. 8B) |
| being displayed via | indicating no action is taken |
| one or more display | |
| generation components | |
| (e.g., 602) | |

| | Operation performed |
|---|---|
| | when a respective |
| Use case/State of the | wrist gesture (e.g., |
| computer system | gesture type B and/or a |
| (e.g., 600) | wrist flick) is detected |
| Watch face user interface with a stack of | Cease to display the |
| widgets (e.g., 810A-810C) is being | stack of widgets (e.g., |
| displayed via the one or more display | transition from FIG. 8C |
| generation components (e.g., 602) | to FIG. 8A) |
| Application user interface is being | Cease to display the |
| displayed via the one or more display | application user |
| generation components (e.g., 602) | interface and/or display |
| | a watch face user |
| | interface (e.g., 610 at |
| | FIG. 8A or 8C) |
| Home screen with a plurality of activatable | Display a watch face |
| application icons for launching respective | user interface (e.g., |
| applications is being displayed via the one | 610) |
| or more display generation components | |
| (e.g., 602) | |
| System settings user interface is being | Display a watch face |
| displayed via the one or more display | user interface (e.g., |
| generation components (e.g., 602) | 610) |
| Phone: Incoming call is causing an alert | 1st respective wrist |
| (e.g., 816) to be presented via one or more | gesture reduces |
| output devices (e.g., the one or more | prominence (e.g., at |
| display generation components (e.g., 602), | FIG. 8K) of an alert |
| one or more audio output devices, and/or | (e.g., reduce volume/ |
| one or more tactile output device) of the | tactile output and/or |
| computer system (e.g., 600) | cease audio/tactile output) |
| | 2nd respective wrist |
| | gesture (e.g., when |
| | prominence of alert |
| | is already reduced) |
| | causes no feedback, |
| | provides feedback |
| | (e.g., 804 at FIG. 8B) |
| | indicating no action |
| | is taken, and/or causes |
| | the incoming call |
| | to be declined (e.g., |
| | at FIGS. 8K-8L) |
| An active phone call user interface is being | No feedback, provides |
| displayed via the one or more display | feedback (e.g., 804 |
| generation components (e.g., 602) | at FIG. 8B) indicating |
| | no action is taken, |
| | display directions (e.g., |
| | 816F) indicating |

| | Operation performed |
|---|---|
| | when a respective |
| | wrist gesture (e.g., |
| Use case/State of the | gesture type B |
| computer system | and/or a wrist flick) |
| (e.g., 600) | is detected |
| | how to end the call, |
| | and/or causes text |
| | (e.g., duration and/or |
| | name in FIGS. 8P- |
| | 8Q) to change in |
| | color (e.g., to red) |
| A notification for voice mail (e.g., a voice | Cease to display |
| message left after a phone call is | the notification |
| unanswered) is being displayed via the one | |
| or more display generation components | |
| (e.g., 602) | |
| A notification initiated by a third-party | Cease to display |
| application (e.g., not by a system | the notification |
| application) is being displayed via the one | |
| or more display generation components | |
| (e.g., 602) | |
| A banner-style notification (e.g., a | Cease to display the |
| notification that is displayed at the top or | notification and/or |
| bottom of the display and/or a notification | perform the same |
| that is displayed partially (e.g., not fully) | operation as would be |
| obscuring a user interface (e.g., a system | performed when |
| user interface, an application user | rotatable input |
| interface, and/or a home screen user | mechanism (e.g., |
| interface that includes an arrangement of | 802) is pressed |
| application icons)) is being displayed via | |
| the one or more display generation | |
| components (e.g., 602) | |
| A timer user interface that indicates that a | Cease display of the |
| timer is active and currently counting down | timer user interface |
| is being displayed via the one or more | (e.g., 820) and/or |
| display generation components (e.g., 602) | display a watch face |
| | user interface (e.g., |
| | 610 at FIG. 8C) with |
| | stack of widgets (e.g., |
| | 810A-810C). |

| | Operation performed |
|---|---|
| | when a respective |
| | wrist gesture (e.g., |
| Use case/State of the | gesture type B |
| computer system | and/or a wrist flick) |
| (e.g., 600) | is detected |
| A timer user interface, a notification, | Reduce prominence |
| and/or an alert that indicates that a timer | (e.g., at FIG. 8T) of |
| has elapsed and/or is no longer counting | an alert (e.g., 860A- |
| down (e.g., as in FIG. 8T) is being | 860B) (e.g., reduce |
| displayed via the one or more display | volume/tactile output |
| generation components (e.g., 602) | and/or cease |
| | audio/tactile output), |
| | cease to display the |
| | visual notification of |
| | the timer, and/or end |
| | the timer |
| An alarm user interface, a notification, an | Cease to display the |
| alert, or other visual indication that | visual indication of |
| indicates that an alarm time (e.g., a system- | the alarm and/or snooze |
| determined and/or user-specified time of | the alarm (e.g., as |
| the day) has been reached (e.g., as in FIG. | in FIG. 8S) |
| 8S) is being displayed via one or more | |
| display generation components (e.g., 602) | |
| A stopwatch user interface (e.g., actively | Cease to display |
| showing time progressing and/or that is | the stopwatch user |
| currently stopped) is being displayed via | interface (e.g., while |
| the one or more display generation | the stopwatch |
| components (e.g., 602) | continues to run) and/ |
| | or display a watch |
| | face user interface |
| | (e.g., 610 at FIG. 8C) |
| | with stack of widgets |
| | (e.g., 810A-810C) |
| A media user interface (e.g., 812) | Cease to display the |
| configured to provide the user with | media user interface |
| playback control of media (e.g., Music, | (e.g., 812 at FIG. 8D) |
| Audio Books, and/or Podcasts) is being | (e.g., while the |
| displayed via the one or more display | media continues to play) |
| generation components (e.g., 602) | and/or display a |
| | watch face user interface |
| | (e.g., 610 at FIG. |
| | 8C) with stack of |
| | widgets (e.g., 810A- |
| | 810C) |
| A camera remote user interface (e.g., | Cease to display the |
| camera control user interface 824 at FIG. | camera remote user |
| 8V) that enables a user to remotely control | interface (e.g., 824 at |
| a camera of another device (e.g., | FIG. 8V), display a |
| | watch face user interface |
| | (e.g., 610 at FIG. |
| | 8A or 8C), and/or |
| | instruct companion |

| | Operation performed |
|---|---|
| | when a respective |
| | wrist gesture (e.g., |
| Use case/State of the | gesture type B |
| computer system | and/or a wrist f |
| (e.g., 600) | lick) is detected |
| companion device 880) is being displayed | device (e.g., 880 at |
| via the one or more display generation | FIG. 8V) to cease |
| components (e.g., 602) | displaying the camera |
| | user interface (e.g., |
| | 882) |
| A notification/alert that indicates activity | Cease to display the |
| detected (e.g., a doorbell press, detected | notification and/or |
| motion, detected person, detected package, | display a watch face |
| detected car, and/or detected animal) at a | user interface (e.g., |
| home/building doorbell and/or | 610 at FIG. 8A or 8C) |
| home/building camera (e.g., entryway | |
| camera) is being displayed via the one or | |
| more display generation components (e.g., | |
| 602) | |
| A messaging (e.g., instant messaging | Cease to display the |
| and/or email) user interface that includes a | messaging user |
| reply field and/or a user interface object for | interface and/or display |
| initiating a reply (e.g., at FIG. 6AC) is | a watch face user |
| being displayed via the one or more | interface (e.g., 610 at |
| display generation components (e.g., 602) | FIG. 8A or 8C) |
| A virtual keyboard is being displayed via | Cease to display the |
| the one or more display generation | keyboard, display a |
| components (e.g., 602) | watch face user interface |
| | (e.g., 610 at FIG. |
| | 8A or 8C) and/or |
| | perform the same |
| | operation as would |
| | be performed when |
| | rotatable input |
| | mechanism (e.g., 802) |
| | is pressed |
| A notification that is being displayed via | Cease to display the |
| the one or more display generation | notification and/or |
| components (e.g., 602) while the computer | display a watch face |
| system (e.g., 600) is in do-not-disturb | user interface (e.g., |
| | 610 at FIG. 8A or 8C) |

| | Operation performed |
|---|---|
| | when a respective |
| | wrist gesture (e.g., |
| Use case/State of | gesture type B |
| the computer system | and/or a wrist |
| (e.g., 600) | flick) is detected |
| mode (e.g., a mode that silences and/or | |
| reduces audio, visual, and/or tactile | |
| notifications) | |
| A low battery notification that indicates | Cease to display the |
| that the computer system (e.g., 600) | low battery |
| (and/or a remote device, such as a | notification and/or |
| companion device (e.g., 880)) has a low | display a watch face |
| battery (e.g., a battery level that is below a | user interface (e.g., 610 |
| threshold value and/or percent charge) is | at FIG. 8A or 8C) |
| being displayed via the one or more | |
| display generation components (e.g., 602) | |
| A low power mode notification that | Cease to display the |
| indicates the computer system (e.g., 600) is | low power mode |
| operating in and/or switching to operate in | notification, display |
| a low power mode is being displayed via | a watch face user |
| the one or more display generation | interface (e.g., 610 |
| components (e.g., 602) | at FIG. 8A or 8C) |
| | and/or perform the |
| | same operation as |
| | would be performed |
| | when rotatable input |
| | mechanism (e.g., 802) |
| | is pressed |
| A recording user interface that includes | When a respective |
| one or more user interface objects for | wrist gesture is |
| controlling recording of audio (e.g., voice | detected within a |
| memos and/or ambient noise) is being | threshold duration of |
| displayed via the one or more display | time (e.g., 1 second, |
| generation components (e.g., 602) | 2 seconds, or 5 |
| | seconds) of an action |
| | (e.g., launching or |
| | displaying application), |
| | dismiss to home |
| | screen that includes |
| | a plurality of |
| | activatable application |
| | icons. When |
| | respective wrist |
| | gesture is detected after |
| | the threshold duration |
| | of time (e.g., 2 |
| | seconds or 5 seconds), |
| | cease display of |
| | the recording user |
| | interface and/or display |

| Use case/State of the | Operation performed when a respective |
|---|---|
| computer system | wrist gesture (e.g., gesture type B |
| (e.g., 600) | and/or a wrist flick) is detected |
| | a watch face user interface (e.g., 610 at |
| | FIG. 8C) with stack of widgets (e.g., |
| | 810A-810C) |
| A recording list user | When respective wrist gesture is detected |
| interface that includes | within a threshold duration of time (e.g., 1 |
| a list of recording is | second, 2 seconds, or 5 seconds) of an |
| being displayed via | action (e.g., launching or displaying |
| the one or more | application), dismiss to home screen that |
| display generation | includes a plurality of activatable |
| components (e.g., 602) | application icons. When respective wrist |
| | gesture is detected after the threshold |
| | duration of time (e.g., 2 seconds or 5 |
| | seconds), cease display of recording list |
| | user interface and/or display a watch face |
| | user interface (e.g., 610 at FIG. 8C) with |
| | stack of widgets (e.g., 810A-810C) |
| A recording user | Cease to display the recording user |
| interface that includes | interface, cease playback of |
| an indication | recording/media, and/or display a watch |
| that one or more | face user interface (e.g., 610 at FIG. 8A or |
| recordings/media | 8C) |
| are currently playing | |
| and/or that includes | |
| user interface objects | |
| for controlling | |
| playback of a | |
| recording/media is | |
| being displayed via the | |
| one or more | |
| display generation | |
| components (e.g., 602) | |
| A tips user interface | Cease to display the tips user interface |
| (e.g., tips user | and/or display a watch face user interface |
| interface for providing | (e.g., 610 at FIG. 8A or 8C) |
| instructions on how | |
| to use features of the | |
| computer system | |
| (e.g., 600)) is being | |
| displayed via the one | |

| | Operation performed |
|---|---|
| | when a respective |
| | wrist gesture (e.g., |
| Use case/State of the | gesture type B |
| computer system | and/or a wrist flick) |
| (e.g., 600) | is detected |
| or more display generation components | |
| (e.g., 602) | |
| A locate user interface configured to locate | Cease to display the |
| a device (e.g., companion device 880) is | locate user interface, |
| being displayed via the one or more | display a watch face |
| display generation components (e.g., 602) | user interface (e.g., |
| | 610 at FIG. 8A or 8C), |
| | and/or perform the |
| | same operation as |
| | would be performed |
| | when rotatable input |
| | mechanism (e.g., |
| | 802) is pressed |
| Physical activity and/or reminder to stand | Cease to display the |
| alert is being displayed via the one or more | physical activity |
| display generation components (e.g., 602) | notification and/or |
| | display a watch face |
| | user interface (e.g., 610 |
| | at FIG. 8A or 8C) |
| A prediction notification related to a | Cease to display |
| workout is being displayed via the one or | the prediction |
| more display generation components (e.g., | notification and/or |
| 602) | display a watch face |
| | user interface (e.g., 610 |
| | at FIG. 8A or 8C) |
| A workout notification that corresponds to | Cease to display the |
| an activity alert and/or to a workout video | workout notification |
| is being displayed via the one or more | and/or a display a |
| display generation components (e.g., 602) | watch face user |
| | interface (e.g., 610 |
| | at FIG. 8A or 8C) |
| A workout summary user interface and/or a | Cease to display |
| workout summary notification is being | the summary user |
| displayed via the one or more display | interface and/or |
| generation components (e.g., 602) | notification and/or a |
| | display a watch face |
| | user interface (e.g., |
| | 610 at FIG. 8A or 8C) |
| An activity starting notification indicating | Cease to display the |
| that an activity (e.g., a workout, a specific | activity starting |
| type of workout, and/or tracking of a | notification and/or |
| workout) has been started is being | display a watch face |
| | user interface (e.g., 610 |
| | at FIG. 8A or 8C) |

| | Operation performed |
|---|---|
| | when a respective |
| | wrist gesture (e.g., |
| | gesture type B |
| Use case/State of the computer system | and/or a wrist flick) |
| (e.g., 600) | is detected |
| displayed via the one or more display | |
| generation components (e.g., 602) | |
| A workout user interface that includes | In some embodiments, |
| information about an active workout | do not take action, |
| session is being displayed via the one or | stay in the current |
| more display generation components (e.g., | application (e.g., |
| 602) | displaying a workout |
| | user interface). In |
| | some embodiments, |
| | cease to display the |
| | workout user interface |
| | and/or display a |
| | watch face user interface |
| | (e.g., 610 at FIG. |
| | 8A or 8C) |
| A user interface and/or notification | Cease to display the user |
| corresponding to beginning a reflect | interface/notification |
| activity, a breathe activity, and/or a | and/or display a |
| meditation activity is being displayed via | watch face user |
| the one or more display generation | interface (e.g., 610 at |
| components (e.g., 602) | FIG. 8A or 8C) |
| A user interface and/or notification for | Cease to display the user |
| starting a paired meditation session and/or | interface/notification |
| indicating that a paired meditation session | and/or display a |
| is in progress is being displayed via the one | watch face user |
| or more display generation components | interface (e.g., 610 at FIG. |
| (e.g., 602) | 8A or 8C) |
| An activity notification (e.g., sharing | Cease to display the |
| physical activity competitions, setting | notification and/or |
| physical activity goals, and/or rewards for | display a watch |
| completing physical activity challenges) is | face user interface (e.g., |
| being displayed via the one or more | 610 at FIG. 8A or 8C) |
| display generation components (e.g., 602) | |

| Use case/State of | Operation performed when a respective |
|---|---|
| the computer system | wrist gesture (e.g., gesture type B |
| (e.g., 600) | and/or a wrist flick) is detected |
| An activity (e.g., | Cease to display the notification and/or |
| physical activity) | display a watch face user interface (e.g., |
| notification is being | 610 at FIG. 8A or 8C) |
| displayed via the one | |
| or more display | |
| generation components | |
| (e.g., 602) | |
| A process to send a | In some embodiments, cancel sending the |
| message using a smart | message and cease to display the smart |
| voice assistant is | voice assistant user interface. In some |
| in progress and | embodiments, sending a message with a |
| information about | smart voice assistant includes delaying |
| the progress is | sending for a time period from when the |
| optionally being | computer system detects the voice input |
| displayed via the one or | that composed the message, to allow the |
| more display generation | user to determine whether the message |
| components (e.g., | was detected accurately and, in response |
| 602) | to detecting the wrist flick gesture before |
| | the time period elapses, the computer |
| | system cancels sending (e.g., does not |
| | send and/or waits for a different/additional |
| | user input before sending) of the message. |
| | In some embodiments, continue to send |
| | the message. In some embodiments, |
| | sending a message with a smart voice |
| | assistant includes delaying sending for a |
| | time period from when the computer |
| | system detects the voice input that |
| | composed the message (and, optionally, |
| | showing a countdown), to allow the user |
| | to determine whether the message was |

| Use case/State of the | Operation performed when a respective |
|---|---|
| computer system | wrist gesture (e.g., gesture type B |
| (e.g., 600) | and/or a wrist flick) is detected |
| | detected accurately and the computer |
| | system sends the message in response to |
| | detecting the wrist flick gesture without |
| | waiting for the time period to elapse. |
| A compass user | Cease to display the compass user |
| interface is being | interface and/or display a watch face user |
| displayed via the | interface (e.g., 610 at FIG. 8A or 8C) |
| one or more display | |
| generation components | |
| (e.g., 602) | |
| A flashlight user | In some embodiments, cease to display |
| interface is being | the flashlight user interface and/or display |
| displayed via the | a watch face user interface (e.g., 610 at |
| one or more display | FIG. 8A or 8C). In some embodiments, |
| generation components | maintain at least a portion of the flashlight |
| (e.g., 602) | user interface (e.g., while switching to |
| | displaying the watch face user interface). |
| A water lock mode | While in water lock mode (e.g., a mode |
| (e.g., a mode for using | for using the computer system in water |
| the computer system | (e.g., while swimming)), do not perform |
| in water (e.g., while | any actions. |
| swimming)) is enabled | |
| at the computer | |
| system (e.g., 600) | |
| A notification | Cease to display the notification and/or |
| corresponding | display a watch face user interface (e.g., |
| to pairing the | 610 at FIG. 8A or 8C) |
| computer system | |
| (e.g., 600) to one or more | |
| physical workout | |
| machines is being | |
| displayed via the | |
| one or more display | |
| generation components | |
| (e.g., 602) | |
| A menstrual cycle | Cease to display the notification and/or |
| tracking notification is | display a watch face user interface (e.g., |
| being displayed | 610 at FIG. 8A or 8C) |
| via the one or more | |
| display generation | |
| components (e.g., 602) | |

| | Operation performed |
|---|---|
| | when a respective |
| | wrist gesture (e.g., |
| | gesture type B |
| Use case/State of the computer system | and/or a wrist |
| (e.g., 600) | flick) is detected |
| A notification for the user to confirm | Cease to display the |
| whether a shortcut and/or automation | notification and/or |
| should be run is being displayed via the | display a watch face |
| one or more display generation | user interface (e.g., |
| components (e.g., 602) | 610 at FIG. 8A or 8C) |
| A notification that includes smart prompts | Cease to display the |
| and/or prompts with two or more options | notification and/or |
| for running automation is being displayed | display a watch face |
| via the one or more display generation | user interface (e.g., |
| components (e.g., 602) | 610 at FIG. 8A or 8C) |
| A notification corresponding to a shortcut | Cease to display the |
| and/or automation is being displayed via | notification and/or |
| the one or more display generation | display a watch face |
| components (e.g., 602) | user interface (e.g., |
| | 610 at FIG. 8A or 8C) |
| A user interface and/or a notification | Cease to display the |
| corresponding to recording audio based on | user interface and/or |
| a shortcut and/or automation is being | notification, display |
| displayed via the one or more display | watch a face user |
| generation components (e.g., 602) | interface (e.g., 610 |
| | at FIG. 8C), and/or |
| | cease (or start) |
| | recording audio |
| A user interface and/or notification for | Cease to display the user |
| choosing a workout goal is being displayed | interface/notification |
| via the one or more display generation | and/or display a |
| components (e.g., 602) | watch face user |
| | interface (e.g., 610 at |
| | FIG. 8A or 8C) |
| A user interface and/or notification for | Cease to display the user |
| changing a workout goal is being displayed | interface/notification |
| via the one or more display generation | and/or display a |
| components (e.g., 602) | watch face user interface |
| | (e.g., 610 at FIG. |
| | 8A or 8C) |

| Use case/State of the | Operation performed when a respective |
|---|---|
| computer system | wrist gesture (e.g., gesture type B |
| (e.g., 600) | and/or a wrist flick) is detected |
| A user interface and/ | Cease to display the user |
| or notification for | interface/notification and/or display a |
| sending a message | watch face user interface (e.g., 610 at FIG. |
| using a walk-talkie | 8A or 8C) |
| feature and/or sending | |
| an audio message is | |
| being displayed via | |
| the one or more | |
| display generation | |
| components (e.g., 602) | |
| A meditation user | In some embodiments, do not take action, |
| interface of an activate | stay in the current application (e.g., |
| meditation session | displaying a meditation user interface). In |
| is being displayed via | some embodiments, cease to display the |
| the one or more | user interface and/or display a watch face |
| display generation | user interface (e.g., 610 at FIG. 8A or 8C) |
| components (e.g., 602) | |
| A navigation user | In some embodiments, do not take action, |
| interface (e.g., that | stay in the current application (e.g., |
| includes navigation | displaying a navigation user interface). In |
| directions and/or a | some embodiments, cease to display the |
| map) is being | user interface and/or display a watch face |
| displayed via | user interface (e.g., 610 at FIG. 8A or 8C) |
| the one or | |
| more display | |
| generation components | |
| (e.g., 602) | |
| A user interface and/ | Cease to display the user |
| or notification | interface/notification and/or display a |
| indicating that | watch face user interface (e.g., 610 at FIG. |
| authentication via | 8A or 8C) |
| a physical | |
| button to proceed | |
| with a process is being | |
| displayed via the | |
| one or more display | |
| generation components | |
| (e.g., 602) | |
| An ECG user interface | Cease to display the user |
| and/or notification | interface/notification and/or display a |
| (e.g., of an ECG | watch face user interface (e.g., 610 at FIG. |
| application) is being | 8A or 8C) |
| displayed via the | |
| one or more display | |
| generation components | |
| (e.g., 602) | |

| | Operation performed |
|---|---|
| | when a respective |
| | wrist gesture (e.g., |
| | gesture type B |
| Use case/State of the computer system | and/or a wrist |
| (e.g., 600) | flick) is detected |
| A heart rate user interface (e.g., of a hear | Cease to display the |
| rate measuring application) is being | user interface and/or |
| displayed via the one or more display | display a watch face |
| generation components (e.g., 602) | user interface (e.g., |
| | 610 at FIG. 8A or 8C) |
| The computer system (e.g., 600) has | Do not change a |
| detected (e.g., using one or more sensors, | state of the computer |
| such as accelerometer) that the user and/or | system and/or do |
| wearer of the computer system has fallen | not provide user |
| | interface feedback in |
| | response to the wrist |
| | flick gesture. |
| The computer system (e.g., 600) has | Do not change a state |
| detected (e.g., using one or more sensors, | of the computer |
| such as accelerometer) that the user and/or | system and/or do |
| wearer of the computer system has been | not provide user |
| involved in a crash (e.g., a car crash and/or | interface feedback in |
| a bicycle crash) | response to the wrist |
| | flick gesture. |
| The computer system is initiating and/or is | Do not change a state |
| in an active emergency call (e.g., to | of the computer |
| rescuers, to police, and/or to medical | system and/or do |
| emergency professionals) | not provide user |
| | interface feedback in |
| | response to the wrist |
| | flick gesture. |
| A location sharing notification (e.g., | Cease to display the |
| initiated by a detected emergency | user notification |
| condition (e.g., fall and/or crash)) is being | and/or display a watch |
| displayed via the one or more display | face user interface |
| generation components (e.g., 602) | (e.g., 610 at FIG. 8A or 8C) |
| A location sharing permissions user | Cease to display the user |
| interface and/or notification is being | interface/notification |
| displayed via the one or more display | and/or display a |
| generation components (e.g., 602) | watch face user interface |
| | (e.g., 610 at FIG. |
| | 8A or 8C) |

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve user control of a computer system. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data, or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide better control of the computer system. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of air gestures, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

1-75. (canceled)

76. A computer system configured to communicate with one or more display generation components and one or more input devices, comprising:
one or more processors; and
memory storing one or more programs configured to be executed by the one or more processors, the one or more programs including instructions for:
displaying, via the one or more display generation components, a respective user interface;
while displaying the respective user interface, detecting, via the one or more input devices, a hand input; and
in response to detecting the hand input:
in accordance with a determination that the hand input is a respective wrist gesture, performing a cancel operation associated with the respective user interface; and
in accordance with a determination that the hand input is a first type of finger gesture that is different from the respective wrist gesture, performing an operation associated with the respective user interface that is different from the cancel operation.

77. The computer system of claim 76, wherein the cancel operation associated with the respective user interface is related to a respective function and the operation associated with the respective user interface is related to the respective function.

78. The computer system of claim 76, wherein the first type of finger gesture is a tap air gesture.

79. The computer system of claim 76, wherein performing the operation associated with the respective user interface includes performing a first operation, the one or more programs further including instructions for:
in response to detecting the hand input:
in accordance with a determination that the hand input is a second type of finger gesture that is different from the first type of finger gesture and the respective wrist gesture, performing a second operation that is different from the first operation and the cancel operation.

80. The computer system of claim 79, wherein the first operation is a navigation operation and the second operation is a selection operation.

81. The computer system of claim 79, wherein the first type of finger gesture is a multiple tap air gesture and the second type of finger gesture is a single tap air gesture.

82. The computer system of claim 79, wherein performing the first operation includes displaying, via the one or more display generation components, a visual indication of input focus.

83. The computer system of claim 82, wherein performing the second operation includes performing a selection based on the visual indication of input focus.

84. The computer system of claim 82, the one or more programs further including instructions for:
while displaying the visual indication of input focus, detecting, via the one or more input devices, a second hand input; and
in response to detecting the second hand input and in accordance with a determination that the second hand input is the first type of finger gesture, moving the visual indication of input focus.

85. The computer system of claim 84, wherein moving the visual indication of input focus includes moving the visual indication of input focus from a primary action of a user interface object to a sub-element of the user interface object.

86. The computer system of claim 82, wherein:
the respective user interface includes a plurality of user interface objects; and
performing the first operation includes: dimming one or more first user interface objects, of the plurality of user interface objects, that cannot be selected using an air gesture without dimming one or more second user interface objects, of the plurality of user interface objects, that can be selected using an air gesture.

87. The computer system of claim 82, wherein:
the respective user interface includes a plurality of user interface objects; and
performing the first operation includes:
in accordance with a determination that a user interface object of the plurality of user interface objects is a selectable user interface object that corresponds to updates to an ongoing activity, displaying, via the one or more display generation components, a visual indication of input focus to indicate that the selectable user interface object that corresponds to the updates to the ongoing activity has focus.

88. The computer system of claim 76, wherein performing the cancel operation associated with the respective user interface includes reducing a prominence of audio being output via one or more output devices of the computer system.

89. The computer system of claim 76, wherein performing the cancel operation associated with the respective user interface includes reducing a prominence of tactile output being output via one or more output devices of the computer system.

90. The computer system of claim 76, wherein performing the cancel operation associated with the respective user interface includes ending an active timer that is counting down.

91. The computer system of claim 76, wherein performing the cancel operation associated with the respective user interface includes snoozing an alarm that has expired.

92. The computer system of claim 76, wherein performing the cancel operation associated with the respective user interface includes canceling an operation that is pending and has not yet been completed.

93. The computer system of claim 76, wherein performing the cancel operation associated with the respective user interface includes ceasing to display the respective user interface.

94. The computer system of claim 93, wherein the respective user interface is a system user interface and performing the cancel operation associated with the respective user interface includes displaying, via the one or more display generation components, a wake screen user interface.

95. The computer system of claim 93, wherein:
the respective user interface is an application user interface; and
performing the cancel operation associated with the respective user interface includes displaying, via the one or more display generation components, a system user interface.

96. The computer system of claim 95, wherein displaying the system user interface includes:
in accordance with a determination that display of the respective user interface was initiated from a first system user interface, displaying, via the one or more display generation components, the first system user interface; and
in accordance with a determination that display of the respective user interface was initiated from a second system user interface that is different from the first system user interface, displaying, via the one or more display generation components, the second system user interface.

97. The computer system of claim 93, wherein performing the cancel operation associated with the respective user interface includes displaying, via the one or more display generation components, a respective system user interface, including:
in accordance with a determination that an application is providing updates to an ongoing activity, displaying, via the one or more display generation components, a stack of widgets that includes information about the ongoing activity; and
in accordance with a determination that no application is providing updates to an ongoing activity, displaying, via the one or more display generation components, a watch user interface that does not include a stack of widgets.

98. The computer system of claim 93, wherein performing the cancel operation associated with the respective user interface includes displaying, via the one or more display generation components, a respective system user interface, including:
in accordance with a determination that the respective wrist gesture is detected within a threshold duration of time of initiating display of the respective user interface, displaying, via the one or more display generation components, an application launching user interface that includes a plurality of application user interface objects, including a first application user interface object configured to cause display of a user interface of a first application and a second application user interface object configured to cause display of a user interface of a second application; and
in accordance with a determination that the respective wrist gesture is not detected within the threshold duration of time of initiating display of the respective user interface, displaying, via the one or more display generation components, a watch face user interface that does not include the plurality of application user interface objects.

99. The computer system of claim 76, the one or more programs further including instructions for:
in response to detecting the hand input:
in accordance with the determination that the hand input is the respective wrist gesture, sending to a companion device that is different from the computer system, information that causes the companion device to change a state of an application of the companion device.

100. The computer system of claim 76, the one or more programs further including instructions for:
after performing the cancel operation associated with the respective user interface, detecting, via the one or more input devices, a second hand input; and
in response to detecting the second hand input and in accordance with a determination that the second hand input is the respective wrist gesture, performing a second operation that is different from the cancel operation.

101. The computer system of claim 100, wherein:
the cancel operation includes silencing a notification corresponding to an incoming call; and
the second operation includes rejecting the incoming call.

102. The computer system of claim 76, the one or more programs further including instructions for:
displaying, via the one or more display generation components, a second respective user interface;
while displaying the second respective user interface, detecting, via the one or more input devices, a respective hand input; and
in response to detecting the respective hand input and in accordance with a determination that the respective hand input is the respective wrist gesture and a determination that the cancel operation cannot be performed based on the respective wrist gesture, providing an indication that the respective wrist gesture was detected.

103. The computer system of claim 76, wherein the respective wrist gesture includes a rotation of a user's wrist.

104. The computer system of claim 76, wherein the respective wrist gesture is different from a wrist down gesture.

105. The computer system of claim 76, wherein:
the respective wrist gesture is a gesture performed by a hand wearing the computer system that is displaying the respective user interface; and
the finger gesture is a gesture performed by a hand wearing the computer system that is displaying the respective user interface.

106. The computer system of claim 76, the one or more programs further including instructions for:
while displaying the respective user interface, detecting, via the one or more input devices, a subsequent hand input; and
in response to detecting the subsequent hand input:
in accordance with a determination that the subsequent hand input is the respective wrist gesture and that a respective type of activity was not being performed when the subsequent hand input was detected, performing a cancel operation associated with the respective user interface; and
in accordance with a determination that the subsequent hand input is the respective wrist gesture and that the respective type of activity was being performed when the subsequent hand input was detected, forgoing performing the cancel operation associated with the respective user interface.

107. A non-transitory computer-readable storage medium storing one or more programs configured to be executed by one or more processors of a computer system that is in communication with one or more display generation components and one or more input devices, the one or more programs including instructions for:
displaying, via the one or more display generation components, a respective user interface;
while displaying the respective user interface, detecting, via the one or more input devices, a hand input; and
in response to detecting the hand input:
in accordance with a determination that the hand input is a respective wrist gesture, performing a cancel operation associated with the respective user interface; and
in accordance with a determination that the hand input is a first type of finger gesture that is different from the respective wrist gesture, performing an operation associated with the respective user interface that is different from the cancel operation.

108. A method, comprising:
at a computer system that is in communication with one or more display generation components and one or more input devices:
displaying, via the one or more display generation components, a respective user interface;
while displaying the respective user interface, detecting, via the one or more input devices, a hand input; and
in response to detecting the hand input:
in accordance with a determination that the hand input is a respective wrist gesture, performing a cancel operation associated with the respective user interface; and
in accordance with a determination that the hand input is a first type of finger gesture that is different from the respective wrist gesture, performing an operation associated with the respective user interface that is different from the cancel operation.
